(19) United States
(12) Patent Application Publication
(10) Pub. No.: US 2017/0196175 A1
(43) Pub. Date: Jul. 13, 2017

(54) COMPOSITIONS FOR THE DELIVERY OF AGROCHEMICALS TO THE ROOTS OF A PLANT

(71) Applicant: ADAMA MAKHTESHIM LTD., Beer Sheva (IL)

(72) Inventors: Uri Shani, Ness-Ziona (IL); Asher Vitner, Jerusalem (IL); Matti Ben-Moshe, Reut (IL); Eran Segal, Kubbutz-Hulda (IL)

(73) Assignee: Adama Makhteshim Ltd., Beer Sheva (IL)

(21) Appl. No.: 15/324,232

(22) PCT Filed: Sep. 11, 2015
(86) PCT No.: PCT/IB2015/001591

§ 371 Date: Jan. 5, 2017

Related U.S. Application Data
(60) Provisional application No. 62/050,611, filed on Sep. 15, 2014.

(51) Int. Cl. A01G 29/00; A01N 43/54; C05G 3/02; A01N 51/00

(52) U.S. Cl. CPC A01G 29/00; A01N 51/00; A01N 43/54; C05G 3/02

(57) ABSTRACT

In some embodiments, the invention provides a unit for delivery of agrochemicals to the roots of a plant comprising: one or more root development zones; optionally, one or more agrochemical zones; and a pesticide; wherein the agrochemical zones are formulated to release at least one agrochemical into the root development zones in a controlled release manner when the root development zones are swelled; and wherein the dry weight ratio of the root development zones to the agrochemical zones in a dry unit is 0.05:1 to 20:1, or wherein the total volume of the root development zones in the unit is at least 0.2 mL when the unit is fully swelled.

This application claims the priority of U.S. Provisional Application No. 61/050,611, filed Sep. 15, 2014, the contents of which are hereby incorporated by reference in its entirety.

Throughout this application, various publications are referenced, including referenced in parenthesis. Full citations for publications referenced in parenthesis may be found listed at the end of the specification immediately preceding the claims. The disclosures of all referenced publications in their entireties are hereby incorporated by reference into this application in order to more fully describe the state of the art to which this invention pertains.

### BACKGROUND OF INVENTION

Current practices and technologies yield poor agrochemical use efficiency by plants due to over application (up to 50%) (Shaviv and Mikkelsen 1993). Excessive application of agrochemicals has adverse effects on the environment and is costly for farmers (Shaviv and Mikkelsen 1993). Additionally, many soils and climates are not suitable for growing crops (Habarurema and Steiner, 1997; Nicholson and Farrar, 1994).

Plant protection products (PPPs), e.g. pesticides, are commonly applied using methods which include foliar spraying, soil drenching, above ground distribution (granular products), and soil spraying (mainly herbicides). The choice of application method is subject to the crop type and phenology, prevailing climatic conditions, target pest or weed species and its phenology, and soil type. These application methods can be suboptimal because not all of the PPPs applied reach the actual target because of drift, run off, leaching, degradation and breakdown. For example, efficiency can be decreased due to variable environmental conditions (e.g., rainfall, heat waves), and photo chemical degradation following foliar spraying. Unknown spatial distribution of the targeted roots (relevant to drenching and above ground application) can similarly result in suboptimal application of PPPs using traditional application methods.

Moreover, these application methods have the risk of exposing humans to toxic chemicals. For example, operators, field entrants and nearby communities can be exposed to chemicals though handling, contamination of drinking water, and contamination of agricultural produce harvested prior to required post-harvest picking intervals. Non-target organisms can similarly be affected when PPPs are applied using the above-identified methods.

Accordingly, new practices and technologies are needed for efficient application of fertilizers and other agrochemicals for improving plant growth.

### SUMMARY OF THE INVENTION

The invention provides a unit for delivery of agrochemicals to the roots of a plant comprising: one or more root development zones; optionally, one or more agrochemical zones; and a pesticide; wherein the agrochemical zones are formulated to release at least one agrochemical into the root development zones in a controlled release manner when the root development zones are swelled; and wherein the dry weight ratio of the root development zones to the agrochemical zones in a dry unit is 0.05:1 to 20:1, or wherein the total volume of the root development zones in the unit is at least 0.2 mL when the unit is fully swelled.

The invention provides a unit for delivery of agrochemicals to the roots of a plant comprising:
i) one or more root development zones,
ii) one or more agrochemical zones containing a fertilizer, and
iii) a pesticide,
wherein the agrochemical zones are formulated to release the fertilizer into the root development zones in a controlled release manner when the root development zones are swelled,
wherein the total amount of pesticide in the dry unit is 0.0004% to 0.5% of the total weight of the unit, wherein the weight ratio of pesticide to fertilizer in the unit is 5×10-6:1 to 6×10-3:1, or wherein the total amount of pesticide in the unit is less than 50 mg, and
wherein the dry weight ratio of the root development zones to the agrochemical zones in a dry unit is 0.05:1 to 0.32:1, or wherein the total volume of the root development zones in the unit is at least 0.2 mL when the unit is fully swelled.

The invention provides a unit for delivery of agrochemicals to the roots of a plant comprising:
i) one or more root development zones, and
ii) one or more agrochemical zones containing at least one agrochemical,
   wherein the agrochemical zones are formulated to release the at least one agrochemical into the root development zones in a controlled release manner when the root development zones are swelled, and
   wherein the weight ratio of the root development zones to the agrochemical zones in a dry unit is 0.12:1, 0.14:1, or 0.21:1.

The invention provides a method of growing a plant, comprising adding at least one unit of the invention to the medium in which the plant is grown.

The invention provides a method of reducing environmental damage caused by a fertilizer, a pesticide, or a fertilizer and a pesticide, comprising delivering the fertilizer and the pesticide to the root of a plant by adding at least one unit of the invention to the medium of the plant.

The invention provides a method of reducing environmental damage caused by agrochemicals, comprising delivering the agrochemicals to the root of a plant by adding at least one unit of the invention to the medium of the plant.

The invention provides a method of minimizing exposure to a fertilizer, a pesticide, or a fertilizer and a pesticide, comprising delivering the fertilizer and the pesticide to the root of a plant by adding at least one unit of the invention to the medium of the plant.

The invention provides a method of generating an artificial zone with predetermined chemical properties within the root zone of a plant, comprising:
i) adding one or more units of the invention to the medium of the root zone of the plant; or
ii) adding one or more units of the invention to the anticipated root zone of the medium in which the plant is anticipated to grow.

The invention provides a method of fertilizing a plant comprising adding at least one unit of the invention to the medium in which the plant is grown.

The invention provides a method of protecting a plant from a pest comprising adding at least one unit of the invention to the medium in which the plant is grown.

### BRIEF DESCRIPTION OF THE DRAWINGS

FIG. 1A-G. (A) Pea roots growth in CMC-Lab. (B) Corn roots growth in Alginate-Lab. (C) Pea root growth in k-Carrageenan-Lab. (D) Pea root growth on CMC-Lab. (E) Corn root grown in Fully synthetic-Lab. (F) Corn root grown in Fully synthetic-Lab. (G) Corn roots growth in Alginate-Lab.

FIG. 2. Phase 1: Banding and incorporating dry “beads”, made from an external zone (hydrogel) and internal zone (coated minerals) into the upper soil profile. Phase 2: Following watering, the beads swell (up to, e.g., 5 cm in diameter) and agrochemicals diffuse to the external zone & soil. Phase 3: Roots grow and are sustained in/near the external zone, and uptake lasts a few weeks (6-8).

FIG. 3. The field plot experimental setup of Example 3.

FIG. 4. Soil temperatures at the experimental site of Example 3. Top line shows maximum soil temperatures and bottom line shows minimum soil temperatures.

FIG. 5. Relative weight of the hydrogels and water application over time in Example 3.

FIG. 6. Final surface areas of the hydrogel units of Example 3.

FIG. 7. Surface areas of the hydrogel units of Example 3 over time.

FIG. 8. Final surface area to volume ratio of the hydrogel units of Example 3.

FIG. 9. Final minimal distance values of the hydrogel units of Example 3.

FIG. 10. Minimal distance of the hydrogel units of Example 3 versus time.

FIG. 11. Final stiffness values of the hydrogel units of Example 3.

FIG. 12. Stiffness of the hydrogel units of Example 3 versus time.

FIG. 13A-I. Photos of the hydrogels of Example 3 from plots A-C at the end of the experiment. FIG. 13A: fully synthetic; FIG. 13B: Semisynthetic CMC 6% AAm; FIG. 13C: Semisynthetic CMC 6% AA; FIG. 13D: Semisynthetic CMC 25% AA; FIG. 13E: Semisynthetic CMC 50% AA; FIG. 13F: Polysugars Alginate; FIG. 13G: Semisynthetic CMC 6% AAm-Large; FIG. 13H: Semisynthetic CMC 50% AA-large; FIG. 13I: Semisynthetic CMC 6% AAm-Small.

FIG. 14A-H Photos of the hydrogels of Example 3 from plot D at the end of the experiment. Left panels of FIGS. 14A-G show hydrogels in situ. Right panels of FIGS. 14A-G show samples where roots penetrated through the hydrogel. FIG. 14A: fully synthetic; FIG. 14B: Semisynthetic CMC 6% AAm; FIG. 14C: Semisynthetic CMC 6% AA; FIG. 14D: Semisynthetic CMC 25% AA; FIG. 14E: Semisynthetic CMC 50% AA; FIG. 14F: Semisynthetic CMC 6% AAm-Large; FIG. 14G: Semisynthetic CMC 50% AAm-Large; FIG. 14H: Semisynthetic CMC 25% AA.

FIG. 15. Fertilizer units made according to the process of Example 4.

FIG. 16. A fully swelled fertilizer unit made according to the process of Example 4 compared to a dried fertilizer unit made according to the process of Example 4.

FIG. 17. Example of the visual notation scale of fertilizer/insecticide unit colonization by roots in Example 5. FIG. 17A: Notation 0, No roots; FIG. 17B: notation 0.5, Weak colonization; FIG. 17C: Notation 1: colonization; FIG. 17D: Notation 2, Important colonization; FIG. 17E: Notation 3, Very Important colonization.

FIG. 18. Efficacies of the different treatments and doses on both adults and larvae 1, 4 and 7 days after infestation (DAI) in Example 5. Values are the mean percentage of efficacy determined from the number of both living adults and larvae of 4 repetitions of 4 to 6 plants. Two conditions with the same letter of the same color are not significantly different from each other in the Newman-Keuls test.

FIG. 19. Disease kinetics following M. majus inoculation in Example 6.

FIG. 20. Transects of six units of variable sizes of Example 7.

FIG. 21. A single root image within the outer casing of hydrogel (×4) (Example 7).

FIG. 22. Number of visible roots for each unit size of Example 7.

FIG. 23. Number of roots per equivalent transect of each size unit of Example 7.

FIG. 24. Total root length within each size unit of Example 7.

FIG. 25. Production stages of the fertilizer units of Example 7. Left panel: core; middle panel: core covered with cotton fibers; right panel: fertilizer unit following polymerization of the root development zone.

FIG. 26. Root penetration and development for fertilizer units of each ratio of Example 8. FIG. 26A Root penetration and development after two weeks (ratio 1:5); FIG. 26B: Root penetration and development over time (ratio 1:5); FIG. 26C: Root penetration and development after two weeks (ratio 1:6.7); FIG. 26D: Root penetration and development after two weeks (ratio 1:7.2); FIG. 26E: Root penetration and development after two weeks (ratio 1:8.2); FIG. 26F: Root penetration and development after two weeks (ratio 1:10).

FIGS. 27A, 27B. Pesticide content with variable doses submerged in water over time.

FIGS. 28A-28C. Crop selectivity.

FIGS. 29A-29E. Weed development and mortality.

FIGS. 30A, 30B. Fertilizer application rate.

FIG. 31. Root growth.

FIG. 32. Root growth.

FIGS. 33A, 33B.

FIG. 34. Fertilizer application rate.

### DETAILED DESCRIPTION OF THE INVENTION

The invention provides a unit for delivery of agrochemicals to the roots of a plant comprising: one or more root development zones; optionally, one or more agrochemical zones; and a pesticide; wherein the agrochemical zones are formulated to release at least one agrochemical into the root development zones in a controlled release manner when the root development zones are swelled; and wherein the dry weight ratio of the root development zones to the agrochemical zones in a dry unit is 0.05:1 to 20:1, or wherein the total volume of the root development zones in the unit is at least 0.2 mL when the unit is fully swelled.

In some embodiments, the unit does not contain an agrochemical zone.

In some embodiments, the unit does not contain a fertilizer.

In some embodiments, the unit contains one or more agrichemical zones wherein the one or more agrochemical zones contains a fertilizer.

In some embodiments, the one or more of the agrochemical zones contains a fertilizer and the weight ratio of the pesticide to the fertilizer is at least or greater than 6×10⁻³:1.

In some embodiments, the total amount of the pesticide in the dry unit is 0.0004% to 20%, 0.01% to 20%, 0.05% to 10%, or 0.1% to 1% of the total weight of the dry unit.

In some embodiments, the weight ratio of the pesticide to the fertilizer is 6×10⁻³:1 to 1:1, 1×10⁻²:1, or 0.1:1 to 1:1.

In some embodiments, the unit contains one or more agrichemical zones and wherein the dry weight ratio of the root development zones to the agrochemical zones in a dry unit is 0.05:1 to 10:1, 0.1:1 to 10:1, or 0.5:1 to 5:1.

In some embodiments, the unit contains one or more agrichemical zones and wherein the dry weight ratio of the root development zones to the agrochemical zones in a dry unit is 0.05:1 to 10:1, 0.1:1 to 10:1, or 0.5:1 to 5:1.

The invention provides a unit for delivery of agrochemicals to the roots of a plant comprising:
i) one or more root development zones,
ii) one or more agrochemical zones containing a fertilizer, and
iii) a pesticide,
wherein the agrochemical zones are formulated to release the fertilizer into the root development zones in a controlled release manner when the root development zones are swelled,
wherein the total amount of pesticide in the dry unit is 0.0004% to 0.5% of the total weight of the unit, wherein the weight ratio of pesticide to fertilizer in the unit is 5×10-6:1 to 6×10-3:1, or wherein the total amount of pesticide in the unit is less than 50 mg, and
wherein the dry weight ratio of the root development zones to the agrochemical zones in a dry unit is 0.05:1 to 0.32:1, or wherein the total volume of the root development zones in the unit is at least 0.2 mL when the unit is fully swelled. In some embodiments, the total amount of pesticide in the dry unit is 0.0004% to 0.5% of the total weight of the unit.

In some embodiments, the total amount of pesticide in the dry unit is 0.01% to 0.05%, 0.0005% to 0.1%, 0.01% to 0.05%, or 0.01% to 0.3% of the total weight of the unit.

In some embodiments, the total amount of pesticide in the dry unit is 0.06% of the total dry weight of the unit.

In some embodiments, the weight ratio of pesticide to fertilizer in the unit is 5×10⁻⁶:1 to 6×10³:1.

In some embodiments, the weight ratio of pesticide to fertilizer in the unit is 4.6×10⁻⁴:1.

In some embodiments, the total amount of pesticide in the unit is less than 50 mg.

In some embodiments, the total weight of the pesticide in the unit is less than 45 mg, less than 40 mg, less than 35 mg, less than 30 mg, less than 25 mg, less than 20 mg, less than 15 mg, less than 10 mg, less than 5 mg, or less than 1 mg.

In some embodiments, the total weight of the pesticide in the unit is 0.01 to 0.1 mg, 0.1 to 1 mg, 1 mg to 5 mg, 5 mg to 10 mg, 10 mg to 15 mg, 15 mg to 20 mg, 20 mg to 25 mg, 25 mg to 30 mg, 30 mg to 35 mg, 35 mg to 40 mg, 40 mg to 45 mg, or 45 mg to less than 50 mg.

In some embodiments, the total weight of the pesticide in the unit is 0.01 mg, less than 0.1 mg, 0.1 mg, less than 0.5 mg, 0.5 mg, 0.7 mg, 0.75 mg, 1 mg, 1.4 mg, 1.5 mg, 2 mg, 2.8 mg, 3 mg, 4 mg, 5 mg, 6 mg, 7 mg, 8 mg, 9 mg, 10 mg, 15 mg, 20 mg, 25 mg, 30 mg, 35 mg, 40 mg, or 45 mg.

In some embodiments, the pesticide is in one or more agrochemical zones.

In some embodiments, the agrochemical zones containing the pesticide are formulated to release the pesticide into the root development zones in a controlled release manner when the root development zones are swelled.

In some embodiments, the fertilizer and the pesticide are together in one or more agrochemical zones.

In some embodiments, the fertilizer and the pesticide are each in different agrochemical zones.

In some embodiments, the pesticide is dispersed throughout one or more root development zones and outside of an agrochemical zone.

In some embodiments, the pesticide is an insecticide, a fungicide, a nematicide, or an herbicide.

In some embodiments, the pesticide is an insecticide. In some embodiments, the pesticide is a fungicide. In some embodiments, the pesticide is a nematicide. In some embodiments, the pesticide is an herbicide.

In some embodiments, the unit comprises an insecticide which is imidacloprid, dinotefuran, thiacloprid, thiamethoxam, clothianidin, sulfoxaflor, spirotetramat, spiromesafen, spirodiclofen, acephate, or acetamiprid.

In some embodiments, the unit comprises a fungicide which is azoxystrobin, flutriafol, thiophanate methyl, imazalil, prochloraz, tebuconazole, fosetyl-A1, methalaxyl, mefenoxam, triadimenol, or propamocarb.

In some embodiments, the unit comprises an herbicide which is atrazine, glyphosate, imazethapyr, imazapic, imazamox, tribenuron, isoxaflutole, bromacyl, carbetamide, clomazone, diclosulam, diuron, florasulam, flufenacet, flumioxazine, fluorocloridone, hexazinone, metamitron, metazachlor, metribuzine, metsulfuron, pendimethalin, sulfentrazone, or trifloxysulfuron.

In some embodiments, the pesticide is a pesticide for soil pests and pathogens which is fluensulfone, propamocarb, flutolanil, fludioxonil, abamectin, fluopyram, or oxamyl.

In some embodiments, the pesticide is imidacloprid.

In some embodiments, the unit contains 0.7 mg, 1.4 mg, or 2.8 mg of imidacloprid.

In some embodiments, the pesticide is azoxystrobin.

In some embodiments, the unit contains 0.75 mg, 1.5 mg, or 3 mg of azoyxstrobin.

In some embodiments, the unit contains two or more pesticides.

In some embodiments, at least two of the two or more pesticides are together in at least one agrochemical zone.

In some embodiments, at least two of the two or more pesticides are each in different agrochemical zones.

In some embodiments, at least one of the two or more pesticides is dispersed throughout one or more root development zones and outside of an agrochemical zone.

In some embodiments, the unit contains two or more fertilizers.

In some embodiments, at least two of the two or more fertilizers are together in at least one agrochemical zone.

In some embodiments, at least two of the two or more fertilizers are each in different agrochemical zones.

In some embodiments, at least one of the two or more fertilizers is in an agrochemical zone which is formulated to release the fertilizers contained therein over a period of less than one week when the unit is swelled.

In some embodiments, the agrochemical zones contain a second fertilizer, wherein the agrochemical zones are not formulated to release the second fertilizer into the root development zones in a controlled release manner.

In some embodiments, the root development zones do not contain fertilizer or pesticide before the unit is swelled for the first time.

In some embodiments, the root development zones further comprise a fertilizer, a pesticide, or a fertilizer and a pesticide before the unit is swelled for the first time.

In some embodiments, the amount of the fertilizer, the pesticide, or the fertilizer and the pesticide in the root development zones is about 5%, 10%, 15% or 20% (w/w) of the amount of the fertilizer, pesticide, or the fertilizer and the pesticide, that is in the agrochemical zones.

In some embodiments, the weight ratio of the root development zones to the agrochemical zones in a dry unit is 0.05:1 to 0.32:1.

In some embodiments, the weight ratio of the root development zones to the agrochemical zones in a dry unit is 0.05:1, 0.1:1, 0.15:1, 0.2:1, 0.25:1, or 0.3:1.

In some embodiments, the weight ratio of the root development zones to the agrochemical zones in a dry unit is 0.01:1 to 0.5:1, 0.01:1 to 0.02:1, 0.01:1 to 0.03:1, 0.01:1 to 0.04:1, 0.01:1 to 0.05:1, 0.3:1 to 0.4:1, 0.3:1 to 0.4:1, 0.3:1 to 0.5:1

The invention provides a unit for delivery of agrochemicals to the roots of a plant comprising:
i) one or more root development zones, and
ii) one or more agrochemical zones containing at least one agrochemical,
   wherein the agrochemical zones are formulated to release the at least one agrochemical into the root development zones in a controlled release manner when the root development zones are swelled, and
   wherein the weight ratio of the root development zones to the agrochemical zones in a dry unit is 0.12:1, 0.14:1, or 0.21:1.

In some embodiments, the total volume of the root development zones in the unit is at least 2 mL when the unit is 1%, 5%, 10%, 15%, 20%, 25%, 30%, 35%, 40%, 45%, 50%, 1-50%, or 5-50% swelled.

In some embodiments, the total volume of the root development zones in the unit is greater than 2 mL, 2-3 mL, 3-4 mL, 4-5 mL, 2-5 mL, 2-10 mL, 5-10 mL, 5-20 mL, 10-15 mL, 10-20 mL, 15-20 mL, 10-40 mL, 20-40 mL, 20-80 mL, 40-80 mL, 50-100 mL, 75-150 mL, 100-150 mL, 150-300 mL, 200-400 mL, 300-600 mL, or 600-1000 mL when the unit is 1%, 5%, 10%, 15%, 20%, 25%, 30%, 35%, 40%, 45%, 50%, 1-50%, or 5-50% swelled.

In some embodiments, the total volume of the root development zones in the unit is at least 0.2 mL when the unit is fully swelled.

In some embodiments, the total volume of the root development zones in the unit is at least 2 mL when the unit is fully swelled.

In some embodiments, the total volume of the root development zones in the unit is at least at least 0.2 mL, at least 0.5 mL, at least 1 mL, at least 2 mL, at least 5 mL, at least 10 mL, at least 20 mL, at least 30 mL, at least 40 mL, at least 50 mL, at least 60 mL, at least 70 mL, at least 80 mL, at least, 90 mL, at least 100 mL, at least 150 mL, at least 200 mL, at least 250 mL, at least 300 mL, at least 350 mL, at least 400 mL, at least 450 mL, at least 500 mL, at least 550 mL, at least 600 mL or larger than 600 mL when the unit is fully swelled.

In some embodiments, the total volume of the root development zones in the unit is greater than 2 mL, 2-3 mL, 3-4 mL, 4-5 mL, 2-5 mL, 2-10 mL, 5-10 mL, 5-20 mL, 10-15 mL, 10-20 mL, 15-20 mL, 10-40 mL, 20-40 mL, 20-80 mL, 40-80 mL, 50-100 mL, 75-150 mL, 100-150 mL, 150-300 mL, 200-400 mL, 300-600 mL, or 600-1000 mL when the unit is fully swelled.

In some embodiments, the total volume of the root development zones when the unit is 1-100% swelled is large enough to contain 10-50 mm of a root having a diameter of 0.5-5 mm.

In some embodiments, the total volume of the root development zones when the unit is 1%-100% swelled is large enough to contain at least 10 mm of a root having a diameter of 0.5 mm.

In some embodiments, the total volume of the root development zones when the unit is 1%, 5%, 10%, 15%, 20%, 25%, 30%, 35%, 40%, 45%, 50%, 1-50% or 5-50% swelled is large enough to contain 10-50 mm of a root having a diameter of 0.5-5 mm.

In some embodiments, the total volume of the root development zones when the unit is 1%, 5%, 10%, 15%, 20%, 25%, 30%, 35%, 40%, 45%, 50%, 1-50% or 5-50% swelled is large enough to contain at least 10 mm of a root having a diameter of 0.5 mm.

In some embodiments, the unit has a dry weight of 0.1 g to 20 g.

In some embodiments, weight of the dry unit is 1-10 g. In some embodiments, the weight of the dry unit is 0.1, 1, 2, 3, 4, 5, 6, 7, 8, 9, or 10 g.

In some embodiments, the total weight of the agrochemical zones of the unit is 0.05 to 5 grams.

In some embodiments, the total weight of the agrochemical zones of the unit is 5 grams.

In some embodiments, the total weight of the agrochemical zones of the unit is 1.5 to 2 g.

In some embodiments, the total weight of the agrochemical zones of the unit is 1.5 g.

In some embodiments, the unit is in the shape of a cylinder.

In some embodiments, the unit is in the shape of a polyhedron.

In some embodiments, the unit is in the shape of a cube.

In some embodiments, the unit is in the shape of a disc.

In some embodiments, the unit is in the shape of a sphere.

In some embodiments, the agrochemical zones and the root development zones are adjoined.

In some embodiments, the unit consists of one root development zone which is next to one agrochemical zone.

In some embodiments, the agrochemical zones are partially contained within the root development zones such that the surface of the unit is formed by both the root development zones and the agrochemical zones.

In some embodiments, the unit is a bead comprising an external zone surrounding an internal zone, wherein the root development zones form the external zone and the agrochemical zones form the internal zone.

In some embodiments, the unit comprises one root development zone and one agrochemical zone.

In some embodiments, the unit comprises more than one agrochemical zone.

In some embodiments, the root development zones are partially contained within the agrochemical zones such that the surface of the unit is formed by both the root development zones and the agrochemical zones.

In some embodiments, an agrochemical zone is sandwiched between two root development zones.

In some embodiments, the agrochemical zone is surrounded by a root development zone which forms a perimeter around the agrochemical zone but which covers less than all of the surface of the agrochemical zone, or vice versa. In some embodiments, the perimeter is ring shaped.

In some embodiments, the root development zones comprise a super absorbent polymer (SAP).

In some embodiments, the root development zones are capable of absorbing at least about 10, 15, 20, 25, 30, 35, 40, 45, 50, 75, 80, 85, 90, 95, 100, 200, 300, 400, 500, or 1000 times their weight in water.

In some embodiments, the root development zones are capable of absorbing at least about 20-30 times their weight in water.

In some embodiments, the root development zones are permeable to oxygen.

In some embodiments, the root development zones are permeable to oxygen such that at least about 6 mg/L of dissolved oxygen is maintained in the root development zones when the root development zones are swelled.

In some embodiments, the root development zones when fully swelled are at least about 70, 75, 80, 85, 90, 95, or 100% as permeable to oxygen as swelled alginate or swelled semi-synthetic CMC.

In some embodiments, the root development zones comprise an aerogel.

In some embodiments, the root development zones comprise a geotextile.

In some embodiments, the root development zones comprise a sponge.

In some embodiments, the root development zones further comprise a polymer, a porous inorganic material, a porous organic material, or any combination thereof.

In some embodiments, the agrochemical zones further comprise an aerogel, a hydrogel, an organogel, a polymer, a porous inorganic material, a porous organic material, or any combination thereof.

In some embodiments, the unit further comprises cotton fibers.

In some embodiments, the root development zones are capable of being penetrated by the root of a plant when the root development zones are about 1%, 5%, 10%, 15%, 20%, 25%, 30%, 35%, 40%, 45%, 50%, 1-50%, or 5-50% swelled.

In some embodiments, roots of a plant are capable of growing within the root development zones when the root development zones are swelled.

In some embodiments, roots of a plant are capable of growing within the root development zones when the root development zones are about 1%, 5%, 10%, 15%, 20%, 25%, 30%, 35%, 40%, 45%, 50%, 1-50% or 5-50% swelled.

In some embodiments, the plant is a crop plant.

In some embodiments, the crop plant is a wheat plant, a maize plant, a soybean plant, a rice plant, a barley plant, a cotton plant, a pea plant, a potato plant, a tree crop plant, or a vegetable plant.

In some embodiments, the root development zones are biodegradable.

In some embodiments, the root development zones are about 1%, 5%, 10%, 15%, 20%, 25%, 30%, 35%, 40%, 45%, 50%, 1-50% or 5-50% swelled, the total weight of the root development zones is at least about 2, 3, 4, 5, 6, 7, 8, 9, 10, 20, 30, 40, 50, 60, 70, 80, 90, 100 or more than 100 times greater than the total weight of the agrochemical zones.

In some embodiments, the root development zones comprise a synthetic hydrogel, a natural carbohydrate hydrogel, or a pectin or protein hydrogel, or any combination thereof.

In some embodiments, the root development zones comprise an aerogel, a hydrogel or an organogel.

In some embodiments, the root development zones comprise a hydrogel.

In some embodiments, the hydrogel comprises hydroxyethyl acrylamide.

In some embodiments, the synthetic hydrogel comprises acrylamide, an acrylic derivative, or any combination thereof.

In some embodiments, the natural carbohydrate hydrogel comprises agar, cellulose, chitosan, starch, hyaluronic acid, a dextrine, a natural gum, a sulfated polysaccharide, or any combination thereof.

In some embodiments, the pectin or protein hydrogel comprises gelatin, a gelatin derivative, collagen, a collagen derivative, or any combination thereof.

In some embodiments, the root development zones comprise a natural super absorbent polymer (SAP), a poly-sugar SAP, a semi-synthetic SAP, a fully-synthetic SAP, or any combination thereof.

In some embodiments, the root development zones are capable of absorbing at least about 10, 15, 20, 25, 30, 35, 40, 45, 50, 75, 80, 85, 90, 95, 100, 200, 300, 400, 500, or 1000 times their weight in water.

In some embodiments, the root development zones further comprise at least one oxygen carrier that increases the amount of oxygen in the root development zones compared to corresponding root development zones not comprising the oxygen carrier.

In some embodiments, the at least one oxygen carrier is a perfluorocarbon.

In some embodiments, the agrochemical zones comprise an organic polymer, a natural polymer, or an inorganic polymer, or any combination thereof.

In some embodiments, the agrochemical zones are partially or fully coated with a coating system.

In some embodiments, the coating system dissolves into the root development zones when the root development zones are swelled.

In some embodiments, the coating system slows the rate at which at least one agrochemical in the agrochemical zones dissolves into the root development zones when the root development zones are swelled.

In some embodiments, the units comprise a coating system which covers all surfaces of the agrochemical zones which would otherwise be on the surface of the unit and which is impermeable to at least one agrochemical in the agrochemical zones.

In some embodiments, the coating system comprises sulfur, pentadiene, and D-triethylphosphate.

In some embodiments, the coating system is silicate or silicon dioxide.

In some embodiments, the coating system is a polymer.

In some embodiments, the coating system is an agrochemical.

In some embodiments, the units comprise a fertilizer, a pesticide, a hormone compound, a drug compound, a chemical growth agent, an enzyme, a growth promoter, a microelement, or any combination thereof.

In some embodiments, the root development zones are capable of repeated swelling cycles that each comprises hydration followed by dehydration.

In some embodiments, the root development zones are capable of repeated swelling cycles in soil that each comprise hydration followed by dehydration while in the soil.

In some embodiments, the unit is in the shape of a sphere or an equivalent polyhedron after repeated swelling cycles.

In some embodiments, the root development zones, when swelled, maintain at least about 75%, 80%, 85%, 90%, or 95% of their water content over a period of at least about 25, 50, 100, or 150 hours in soil.

In some embodiments, the root development zones, when swelled, maintain at least about 75%, 80%, 85%, 90%, or 95% of their water content over a period of at least about 25, 50, 100, or 150 hours in sandy soil.

In some embodiments, the root development zones, when swelled, maintain at least about 75%, 80%, 85%, 90%, or 95% of their volume over a period of at least about 25, 50, 100, or 150 hours in soil.

In some embodiments, the root development zones, when swelled, maintain at least about 75%, 80%, 85%, 90%, or 95% of their volume over a period of at least about 25, 50, 100, or 150 hours in sandy soil.

In some embodiments, the root development zones, when swelled, maintain their shape over a period of at least about 25, 50, 100, or 150 hours in soil.

In some embodiments, the root development zones, when swelled, maintain their shape over a period of at least about 25, 50, 100, or 150 hours in sandy soil.

In some embodiments, the root development zones, when swelled, maintain their shape after repeated swelling cycles that each comprises hydration followed by dehydration.

In some embodiments, the root development zones, when swelled maintain their shape after at least 3 swelling cycles that each comprises hydration followed by dehydration.

In some embodiments, the root development zones, when swelled in soil, have a pH or osmotic pressure that differs from the pH or osmotic pressure of the surrounding soil by at least about 10%.

In some embodiments, the widest part of the unit is about 1, 2, 3, 4, 5, 6, 7, 8, 9, 10 cm, or more than 10 cm when the root development zones are about 1%, 5%, 10%, 15%, 20%, 25%, 30%, 35%, 40%, 45%, 50%, 1-50% or 5-50% swelled.

In some embodiments, when the root development zones are about 5%, 10%, 15%, 20%, 25%, 30%, 35%, 40%, 45%, 50%, or 5-50% swelled, the total weight of the root development zones is at least about 2, 3, 4, 5, 6, 7, 8, 9, 10, 20, 30, 40, 50, 60, 70, 80, 90, 100 or more than 100 times greater than the total weight of the agrochemical zones.

In some embodiments, the root development zones comprise a natural super absorbent polymer (SAP), a poly-sugar SAP, a semi-synthetic SAP, a fully-synthetic SAP, or any combination thereof.

In some embodiments, the root development zones comprise a combination of at least one natural SAP and at least one semi-synthetic or synthetic SAP.

In some embodiments, the root development zones comprise a poly-sugar SAP.

In some embodiments, the poly-sugar SAP is alginate.

In some embodiments, the alginate is at least about 0.2% alginate.

In some embodiments, the root development zones comprise a semi-synthetic SAP.

In some embodiments, the semi-synthetic SAP is a CMC-g-polyacrylic acid SAP.

In some embodiments, the Carboxymethyl cellulose (CMC) grafted polyacrylic acid SAP comprises 6% CMC relative to the acrylic monomers (Acrylamide-acrylic), 6% CMC relative to acrylic acid, 25% CMC relative to acrylic acid, or CMC 50% AA.

In some embodiments, the CMC grafted SAP comprises 5-50% CMC relative the acrylic monomers. In some embodiments, the CMC grafted SAP comprises 6-12% CMC relative the acrylic monomers.

In some embodiments, the semi-synthetic SAP is k-carrageenan cross-linked-polyacrylic acid SAP.

In some embodiments, the SAP is other than alginate or a k-carrageenan cross-linked-polyacrylic acid SAP.

In some embodiments, the root development zones comprise a fully synthetic SAP.

In some embodiments, the fully synthetic SAP is acrylic acid or acrylic amide or any of the combinations thereof.

In some embodiments, the amount of cross-linker in the root development zones is below 5% relative to the total monomer content by weight. In some embodiments, the amount of cross-linker in the root development zones is below 2% relative to the total monomer content by weight. In some embodiments, the amount of cross-linker in the root development zones is below 1% relative to the total monomer content by weight.

In some embodiments, the polymer content of a swelled unit is below 5% by weight. In some embodiments, the polymer content of a swelled unit is below 4%, below 3%, below 2%, or below 1% by weight.

In some embodiments, the agrochemical zones comprise an organic polymer, a natural polymer, or an inorganic polymer, or any combination thereof.

In some embodiments, the agrochemical zones comprise a polymer.

In some embodiments, the polymer is a highly cross-linked polymer.

In some embodiments, the highly cross-linked polymer is a poly-sugar or a poly-acrylic polymer.

In some embodiments, the agrochemical zones comprises a filler.

In some embodiments, the filler comprises a cellulosic material, a cellite, a polymeric material, a silicon dioxide, a phyllosilicate, a clay mineral, metal oxide particles, porous particles, or any combination thereof.

In some embodiments, the filler comprises a phyllosilicate of the serpentine group.

In some embodiments, the phyllosilicate of the serpentine group is antigorite (Mg₃Si₂O₅(OH)₄), chrysotile (Mg₃Si₂O₅(OH)₄), or lizardite (Mg₃Si₂O₅(OH)₄).

In some embodiments, the filler comprises a clay mineral, which is halloysite (Al₂Si₂O₅(OH)₄), kaolinite (Al₂Si₂O₅(OH)₄), illite ((K,H₃O)(Al,Mg,Fe)₂(Si,Al)₄O₁₀[(OH)₂,(H₂O)]), montmorillonite ((Na,Ca)_{0.33}(Al,Mg)₂Si₄O₁₀(OH)₂.nH₂O), vermiculite ((MgFe,Al)₃(Al,Si)₄O₁₀(OH)₂.4H₂O), talc (Mg₃Si₄O₁₀(OH)₂), palygorskite ((Mg,Al)₂Si₄O₁₀(OH).4(H₂O), or pyrophyllite (Al₂Si₄O₁₀(OH)₂).

In some embodiments, the filler comprises a phyllosilicate of the mica group.

In some embodiments, the phyllosilicate of the mica group is biotite (K(Mg,Fe)₃(AlSi₃)O₁₀(OH)₂), muscovite (KAl₂(AlSi₃)O₁₀(OH)₂), phlogopite (KMg₃(AlSi₃)O₁₀(OH)₂), lepidolite (K(Li,Al)₂₋₃(AlSi₃)O₁₀(OH)₂), margarite (CaAl₂(Al₂Si₂)O₁₀(OH)₂), glauconite ((K,Na)(Al,Mg,Fe)₂(Si,Al)₄O₁₀(OH)₂), or any combination thereof.

In some embodiments, the filler comprises a phyllosilicate of the chlorite group.

In some embodiments, the a phyllosilicate of the chlorite group is chlorite ((Mg,Fe)₃(Si,Al)₄O₁₀(OH)₂.(Mg,Fe)₃(OH)₆).

In some embodiments, the filler forms a beehive-like structure.

In some embodiments, the beehive-like structure is microscopic.

In some embodiments, the filler comprises clay.

In some embodiments, the filler comprises zeolite.

In some embodiments, the agrochemical zones comprise at least about 0.05, 0.1, 0.2, 0.3, 0.4, 0.5, 0.6, 0.7, 0.8, 0.9, or 1 grams of the at least one agrochemical.

In some embodiments, the agrochemical zones comprise 1-10 grams of the at least one agrochemical.

In some embodiments, the agrochemical zones are about 30%, 35%, 40%, 45%, 50%, 55%, or 60% of the at least one agrochemical by weight.

In some embodiments, the agrochemical zones are biodegradable.

In some embodiments, the unit comprises one agrochemical zone.

In some embodiments, the unit comprises 2, 3, 4, 5, 6, 7, 8, 9, 10 or more than 10 agrochemical zones.

In some embodiments, the unit comprises 2, 3, 4, 5, 6, 7, 8, 9, 10 or more than 10 root development zones.

In some embodiments, the at least one agrochemical is:

i) at least one fertilizer compound;
ii) at least one pesticide compound;
iii) at least one hormone compound;
iv) at least one drug compound;
v) at least one chemical growth agents;
vi) at least one enzyme;
vii) at least one growth promoter;
viii) at least one microelement;
ix) at least one biostimulant agent;
and any combination thereof.

In some embodiments, the fertilizer compound is a natural fertilizer.

In some embodiments, the fertilizer compound is a synthetic fertilizer.

In some embodiments, the pesticide is:
i) at least one insecticide compound;
ii) at least one nematicide compound;
iii) at least one herbicide compound;
iv) at least one fungicide compound, or
v) any combination of (i)-(v).

In some embodiments, the insecticide compound is imidacloprid.

In some embodiments, the herbicide compound is pendimethalin.

In some embodiments, the fungicide compound is azoxystrobin.

In some embodiments, the nematicide compound is fluensulfone.

In some embodiments, the fertilizer is PO₄, NO₃, (NH₄)₂SO₂, NH₄H₂PO₄, KCl, or any combination thereof.

In some embodiments, the fertilizer is one or more macro nutrients selected from N, P, K, Ca, Mg, and S and, optionally, one or more micro nutrients selected from B, Cu, Fe, Zn, Mn and Mb with or without one or more pesticides.

In some embodiments, the fertilizer comprises urea and KCl. In some embodiments, the fertilizer is 60% urea and 30% KCl by weight.

In some embodiments, the fertilizer comprises multiple fertilizer compounds which include PO₄, NO₃, (NH₄)₂SO₂, NH₄H₂PO₄, and/or KCl.

In some embodiments, the pesticide is at least one pesticide compound that is not suitable for application to an agricultural field.

In some embodiments, the pesticide is a pesticide which is not suitable for application to an agricultural field because it is too toxic to be applied to an agricultural field using conventional soil treatment.

In some embodiments, the pesticide is toxic to animals other than arthropods or mollusks when applied to an agricultural field in an amount that is sufficient to kill an arthropod or a mollusk.

In some embodiments, the fertilizer, the pesticide, or the fertilizer and the pesticide is released from the agrochemical zones over a period of at least about one week when the root development zones are swelled.

In some embodiments, the fertilizer, the pesticide, or the fertilizer and the pesticide is released from the agrochemical zones into the root development zones over a period of at least about 2, 3, 4, 5, 6, 7, 8, 9, 10, or 20 weeks when the root development zones are swelled.

In some embodiments, the fertilizer, the pesticide, or the fertilizer and the pesticide is released from the agrochemical zones into the root development zones over a period of at least about 2, 3, 4, 5, 6, 7, 8, 9, 10, or 20 weeks when the root development zones are about 1%, 5%, 10%, 15%, 20%, 25%, 30%, 35%, 40%, 45%, 50%, 1-50% or 5-50% swelled.

In some embodiments, when the root development zones are swelled and the unit is in soil, the fertilizer, the pesticide, or the fertilizer and the pesticide diffuses from the surface of the unit into the surrounding soil at a linear rate beginning about 25 days after hydration.

In some embodiments, when the root development zones of the unit are swelled and the unit is in soil, the fertilizer, the pesticide, or the fertilizer and the pesticide diffuses from the surface of the unit into the surrounding soil for at least about 50 or 90 days after hydration.

In some embodiments, the unit is not swelled.

In some embodiments, the unit contains less than about 35%, 30%, 25%, 20%, 15%, or 10% water by weight.

In some embodiments, the unit comprises one or more interface zone between the agrochemical zones and the root development zones, which interface zone is formed by at least one insoluble salt or solid, at least one cross-linking agent, or at least one inorganic compound.

In some embodiments, diffusion between the root development zones and the agrochemical zones is limited by altering the pH or the cation concentration in the agrochemical zones, the root development zones, or the interface zone.

In some embodiments, diffusion between the root development zones and the agrochemical zones is limited by altering the pH and/or cation concentration in the agrochemical zone or the root development zone.

In some embodiments, the pH in the agrochemical zones or the root development zones is altered by a buffer.

In some embodiments, the pH in the agrochemical zones, the interface zones, and the root development zones is altered by a buffer.

The invention provides a method of growing a plant, comprising adding at least one unit of the invention to the medium in which the plant is grown.

In some embodiments, the method comprises a step of selecting the size of the unit based upon the specific plant to be grown. For example, it may be desirable to select a unit having a large swelled size when growing a plant having large diameter roots and it may be desirable to select a unit having a smaller swelled size when growing a plant having small diameter roots. In some embodiments, it may be desirable to use more units of a given size when growing a plant having a large root system than when growing a plant having a small root system.

In some embodiments, the medium in which the plant is grown comprises soil.

In some embodiments, the medium in which the plant is grown is soil.

In some embodiments, the soil comprises sand, silt, clay, or any combination thereof.

In some embodiments, the soil is clay, loam, clay-loam, or silt-loam.

In some embodiments, the soil is an Andisol.

In some embodiments, the at least one unit is added to the soil at one or more depths below the soil surface. In some embodiments, the at least one unit is added at a depth of 5-50 cm. In some embodiments, the at least one unit is added at a depth of 5 cm, 10 cm, 15 cm, 20 cm, 25 cm, 30 cm, 35 cm, 40 cm, 45 cm, or 50 cm, or any combination of 2, 3, or 4 of the foregoing depths.

The invention provides a method of reducing environmental damage caused by a fertilizer, a pesticide, or a fertilizer and a pesticide, comprising delivering the fertilizer and the pesticide to the root of a plant by adding at least one unit of the invention to the medium of the plant.

The invention provides a method of reducing environmental damage caused by agrochemicals, comprising delivering the agrochemicals to the root of a plant by adding at least one unit of the invention to the medium of the plant.

In some embodiments, minimizing exposure to the fertilizer, the pesticide, or the fertilizer and the pesticide is minimizing the exposure of a farmer to the fertilizer, the pesticide, or the fertilizer and the pesticide.

In some embodiments, minimizing exposure to the fertilizer, the pesticide, or the fertilizer and the pesticide is minimizing exposure of a person other than the farmer to the fertilizer, the pesticide, or the fertilizer and the pesticide.

The present invention provides a method of generating an artificial zone with predetermined chemical properties within the root zone of a plant, comprising:
i) adding one or more units of the invention to the medium of the root zone of the plant; or
ii) adding one or more units of the invention to the anticipated root zone of the medium in which the plant is anticipated to grow.

In some embodiments, step i) comprises adding at least two different units to the medium of the root zone of the plant; and step ii) comprises adding at least two different units to the anticipated root zone of the medium in which the plant is anticipated to grow, wherein at least one of the at least two different units is a unit of the invention.

In some embodiments, each of the at least two different units contains at least one agrochemical that is not contained within one of the other at least two different units.

The invention provides a method of fertilizing a plant comprising adding at least one unit of the invention to the medium in which the plant is grown.

The invention provides a method of protecting a plant from a pest comprising adding at least one unit of the invention to the medium in which the plant is grown.

In some embodiments, the amount of the pesticide contained in all of the units added to the medium is substantially less than the amount of the pesticide which would be needed to achieve the same level of pest protection when applying the pesticide by foliar spraying, soil drenching, above ground distribution, or soil spraying.

In some embodiments, the amount of pesticide contained in all of the units added to the medium is less than 90%, less than 80%, less than 70%, less than 60%, or less than 50% of the amount of the pesticide which would be needed to achieve the same level of pest protection when applying the pesticide by foliar spraying, soil drenching, above ground distribution, or soil spraying.

In some embodiments, 300,000 to 700,000 units are added per hectare of medium.

In some embodiments, the units comprise 1.5 g of fertilizer, and 500,000 units are added per hectare of medium.

In some embodiments, the unit contains an insecticide, and the number of units added per hectare of medium contain 100 to 500 g of insecticide.

In some embodiments, the unit contains an herbicide, and the number of units added per hectare of medium contain 5 to 1000 g of herbicide.

In some embodiments, the unit contains a fungicide, and the number of units added per hectare of medium contains 100 to 500 g of fungicide.

In some embodiments, the unit contains a pesticide for soil pests and pathogens, and the number of units added her hectare of medium contains 100 to 3000 g of the pesticide for soil pests and pathogens.

In some embodiments, the unit contains an herbicide, and the plant is resistant to the herbicide.

In some embodiments, the plant is a soybean plant and the herbicide is an imidazolinone.

In some embodiments, the plant is wheat, canola, or sunflower and the herbicide is pendimethalin.

In some embodiments, the plant is genetically modified crop with herbicide resistance.

In some embodiments, the plant is genetically modified soybean, genetically modified alfalfa, genetically modified corn, genetically modified cotton, genetically modified canola, or genetically modified sugarbeets, and the herbicide is glyphosate.

In some embodiments, 4-20 units are added to the medium per plant.

In some embodiments, the plant is grown in a field.

In some embodiments, the plant is a crop plant.

In some embodiments, the crop plant is a grain or a tree crop plant.

In some embodiments, the crop plant is a fruit or a vegetable plant.

In some embodiments, the plant is a banana, barley, bean, cassava, corn, cotton, grape, orange, pea, potato, rice, soybean, sugar beet, tomato, or wheat plant.

In some embodiments, the plant is a sunflower, cabbage plant, lettuce, or celery plant.

In some embodiments, the units are added to the medium where the plant is growing.

In some embodiments, the units are added to the medium where the plant is to be grown.

In some embodiments, seeds for growing the plant are added to the medium before the units are added to the medium.

In some embodiments, seeds for growing the plant are added to the medium at the same time the units are added to the medium.

In some embodiments, seeds for growing the plant are added to the medium after the units are added to the medium.

In some embodiments, the medium is soil.

In some embodiments, the units comprise one fertilizer compound. In some embodiments, the units comprise two fertilizer compounds. In some embodiments, the units comprise three fertilizer compounds.

In some embodiments, the units comprise more than three fertilizer compounds.

In some embodiments, the units comprise one to three fertilizer compounds, such that the total N, P, and/or K content as (NH₄)₂SO₂, NH₄H₂PO₄, and KCl in the medium as part of the units is about 5-50, 1-10, and 5-60 g/m², respectively.

In some embodiments, the units comprise three fertilizer compounds, such that the total N, P, and K content as (NH₄)₂SO₂, NH₄H₂PO₄, and KCl in the medium as part of the units is about 25, 5, and 30 g/m², respectively.

In some embodiments, roots of a crop plant are capable of penetrating the hydrogel when the hydrogel is about 1%, 5%, 10%, 15%, 20%, 25%, 30%, 35%, 40%, 45%, 50%, 1-50% or 5-50% hydrated.

In some embodiments, roots of a crop plant are capable of growing within the hydrogel when the hydrogel is hydrated.

In some embodiments, roots of a crop plant are capable of growing within the hydrogel when the hydrogel is about 1%, 5%, 10%, 15%, 20%, 25%, 30%, 35%, 40%, 45%, 50%, 1-50% or 5-50% hydrated.

In some embodiments, the crop plant is a sunflower plant. In some embodiments, the crop plant is a cabbage plant. In some embodiments, the crop plant is wheat plant. In some embodiments, the crop plant is maize plant. In some embodiments, the crop plant is a soybean plant. In some embodiments, the crop plant is a rice plant. In some embodiments, the crop plant is a barley plant. In some embodiments, the crop plant is a cotton plant. In some embodiments, the crop plant is a pea plant. In some embodiments, the crop plant is a potato plant. In some embodiments, the crop plant is a tree crop plant. In some embodiments, the crop plant is a vegetable plant.

Each embodiment disclosed herein is contemplated as being applicable to each of the other disclosed embodiments. Thus, all combinations of the various elements described herein are within the scope of the invention.

It is understood that where a parameter range is provided, all integers within that range, and tenths thereof, are also provided by the invention. For example, “0.2-5 mg/kg/day” is a disclosure of 0.2 mg/kg/day, 0.3 mg/kg/day, 0.4 mg/kg/day, 0.5 mg/kg/day, 0.6 mg/kg/day etc. up to 5.0 mg/kg/day.

Unless stated otherwise or required by context, when a value is provided for an amount of a pesticide, e.g. as a weight in mg, a ratio, or a percentage by weight, the value refers to the amount of active ingredient (a.i.) of the pesticide.

### Terms

Unless otherwise defined, all technical and scientific terms used herein have the same meaning as commonly understood by a person of ordinary skill in the art to which this invention belongs.

As used herein, and unless stated otherwise or required otherwise by context, each of the following terms shall have the definition set forth below.

As used herein, “about” in the context of a numerical value or range means±10% of the numerical value or range recited or claimed, unless the context requires a more limited range.

An “agrochemical zone” is a component of a unit of the invention which contains at least one agrochemical and which releases the at least one agrochemical into the root development zones of a unit of the invention. In some embodiments, the at least one agrochemical is released into the root development zones of a unit of the invention by diffusion when the root development zones of the unit are hydrated.

The term “coating system” means one or more compounds which delays or prevents the release of an agrochemical from the surface of an agrochemical zone which is covered by the coating system. In some embodiments, the coating system comprises a single coat compound. In some embodiments, the coating system comprises more than one coat compound. In some embodiments, the coating system comprises more than one layer. In some embodiments, each layer of the coating system is of the same composition. In some embodiments, each layer of the coating composition is of a different composition. In some embodiments, the coating system comprises two, three, or four layers.

The term “controlled release” when used to refer to an agrochemical zone means that the agrochemical zone is formulated to release one or more agrochemicals of the agrochemical zone gradually over time. In some embodiments, the agrochemical zones are formulated to release at least one agrochemical into the root development zones over a period of at least about one week when the root development zones are swelled. In some embodiments, the agrochemical zones are formulated to release at least one agrochemical into the root development zones over a period greater than one week when the root development zones are swelled. “Controlled release” is interchangeable with the term “slow release” (“SR”).

“DAP” means days after planting.

Unless required otherwise by context, a “unit” refers to a unit for delivery of agrochemicals to the roots of a plant as described herein. A “fertilizer unit” refers to a unit for delivery of agrochemicals to the roots of a plant as described herein which comprises a fertilizer. A “fertilizer/pesticide unit” refers to a unit for delivery of agrochemicals to the roots of a plant as described herein which comprises a fertilizer and a pesticide.

An “empty unit” comprises the root development zone component of a unit of the invention unaccompanied by the agrochemical zone component. In some embodiments, an empty unit has the same shape and/or dimensions as the corresponding unit of the invention.

A “root development zone” is a component of a unit of the invention which, when hydrated, can be penetrated by a growing root. In some embodiments, the growing root can grow and develop within the root development zone of a unit. In some embodiments, a root development zone is a super absorbent polymer (SAP). In some embodiments, the root development zone is an aerogel, a geotextile, or a sponge. In some embodiments, the root development zone will take up water from the surrounding environment when, for example, the unit is placed in soil which is subsequently irrigated. In some embodiments, the hydrated root development zones create an artificial environment in which a growing root can uptake water and nutrients. In some embodiments, the root development zones of a unit are formulated to contain one or more agrochemicals which are the same or different than the agrochemicals of the agrochemical zones of the unit. While the invention described herein is not limited to any particular mechanism of action, it is believed that a growing root is attracted to the root development zones of a unit because of the presence of water and/or agrochemicals (e.g. minerals) in the root development zones. It is believed that roots can continue to grow and develop within the root development zones of units because of the continued availability of water and/or agrochemicals in the units.

Use of the term “root development zones” means one or more root development zones and use of the term “agrochemical zones” means one or more agrochemical zones unless stated otherwise or required otherwise by context.

Plants provided by or contemplated for use in embodiments of the present invention include both monocotyledons and dicotyledons. In some embodiments, a plant is a crop plant. As used herein, a “crop plant” is a plant which is grown commercially. In some embodiments, the plants of the present invention are crop plants (for example, cereals and pulses, maize, wheat, potatoes, tapioca, rice, sorghum, millet, cassava, barley, or pea), or other legumes. In some embodiments, the crop plants may be grown for production of edible roots, tubers, leaves, stems, flowers or fruit. The plants may be vegetable or ornamental plants. Non-limiting examples of crop plants of the invention include: Acrocomia aculeata (macauba palm), Arabidopsis thaliana, Aracinis hypogaea (peanut), Astrocaryum murumuru (murumuru), Astrocaryum vulgare (tucumã), Attalea geraensis (Indaiã-rateiro), Attalea humilis (American oil palm), Attalea oleifera (andaiã), Attalea phalerata (uricuri), Attalea speciosa (babassu), Avena sativa (oats), Beta vulgaris (sugar beet), Brassica sp. such as Brassica carinata, Brassica juncea, Brassica napobrassica, Brassica napus (canola), Camelina sativa (false flax), Cannabis sativa (hemp), Carthamus tinctorius (safflower), Caryocar brasiliense (pequi), Cocos nucifera (Coconut), Crambe abyssinica (Abyssinian kale), Cucumis melo (melon), Elaeis guineensis (African palm), Glycine max (soybean), Gossypium hirsutum (cotton), Helianthus sp. such as Helianthus annuus (sunflower), Hordeum vulgare (barley), Jatropha curcas (physic nut), Joannesia princeps (arara nut-tree), Lemna sp. (duckweed) such as Lemna aequinoctialis, Lemna disperma, Lemna ecuadoriensis, Lemna gibba (swollen duckweed), Lemna japonica, Lemna minor, Lemna minuta, Lemna obscura, Lemna paucicostata, Lemna perpusilla, Lemna tenera, Lemna trisulca, Lemna turionifera, Lemna valdiviana, Lemna yungensis, Licania rigida (oiticica), Linum usitatissimum (flax), Lupinus angustifolius (lupin), Mauritia flexuosa (buriti palm), Maximiliana maripa (inaja palm), Miscanthus sp. such as Miscanthus×giganteus and Miscanthus sinensis, Nicotiana sp. (tabacco) such as Nicotiana tabacum or Nicotiana benthamiana, Oenocarpus bacaba (bacaba-do-azeite), Oenocarpus bataua (patauã), Oenocarpus distichus (bacaba-de-leque), Oryza sp. (rice) such as Oryza sativa and Oryza glaberrima, Panicum virgatum (switchgrass), Paraqueiba paraensis (mari), Persea amencana (avocado), Pongamia pinnata (Indian beech), Populus trichocarpa, Ricinus communis (castor), Saccharum sp. (sugarcane), Sesamum indicum (sesame), Solanum tuberosum (potato), Sorghum sp. such as Sorghum bicolor, Sorghum vulgare, Theobroma grandiforum (cupuassu), Trifolium sp., Trithrinax brasiliensis (Brazilian needle palm), Triticum sp. (wheat) such as Triticum aestivum, Zea mays (corn), alfalfa (Medicago sativa), rye (Secale cerale), sweet potato (Lopmoea batatus), cassava (Manihot esculenta), coffee (Cofea spp.), pineapple (Anana comosus), citris tree (Citrus spp.), cocoa (Theobroma cacao), tea (Camellia senensis), banana (Musa spp.), avocado (Persea americana), fig (Ficus casica), guava (Psidium guajava), mango (Mangifer indica), olive (Olea europaea), papaya (Carica papaya), cashew (Anacardium occidentale), macadamia (Macadamia intergrifolia) and almond (Prunus amygdalus).

Unless stated otherwise or required otherwise by context, “swelled” means that a material has an absorbed amount of water which is at least about 1% of the amount of water that would be absorbed by the material if placed in deionized water for 24 hours at 21° C. When the material is a hydrogel, a “swelled” hydrogel can be referred to as a “hydrated” hydrogel. In some embodiments, a swelled material has an absorbed amount of water which is at least about 2% of the amount of water that would be absorbed by the material if placed in deionized water for 24 hours at 21° C. In some embodiments, a swelled material has an absorbed amount of water which is at least about 3% of the amount of water that would be absorbed by the material if placed in deionized water for 24 hours at 21° C. In some embodiments, a swelled material has an absorbed amount of water which is at least about 4% of the amount of water that would be absorbed by the material if placed in deionized water for 24 hours at 21° C. In some embodiments, a swelled material has an absorbed amount of water which is at least about 5% of the amount of water that would be absorbed by the material if placed in deionized water for 24 hours at 21° C.

Unless stated otherwise or required otherwise by context, “hydrated” means at least about 1% hydrated. In some embodiments, “hydrated” means at least about 2% hydrated. In some embodiments, “hydrated” means at least about 3% hydrated. In some embodiments, “hydrated” means at least about 4% hydrated. In some embodiments, “hydrated” means at least about 5% hydrated.

As used herein, a “fully swelled” unit of the invention is a unit which contains an amount of absorbed water which is equal to the amount of water the unit would absorb if placed in deionized water for 24 hours at 21° C.

As used herein, an artificial environment means a media located within the root zone of an agricultural field or a garden plant loaded with at least one agrochemical, encourages root growth and uptake activity within its internal periphery. Non-limiting examples of agrochemicals include pesticides, including insecticides, herbicides, and fungicides. Agrochemicals may also include natural and synthetic fertilizers, hormones and other chemical growth agents.

The agrochemical zone may contain the input (fertilizer, pesticide, or other agrochemical) in a structure that controls its release into the root development zone. The release rate is designed to meet plant demands throughout the growing season. In some embodiments, no input residuals remain at the end of a predetermined action period.

Units made with a water soluble pesticide may be formulated so that the water soluble pesticide is contained in one or more agrochemical zones together with or without other agrochemicals, e.g. fertilizers. These agrochemical zones may be formulated to release the pesticide into the root development zones in a controlled release manner.

Units made with hydrophobic pesticides may be formulated so that the hydrophobic pesticide is contained in one or more agrochemical zone together with or without other agrochemicals, e.g. fertilizers. These agrochemical zones do not need to be formulated with a controlled release mechanism, e.g. a coating system, because the hydrophobic nature of the pesticide will limit its rate of release into the root development zones. Alternatively, hydrophobic pesticides can be dispersed throughout a root development zone without being contained in any agrochemical zone. The hydrophobic nature of the pesticide will limit the rate at which the pesticide leaches from the unit into the surrounding medium. Thus, in some instances, it will be economically advantageous to formulate hydrophobic pesticides in one or more agrochemical zones lacking a controlled release mechanism, and/or to disperse the pesticide throughout one or more root development zones.

In some embodiments, the agrochemical zone comprises one or more fertilizers, pesticides, and/or other agrochemicals such as nitrogen, phosphorus, potassium, etc., in a beehive like structure made from highly cross linked polymer coated with silica or highly cross linked poly acrylic acid/poly sugar with a clay filler.

In some embodiments, the agrochemical zone comprises fertilizer, pesticide, and/or at least one other agrochemical in a beehive like structure with or without an external coating.

A root development zone which surrounds an agrochemical zone may be referred to herein as a “shell.”

Root development zones of the present invention are sustainable in soils, and encourage root penetration, uptake activity, and growth and/or development in the root development zone. In some embodiments, a super absorbent polymer may serve as the root development zone since during watering it can absorb soil moisture, swell and maintain its high water content over long period of time. These features establish a zone where gradual transition of chemical concentration exists between the agrochemical zone to the periphery of the root development zone allowing root uptake activity during the unit of the invention's life cycle. In some embodiments, the root development zone has features such as mechanical resistance (in order to maintain its shape and geometry in the soil); swelling cycle capability (capable of repeated hydration and dehydration in response to soil water content); oxygen permeability-(maintaining sufficient oxygen level to support root activity, such as root development); and root penetration (allowing the growth of roots into it).

Materials that may be used in the present invention include but are not limited to: 1) clay 2) zeolite 3) tuff 4) fly ash 5) hydrogel 6) foam.

In some embodiments, an artificial environment of the present invention serves as a buffer for soil type and pH to provide universal root growth environment. In some embodiments, an artificial environment of the present invention contains needed materials and nutrients in the desired conditions, such as but not limited to water, fertilizers, drugs, and other additives.

### Oxygen Permeability

Aspects of the present invention relate to root development zones having SAPs that are permeable to oxygen when hydrated. Roots use oxygen for growth and development (Drew, 1997; Hopkins 1950). Therefore, the oxygen permeability of a SAP is an important factor in determining whether it will support root growth and development within a root development zone that comprises the SAP.

Without wishing to be bound by any scientific theory, since hydrogels of the present invention supply water, nutrients and weak resistance, the data hereinbelow show that provided the gas diffusion is high enough, roots will develop in most types of small-volume hydrogels and hydrogel containing units, installed in a field soil. For example, alginate hydrogel, which is suitably permeable to oxygen, encourages root development, whereas starch hydrogel, which is poorly permeable to oxygen does not encourage root development. Additionally, semi-synthetic CMC is also suitably permeable to oxygen. The ability of oxygen to diffuse into root development zones of the present invention is important for root development within them.

Aspects of the present invention relate to the selection of SAPs, such as hydrogels, that are sufficiently permeable to oxygen when hydrated. Oxygen permeability may be measured to determine whether a hydrated SAP is sufficiently permeable to oxygen for use in embodiments of the present invention. In some embodiments, the SAP is permeable to oxygen such that it supports root growth and/or development. In some embodiments, the SAP when hydrated is at least about 70, 75, 80, 85, 90, 95, or 100% as permeable to oxygen as hydrated alginate. In some embodiments, the SAP when hydrated is at least about 70, 75, 80, 85, 90, 95, or 100% as permeable to oxygen as hydrated semi-synthetic CMC.

Oxygen permeability may be measured according to assays that are well known in the art. Non-limiting examples of methods that may be useful for measuring oxygen permeability of SAPs of the invention are described in Aiba et al. (1968) “Rapid Determination of Oxygen Permeability of Polymer Membranes” Ind. Eng. Chem. Fundamen., 7(3), pp 497-502; Yasuda and Stone (1962) “Permeability of Polymer Membranes to Dissolved Oxygen” Cedars-Sinai Medical Center Los Angeles Calif. Polymer Div, 9 pages, available from www.dtic.mil/cgi-bin/GetTRDoc?Location=U2&doc=GetTRDoc.pdf&AD=AD0623983; Erol Ayranci and Sibel Tunc (March 2003) “A method for the measurement of the oxygen permeability and the development of edible films to reduce the rate of oxidative reactions in fresh foods” Food Chemistry Volume 80, Issue 3, Pages 423-431; and Compañ et al. (July 2002) “Oxygen permeability of hydrogel contact lenses with organosilicon moieties” Biomaterials Volume 23, Issue 13, Pages 2767-2772, the entire contents of each of which are incorporated herein by reference. The permeability of a SAP may be measured when it is partially or fully hydrated, e.g. when the SAP is 5%, 10%, 15%, 20%, 25%, 30%, 35%, 40%, 45%, 50%, or 5-50% hydrated.

### Mechanical Resistance

In preferred embodiments of the present invention, the root development zones of a unit of the invention are both i) sufficiently permeable to oxygen to encourage root growth, and ii) do not disintegrate in soil. In especially preferred embodiments, the root development zones of a unit of the invention are mechanically resistant, i.e., are capable of repeated swelling cycles in soil without fragmenting in the soil. In particularly preferred embodiments, all of the SAP of the root development zones remains part of the root development zones after repeated swelling cycles.

Despite alginate's permeability to oxygen, root development zones consisting of alginate are not suitable in preferred embodiments of the invention because alginate tends to disintegrate in soil. However, semi-synthetic CMC, which does not tend to disintegrate and is capable of repeated swelling cycles without fragmenting in soil (i.e., is mechanically resistant), is suitable for use in root development zones in preferred embodiments the invention.

### Implementation of Artificial Environments

Some embodiments of the present invention comprise the following phases:

Phase 1: Banding and incorporating into the upper soil profile.
Phase 2: Following watering (rainfall and/or irrigation) the root development zones (comprising, e.g. a SAP) absorbs moisture from the soil and swells; water penetrates the coating (if present) and dissolves the fertilizer, pesticides and/or other agrochemical(s) which then diffuse into the root development zones (e.g. towards the periphery of a bead).
Phase 3: Roots grow, develop, and remain in the root development zones where uptake lasts a predetermined period.

### Methods for Testing Properties of Root Development Zones

The following is a non-limiting example of a method that may be used to test the properties of root development zones (e.g. bead shells).
Distribute empty units (e.g. shells) of different sizes in a pot. In some embodiments, empty units of three sizes are used. The shells may have a dry radius of, e.g., 0.5, 1, 1.5, 2, 2.5, 3, 3.5, 4, 4.5, or 5 cm or a length of, e.g., 0.5, 1, 1.5, 2, 2.5, 3, 3.5, 4, 4.5, 5, 6, 7, 8, 9, or 10 cm. In some embodiments a 10, 11, 12, 13, 14, 15, 20, 25, or 30 liter pot is used. In some embodiments the empty units are distributed in the pot with soil. In some embodiments, the soil is sandy soil.
Monitor the final size and geometry of the empty units following watering. In some embodiments, the final geometry is spherical, cylindrical, or box shaped.
Installing ceramic suction cups to mimic roots water uptake and applying suction through the syringes.
Altering watering frequency over time (e.g., from high-few times per day to low-once a week).
Monitoring the volume of water in the syringes and water drained from the bottom of the pot over time.

The following is another non-limiting example of a method that may be used to test the properties of root development zones (e.g. bead shells).
Distribute empty units (e.g. shells) of one size (base, e.g. on findings from the method described above phase) in a transparent cell. In some embodiments, the cell is made of Perspex- and is 60×2×30 cm). In some embodiments, the empty units are distributed with soil. In some embodiments, the soil is sandy soil.
Monitoring root location and empty unit status. In some embodiments, root location and empty status is monitored by photography or/and scanning.
Repeat with units with/without nutrients.
Monitoring roots location to conclude if roots attract by nutrients or water.
Altering watering frequency over time (e.g., from high-few times per day to low-once a week).

### Methods for Testing Properties of Units of the Invention

The following is a non-limiting example of a method that may be used to test the properties of root development zones (e.g. bead shells).
Growing a plant in a pot. In some embodiments, the pot is a 10, 11, 12, 13, 14, 15, 20, 25, or 30 liter pot.
Installing filter paper cups to monitor concentrations in the root zone and drainage over time. Additionally:
Growing a plant in a transparent cell with mixture of units (e.g. beads) and soil. In some embodiments, the soil is sandy soil.
Add dying agents to units which are sensitive to environmental conditions (e.g., pH, Salinity, or N, P, and K).
Altering watering frequency over time (e.g. from high-few times per day to low-once a week).

### Super Absorbent Polymers

Super Absorbent Polymers are polymers that can absorb and retain extremely large amounts of a liquid relative to their own mass. Non-limiting examples of SAPs that are useful in embodiments of the subject invention are described in K. Horie, M. Báron, R. B. Fox, J. He, M. Hess, J. Kahovec, T. Kitayama, P. Kubisa, E. Maréchal, W. Mormann, R. F. T. Stepto, D. Tabak, J. Vohlídal, E. S. Wilks, and W. J. Work (2004). “Definitions of terms relating to reactions of polymers and to functional polymeric materials (IUPAC Recommendations 2003)”. Pure and Applied Chemistry 76 (4): 889-906; Kabiri, K. (2003). “Synthesis of fast-swelling superabsorbent hydrogels: effect of crosslinker type and concentration on porosity and absorption rate”. European Polymer Journal 39 (7): 1341-1348; “History of Super Absorbent Polymer Chemistry”. M2 Polymer Technologies, Inc. (available from www.m2polymer.com/html/history_of_superabsorbents.html); “Basics of Super Absorbent Polymer & Acrylic Acid Chemistry”. M2 Polymer Technologies, Inc. (available from www.m2polymer.com/html/chemistry_sap.html); Katime Trabanca, Daniel; Katime Trabanca, Oscar; Katime Amashta, Issa Antonio (September 2004). Los materiales inteligentes de este milenio: Los hidrogeles macromoleculares. Sintesis, propiedades y aplicaciones. (1 ed.). Bilbao: Servicio Editorial de la Universidad del Pais Vasco (UPV/EHU); and Buchholz, Fredric L; Graham, Andrew T, ed. (1997). Modern Superabsorbent Polymer Technology (1 ed.). John Wiley & Sons, the entire contents of each of which are hereby incorporated herein by reference.

Non-limiting examples of hydrogels that are useful in embodiments of the subject invention are described in Mathur et al., 1996. “Methods for Synthesis of Hydrogel Networks: A Review” Journal of Macromolecular Science, Part C: Polymer Reviews Volume 36, Issue 2, 405-430; and Kabiri et al., 2010. “Superabsorbent hydrogel composites and nanocomposites: A review” Volume 32, Issue 2, pages 277-289, the entire contents of each of which are hereby incorporated herein by reference.

### Geotextiles

Geotextiles are permeable fabrics which are typically used to prevent the movement of soil or sand when placed in contact with the ground. Non-limiting examples of geotextiles that are useful in embodiments of the subject invention are described in U.S. Pat. Nos. 3,928,696, 4,002,034, 6,315,499, 6,368,024, and 6,632,875, the entire contents of each of which are hereby incorporated herein by reference.

### Aerogels

Aerogels are gels formed by the dispersion of air in a solidified matrix. Non-limiting examples of aerogels that are useful in embodiments of the subject invention are described in Aegerter, M., ed. (2011) Aerogels Handbook. Springer, the entire contents of which is hereby incorporated herein by reference.

### Agrochemicals

### Fertilizers

A fertilizer is any organic or inorganic material of natural or synthetic origin (other than living materials) that is added to a plant medium to supply one or more nutrients that promotes growth of plants.

Non-limiting examples of fertilizers that are useful in embodiments of the subject invention are described in Stewart, W. M.; Dibb, D. W.; Johnston, A. E.; Smyth, T. J. (2005). “The Contribution of Commercial Fertilizer Nutrients to Food Production”. Agronomy Journal 97: 1-6.; Erisman, Jan Willem; M A Sutton, J Galloway, Z Klimont, W Winiwarter (October 2008). “How a century of ammonia synthesis changed the world”. Nature Geoscience 1 (10): 636.; G. J. Leigh (2004). The world's greatest fix: a history of nitrogen and agriculture. Oxford University Press US. pp. 134-139; Glass, Anthony (September 2003). “Nitrogen Use Efficiency of Crop Plants: Physiological Constraints upon Nitrogen Absorption”. Critical Reviews in Plant Sciences 22 (5): 453; Vance; Uhde-Stone & Allan (2003). “Phosphorus acquisition and use: critical adaptations by plants for securing a non renewable resource”. New Phythologist (Blackwell Publishing) 157 (3): 423-447.; Moore, Geoff (2001). Soilguide—A handbook for understanding and managing agricultural soils. Perth, Western Australia: Agriculture Western Australia. pp. 161-207; Haussinger, Peter; Reiner Lohmüller, Allan M. Watson (2000). Ullmann's Encyclopedia of Industrial Chemistry, Volume 18. Weinheim, Germany: Wiley-VCH Verlag GmbH & Co. KGaA. pp. 249-307.; Carroll and Salt, Steven B. and Steven D. (2004). Ecology for Gardeners. Cambridge: Timber Press.; Enwall, Karin; Laurent Philippot, 2 and Sara Hallin 1 (December 2005). “Activity and Composition of the Denitrifying Bacterial Community Respond Differently to Long-Term Fertilization”. Applied and Environmental Microbiology (American Society for Microbiology) 71 (2): 8335-8343.; Birkhofera, Klaus; T. Martijn Bezemerb, c, d, Jaap Bloeme, Michael Bonkowskia, Søren Christensenf, David Duboisg, Fleming Ekelundf, Andreas Flieβbachh, Lucie Gunstg, Katarina Hedlundi, Paul Mäderh, Juha Mikolaj, Christophe Robink, Heikki Setäläj, Fabienne Tatin-Frouxk, Wim H. Van der Puttenb, c and Stefan Scheua (September 2008). “Long-term organic farming fosters below and aboveground biota: Implications for soil quality, biological control and productivity”. Soil Biology and Biochemistry (Soil Biology and Biochemistry) 40 (9): 2297-2308.; Lal, R. (2004). “Soil Carbon Sequestration Impacts on Global Climate Change and Food Security”. Science (Science (journal)) 304 (5677): 1623-7.; and Zublena, J. P.; J. V. Baird, J. P. Lilly (June 1991). “SoilFacts—Nutrient Content of Fertilizer and Organic Materials”. North Carolina Cooperative Extension Service. (available from www.soil.ncsu.edu/publications/Soilfacts/AG-439-18/), the entire contents of each of which are hereby incorporated herein by reference.

Non-limiting examples of fertilizers which may be useful in embodiments of the present invention include Ammonium nitrate, Ammonium sulfate, anhydrous ammonia, calcium nitrate/urea, oxamide, potassium nitrate, urea, urea sulfate, ammoniated superphosphate, diammonium phosphate, nitric phosphate, potassium carbonate, potassium metaphosphate, calcium chloride, magnesium ammonium phosphate, magnesium sulfate, ammonium sulfate, potassium sulfate, and others disclosed herein.

Pesticides

Pesticides are substances or mixtures of substances capable of preventing, destroying, repelling or mitigating any pest. Pesticides include insecticides, nematicides, herbicides and fungicides.

Insecticides

Insecticides are pesticides that are useful against insects, and include but are not limited to organochloride, organophosphate, carbamate, pyrethroid, neonicotinoid, and ryanoid insecticides.

Non-limiting examples of insecticides that are useful in embodiments of the subject invention are described in van Emden H F, Pealall D B (1996) Beyond Silent Spring, Chapman & Hall, London, 322 pp; Rosemary A. Cole “Isothiocyanates, nitriles and thiocyanates as products of autolysis of glucosinolates in Cruciferae” Phytochemutry, 1976. Vol. 15, pp. 759-762; and Robert L. Metcalf “Insect Control” in Ullmann's Encyclopedia of Industrial Chemistry” Wiley-VCH, Weinheim, 2002, the entire contents of each of which are incorporated herein by reference. Exemplary insecticides include Aldicarb, Bendiocarb, Carbofuran, Ethienocarb, Fenobucarb, Oxamyl, Methomyl, Acetamiprid, Clothianidin, Dinotefuran, Imidacloprid, Nitenpyram, Nithiazine, Thiacloprid, Thiamethoxam, Mirex, Tetradifon, Phenthoate, Phorate, Pirimiphos-methyl, Quinalphos, Terbufos, Tribufos, Trichlorfon, Tralomethrin, Transfluthrin, Fenoxycarb, Fipronil, Hydramethylnon, Indoxacarb, and Limonene. Additional exemplary insecticides include Carbaryl, Propoxur, Endosulfan, Endrin, Heptachlor, Kepone, Lindane, Methoxychlor, Toxaphene, Parathion, Parathion-methyl, Phosalone, Phosmet, Phoxim, Temefos, Tebupirimfos, and Tetrachlorvinphos.

Nematicides

Nematicides are pesticides that are useful against plant-parasitic nematodes.

Non-limiting examples of nematicides that are useful in embodiments of the subject invention are described in D. J. Chitwood, “Nematicides,” in Encyclopedia of Agrochemicals (3), pp. 1104-1115, John Wiley & Sons, New York, N.Y., 2003; and S. R. Gowen, “Chemical control of nematodes: efficiency and side-effects,” in Plant Nematode Problems and their Control in the Near East Region (FAO Plant Production and Protection Paper-144), 1992, the entire contents of each of which are incorporated herein by reference.

Herbicides

Herbicides are pesticides that are useful against unwanted plants. Non-limiting examples of herbicides that are useful in embodiments of the subject invention include 2,4-D, aminopyralid, atrazine, clopyralid, dicamba, glufosinate ammonium, fluazifop, fluroxypyr, imazapyr, imazamox, metolachlor, pendimethalin, picloram, triclopyr, mesotrione, and glyphosate.

Fungicides

Fungicides are pesticides that are useful against fungi and/or fungal spores. Non-limiting examples of fungicides that are useful in embodiments of the subject invention are described in Pesticide Chemistry and Bioscience edited by G. T Brooks and T. R Roberts. 1999. Published by the Royal Society of Chemistry; Metcalfe, R. J. et al. (2000) The effect of dose and mobility on the strength of selection for DMI (sterol demethylation inhibitors) fungicide resistance in inoculated field experiments. Plant Pathology 49: 546-557; and Sierotzki, Helge (2000) Mode of resistance to respiration inhibitors at the cytochrome bcl enzyme complex of Mycosphaerella fijiensis field isolates Pest Management Science 56:833-841, the entire contents of each of which are incorporated herein by reference. Exemplary fungicides include azoxystrobin, cyazofamid, dimethirimol, fludioxonil, kresoxim-methyl, fosetyl-A1, triadimenol, tebuconazole, and flutolanil.

Microelements

Non-limiting examples of microelements that are useful in embodiments of the subject invention include iron, manganese, boron, zinc, copper, molybdenum, chlorine, sodium, cobalt, silicon, and nickel.

Hormones

Plant hormones may be used to affect plant processes.

Non-limiting examples of plant hormones that are useful in embodiments of the subject invention include but are not limited to, auxins (such as heteroauxin and its analogues, indolylbutyric acid and a-naphthylacetic acid), gibberellins, and cytokinins.

All publications and other references mentioned herein are incorporated by reference in their entirety, as if each individual publication or reference were specifically and individually indicated to be incorporated by reference. Publications and references cited herein are not admitted to be prior art.

This invention will be better understood by reference to the Experimental Details which follow, but those skilled in the art will readily appreciate that the specific experiments detailed are only illustrative of the invention as defined in the claims which follow thereafter.

### EXPERIMENTAL DETAILS

Examples are provided below to facilitate a more complete understanding of the invention. The following examples illustrate the exemplary modes of making and practicing the invention. However, the scope of the invention is not limited to specific embodiments disclosed in these Examples, which are for purposes of illustration only.

### Example 1. Root Development Zones

Four specific criteria were defined as the following, where each condition was tested experimentally:
Mechanical resistance-maintain shape and geometry in the soil
Swelling cycles-hydrate and dehydrate in corresponds to soil water content
Oxygen permeability-maintain sufficient oxygen level to root activity
Root penetration-allows the growth of root into it.

Mechanical resistance was tested by flushing water throughout a container filled with SAP and sand soil. Initial, final weights and dimensions were recorded. A pass mark was accepted for SAP that maintains a single element and didn't wash away or split into several parts. Three groups of SAP were synthesized and tested:

SAPs

| Group | Poly sugar | Semi synthetic | Fully synthetic |
|---|---|---|---|
| Type | Alginate | CMC-g-poly (acrylic acid)/Celite | Acrylic |
| | | composite system Carboxymethyl | Acid/Acryl |
| | | cellulose grafted polyacrylics | Amide |
| | | acid with Celite as a filler. | |
| | | k-Carrageenan poly(acrylic | |
| | | acid)SAP | |

Each type of SAP was formulated with variable mixture of poly sugars, crosslinked agents, filler and additive. Moreover, samples were oven dried and immersed in distilled water in order to calculate the equilibrium swelling (ES) according to the following equation:

$$E S = \frac{weight of swollen gel - weight of Dried gel}{weight of Dried gel}$$

Table 1 summarizes the findings of the mechanical resistance tests:

| | | Bis- | % | | |
|---|---|---|---|---|---|
| SAP-Group | SAP-type | AAm/AA | PS/AA | NaOH | ES |
| Semi-synthetic | CMC | 0.75-1.25 | 50-75 | 15-25 | 73-467 |
| | k-Carrageenan | 1.6-2.5 | 33-66 | — | 25-72 |
| Poly sugar | Alginate-2% | — | 100 | — | 38 |
| Fully synthetic | Acrylic | — | 0 | — | 180 |
| | (AA/AM) | | | | |

“Bis-AAm/AA” means (Acrylic acid crosslinked with Bis acrylamide,” “% PS/AA, semi-synthetic Polysugar-acrylic acid hydrogel” and
“ES” means “equilibrium swelling.”
“Alginate-2%.” means 2% in water when hydrated.

### 1) Poly Sugar:

16 gr of sodium alginate was dissolved in 800 nil distilled water at 50° C. using mechanical stirrer (1000 RPM). Then 20 gr from the alginate solution was added in to 50 ml beaker, then 10 gr of 0.1 M solution of CaCl₂, was added in to the beaker (CaCl₂ served as the cross-linking agent). The beads were left in the solution for 12 hr.

### 2) CMC-g-Poly (Acrylic Acid)/Celite

Various amounts of CMC (Carboxymethyl cellulose sodium Salt) (0.5-2 g) were dissolved in 25 ml distilled water and were added to a 100 ml beaker with magnetic stirrer. The beaker was immersed in a temperature controlled water bath preset at 80° C. After complete dissolution of CMC, various amounts of Celite powder (0.3-0.6 g in 5 ml water) were added (if any) to the solution and allowed to stir for 10 min. Then, certain amounts of AA (Acrylic Acid) (2-3 ml) and MBA (N—N methylene bis acrylamide) (0.025-0.1 g in 5 ml water) were added to the reaction mixture and allowed to stir for 5 min. Then the initiator solution (0.07 g APS (Ammonium persulfate) in 5 ml water) was added to the mixture, the mixture was placed immersed in a temperature controlled water bath preset at 85° C. for 40 minutes to complete polymerization. To neutralize (0-100%) acrylic groups, appropriate amount of NaOH (0-1 gr in 5 ml water) was added. The obtained gel was poured to excess nonsolvent ethanol (80 nil) and remained for 1 h.

3) k-Carrageenan (kC) Cross-Linked-Poly(Acrylic Acid)

0.5-1 gr of kC (k-Carrageenan) was dissolved in 25 mL of distilled water, which was under vigorous stirring in a 100 ml beaker with a magnetic stirrer. The flask was immersed in a temperature controlled water bath at 80° C. After complete dissolution of kC to form a homogeneous solution, certain amounts of AA (Acrylic Acid), and MBA (N—N methylene bis acrylamide) simultaneously added to the reaction mixture. Afterward, the solution was stirred and purged with nitrogen for 2 min to remove the dissolved oxygen. Then, a definite amount of APS (Ammonium persulfate) solution was added dropwise to the reaction flask under continuous stirring to generate free radicals. The reaction maintained at this temperature for 1 h to complete polymerization.

### 4) Fully Synthetic System (a Sample for AAm):

AAm (Acrylamide) (10 g) was mix with 25 ml distilled water at room temperature in a 50 ml beaker equipped with magnetic stirrer. Then MBA (N—N methylene bis acrylamide) (0.008 gr) was added into the mixture and allowed to stir for 10 min. Then an initiator solution was added (0.07 g SPS (Sodium persulfate)). The mixture was placed into 5 ml template (4 gr solution each) and placed in a convention furnace (85° C.) for 20 min. The product was washed overnight with ethanol (80 ml) to obtain the polymerized shell.

### Starch Systems—Sample for Non-Growing Media

### 1) Modified Starch Cross-Linked Poly(Acrylic Acid)

1-2.5 gr of Corn starch dissolved in deionized 20 ml water in 100 ml beaker at room temperature. The combination was mixed until a uniform mixture was formed. 2-3 gr AA (Acrylic acid) was added to the cooled mixture and the resulting mixture was stirred for five minutes. Next, 1-3 gr AAm (acrylamide) was added to the mixture, and the resulting mixture was stirred for five minutes. Then 0.005-0.01 gr of MBA (N—N methylene bis acrylamide) dissolved in 5 ml of deionized water was added to the mixture, and the resulting mixture was stirred for five minutes. Lastly, 0.005 gr of APS (ammonium persulfate) dissolved in 0.5 ml of deionized water; was added to the mixture and the resulting mixture was stirred while being heated to 80° C. The mixture was held at that temperature and stirred for approximately 15 minutes. Because the resulting viscous mass was acidic, the mixture was neutralized by titration with 45% potassium hydroxide (KOH) at room temperature. Titration continued until a pH of 7.0 was reached, which required addition of between about 0.2-16 g 45% KOH.

### 2) Similar Process to the CMC-AA System.

(Exchanging CMC with corn-starch):

1 gr of corn Starch was dissolved in 25 ml distilled water and were added to a 100 ml beaker with magnetic stirrer. The beaker was immersed in a temperature controlled water bath preset at 80° C. Then 2 ml of AA (Acrylic Acid) and MBA (N—N methylene bis acrylamide) (0.015 g in 5 ml water) were added to the reaction mixture and allowed to stir for 5 min. Then the initiator solution (0.07 g APS (Ammonium persulfate) in 5 ml water) was added to the mixture, the mixture was placed immersed in a temperature controlled water bath preset at 85° C. for 40 minutes to complete polymerization. NaOH (0.5 gr in 5 ml water) was added in order to neutralize acrylic groups. The obtained gel was poured to excess nonsolvent ethanol (80 ml) and remained for 1 h.

Swelling cycles of selected formulations in water and two types of soil were tested. The ability of the SAPs to absorb water in relatively short time is an important physical property that allows maintaining its functionality in the soil throughout its life cycle. The following graphs present the swelling behavior of the different SAPs upon hydration-dehydration cycles in water. The ES of the investigated SAPs stay constant during three cycles, meaning good mechanical properties.

The water content of several SAPs in sandy silica soil was measured following watering over a time period that is a typical watering cycle of crops and plants. The various SAPs gain water from the soil in the first 24 hours following by a mild decrease/increase over the next 125 hours. When SAPs were introduced to air dry loess soil, initially it went under rapid de hydration, yet watering the soil reverse the process and water were absorbed from the soil the soil recovery percentage were 99 and 50. The results indicate that all groups of SAPs can maintain their moisture in the sandy soil over a watering cycle and that CMC base SAPs can fully recovery from extreme dry condition in soil.

Oxygen permeability of the SAPs was studied by measuring dissolved oxygen in water that was exposed to oxygen saturated water across a SAP. Altering dissolved oxygen level was done by bubbling nitrogen or oxygen gases into the water reservoir located opposite the sensor. SAPs made from Alginate and CMC showed an order magnitude more oxygen permeability than SAP of k-carrageenan (FIG. 4).

### Dissolved Oxygen Test:

Oxygen electrode place into a pre-swelled hydrogel in a 100 ml beaker. The dissolved oxygen inside the hydrogel was measured during N₂ bubbling or O₂ bubbling (˜0.5 liter per minute) as a function of time.

The O₂ measurements made by Lutron WA2017SD Analyzer with dissolved oxygen probe 0-20 mg/L, 0-50° C.

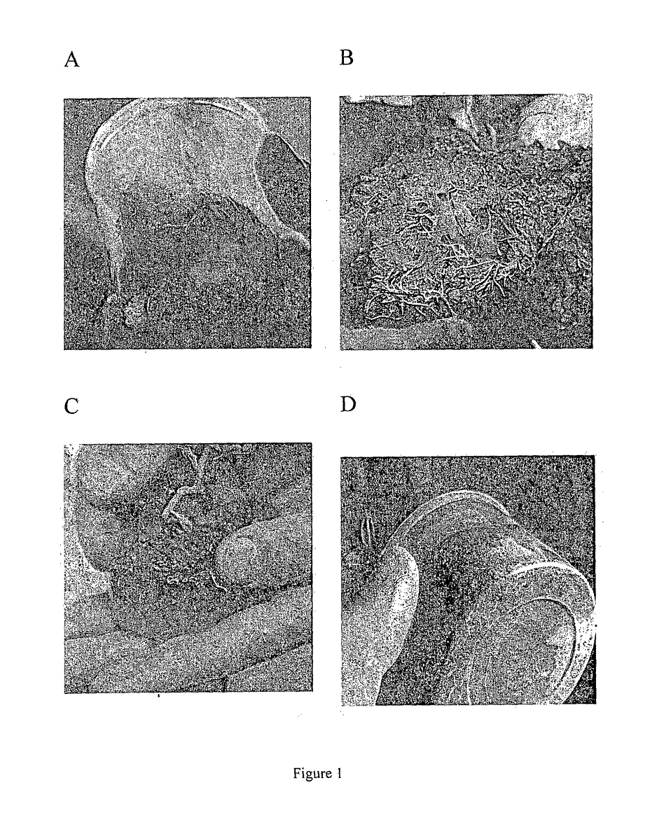

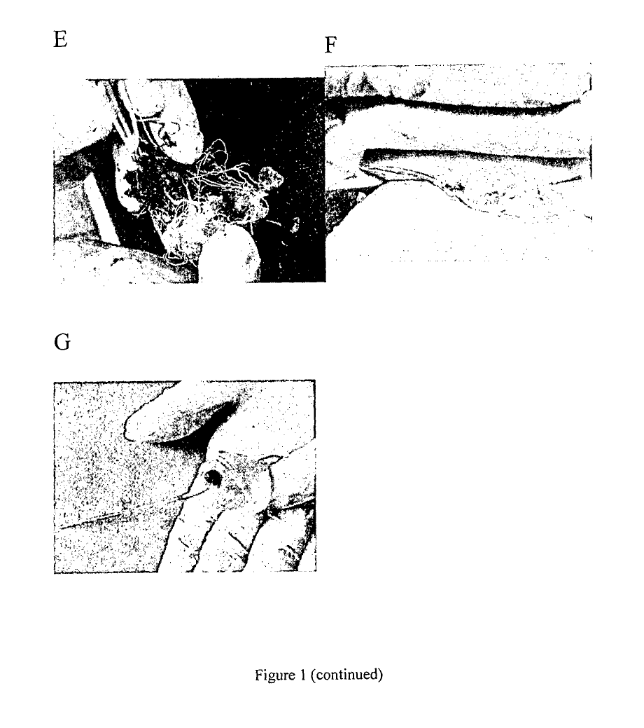

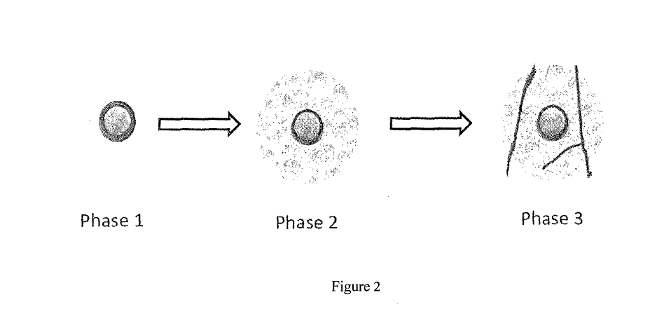

Root penetration was evaluated visually from a series of experiments, where various crops grew in pots filled with organic soil surrounded an artificial environment. Table 2 summarizes the observations presented in FIG. 1:

TABLE 2

| | | Roots on the | | Roots |
|---|---|---|---|---|
| | | surface of | Roots penetrated | developed |
| | | artificial | into the artificial | in the artificial |
| SAPs | Crop | environment | environment | environment |
| Poly Sugar- | Pea | − | + | + |
| Alginate | | | | |
| Semi synthetic- | Corn, | + | + | − |
| CMC | Pea | | | |
| Semi synthetic- | Pea | + | + | − |
| k-Carrageenan | | | | |
| Fully synthetic | Corn | + | + | − |

### Example 2. Agrochemical Zones

Three mechanisms were developed and evaluated to address the criteria of i) release rate of agrochemicals from the agrochemical zones (internal zone) over a growing season, and ii) that no input residuals remain at the end of a predetermined action period. All the three, are based on integrating the input into a very dense polymer as the basic mechanism to slow down diffusion, in conjunction to a secondary mechanism that will additionally decrease the diffusion rate:
1) Highly Cross Linked Polymer with silicon coating (xLP-Si);
2) Highly Cross linked Poly Acrylic/poly sugar with filler (xLP-F); and
3) Hybrid system (SiCLP-).

The first mechanism is based on precipitation of silica, originated from silica water, on the surface of the polymer.

The second mechanism is based on filler, made from bentonite, integrated into the polymer and decreases sharply its diffusion properties.

The third mechanism is to mix the silica with the acrylic while synthesizing the polymer in order to alter its diffusion coefficient.

The reduction in diffusion properties by each mechanism was experimentally tested. The internal zone was located in a free water reservoir where the concentration of a certain input (Nitrogen or Phosphorus) was measured over time.

A reduction of diffused nitrate was measured in the first 24 hours when silicon coating was used.

Alternatively, the mixed silica mechanism yielded release of nitrate and phosphorus in the scale of weeks, as well.

### Example 3. Stability, Dimensions, and Mechanical Resistance of Hydrogels Applied to a Field Plot

### Objective

The objective of this example was to study the sustainability in soil, hydrated dimensions and mechanical resistance of different types and sizes of hydrogel within a field plot. Furthermore, root penetration into these types of hydrogels was studied.

### Hydrogels

The types and sizes of hydrogels are described in Table 3.

TABLE 3

| | | Small | Medium | Large | |
|---|---|---|---|---|---|
| | | (hydrated | (hydrated size | (hydrated size | |
| No. | Chemical composition | size of 2-3 cm) | of 4-5 cm) | of 7-8 cm) | Geometry |
| 1 | Fully synthetic | | + | | Box |
| 2 | Semisynthetic CMC 6% | + | + | + | Cylinder/Box/Cylinder |
| | AAm | | | | |
| 3 | Semisynthetic CMC 6% AA | | + | | Box |
| 4 | Semisynthetic CMC 25% | | + | | Box |
| | AA | | | | |
| 5 | Semisynthetic CMC 50% | + | + | + | Cylinder/Box/Cylinder |
| | AA | | | | |
| 6 | Polysugars Alginate | | + | | Cylinder |

The fully synthetic hydrogel had the composition of the fully synthetic hydrogel described in Example 1.

The semisynthetic CMC 6% AAm hydrogel comprises 6% CMC relative to the acrylic acid monomers (Acrylamide-acrylic) and was made by the following process. 0.25 g AA was mixed with 4.5 ml distilled water at room temperature in a 50 ml beaker equipped with a magnetic stirrer. Then 0.1 g NaOH, 0.01 g MBA, 0.75 g AAm and 1.5 gr CMC solution (3.8% w/w) were added into the mixture and allowed to stir for 10 minutes. Then an initiator solution comprising 0.1 g SPS was added. The mixture was placed into a 5 ml template (4 g solution for each shell) and placed in a convention furnace at 85° C. for 20 minutes. The product was washed overnight with 80 ml ethanol to obtain the polymerized shell.

The semisynthetic CMC 6% AA hydrogel comprises 6% CMC relative to acrylic acid and was made by the following process. 1 g AA was mixed with 4.5 ml distilled water at room temperature in a 50 ml beaker equipped with magnetic stirrer. Then 0.4 g NaOH, 0.01 g MBA and 1.5 g CMC solution (3.8% w/w) were added to the reaction mixture and allowed to stir for 10 minutes. Then 0.1 g of SPS was added. The mixture was added into a 5 ml template (4 g solution for each shell), and the template was placed in a convention furnace at 85° C. for 20 minutes. The product was washed overnight with 80 ml ethanol to obtain the polymerized shell.

The semisynthetic CMC 25% AA hydrogel comprises 25% CMC relative to acrylic acid and was made by the following process. 2 g AA was mixed with 12.5 g CMC solution (3.8% w/w) at room temperature in a 50 ml beaker equipped with magnetic stirrer. Then 0.01 g MBA was added into the mixture and allowed to stir for 10 minutes. Then an initiator solution comprising 0.1 g SPS was added. The mixture was placed into 5 ml template (4 gr solution for each shell), and the template was placed in a convention furnace at 85° C. for 20 min. Then NaOH (0.728 molar ratio or 0.8 gr in 50 ml water) was added to the polymerization product. The product was then washed overnight with 80 ml ethanol to obtain the polymerized shell.

The semisynthetic CMC 50% AA hydrogel comprises 50% CMC relative to acrylic acid and was made by the following process. 1.5 g CMC were dissolved in 35 ml distilled water and added to a 100 ml beaker with magnetic stirrer. The beaker was immersed in a temperature controlled water bath preset at 85° C. After complete dissolution of CMC, the beaker was placed on a magnetic stirrer at room temperature with N₂ bubbling at a flow rate of ˜0.5 LPM. Then 3 g AA and 0.03 g MBA were added to the reaction mixture and allowed to stir for 20 minutes and the temperature was allowed to decrease to 35° C. Then the 0.03 g of the initiator SPS in 1 ml water was added. The mixture was placed into 5 ml template (4 g solution for each shell) and placed in furnace at 85° C. for 20 minutes. Then NaOH (0.728 molar ratio or 0.8 gr in 50 ml water) was added to the polymerization product. The product was then washed overnight with 80 ml ethanol to obtain the polymerized shell.

The polysugars alginate hydrogel had the composition of the polysugar hydrogel described in Example 1.

### Experimental Setup

The experiment took place at the Southern Arava R&D station. A 125 square meters field plot, divided to 4 beds×15 m long was served to test 3 application methods, six types and three sizes of hydrogels. Root penetration was studied in plot D.

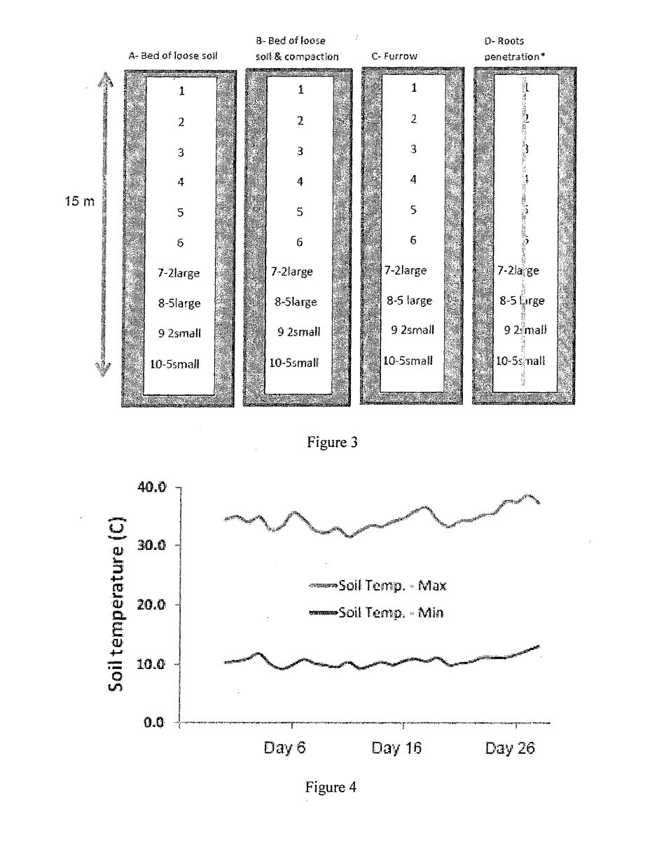

The experimental setup is shown in FIG. 3.

The three application conditions for plots A-C were:

i) Uniform application in loose soil—to mimic conventional beds for vegetable crops;
ii) Uniform application in compacted soil—to mimic conventional beds for vegetable crops, with compaction; and
iii) Application in a furrow—to mimic a furrow in field row crops.

A one square meter or one linear meter sub plots (50 cm apart) were used to apply 27 units of each hydrogel (plots A-C). The units were uniformly distributed on the soil surface and incorporated into the upper 15 cm of the soil profile. Similarly, a 20 cm deep furrow was dug and 27 units were distributed along one meter. Water was applied through a solid sprinkler set without fertilizer (1 m³=8 mm).

The roots penetration plot (plot D) consisted of a 15 m long bed, where 25 hydrogels from each type were applied along a 1 m furrow of 20 cm deep. Maize was sown above the hydrogels at the same day and was irrigated with a solid set of sprinklers without fertilizes, that was switched after germination to a drip line (25 cm spacing, 2 l/h) with Idit liquid fertilizer (100 mg/1 N). Irrigation was shut off on day 31 and was opened again one day before soil excavation. Visual dimensional measurements and qualitative information on root penetration were collected on day 50.

Measurements included individual weight, dimension and tension of 3 units. Timing of water application to plots A-C and measurements are shown in Table 4.

TABLE 4

| Day | Irrigation (mm) | Measurements |
|---|---|---|
| 0 | Application | |
| 1 | 160 | |
| 2 | | 1^{st} |
| 5 | 40 | |
| 6 | | 2^{nd} |
| 8 | 40 | |
| 12 | 40 | 3^{rd} (before |
| | | irrigation) |
| 16 | | 4^{th} |
| 29 | | 5^{th} |

Climate during the experiment was clear sky with no rainfall. Maximum and minimum soil temperatures at 5 cm depth during the experiment period are presented in FIG. 4. The hydrogels were exposed to temperatures which ranged between 10° C. at night to 40° C. around midday.

### Results for Plots A-C

Changes in weight for each hydrogel type and size versus time are shown in FIG. 5. The variable soil moisture was derived by the irrigation events (vertical bars). During the wetting phase, comprising of four consecutive irrigations (day-12), most of the hydrogels gained weight by absorbing soil water. The poly sugar Alginate was the only type to lose weight throughout the experiment, although soil moisture fluctuated between very wet to mild dry soil. While medium and large hydrogels multiplied their own weight (equal to the amount of absorbed soil water) by 5-11 times, the small hydrogel grew by 18 times. During the 16 days drying phase, hydrogels lost weight by 2-4 times (of the original weight) to the drying soil. No correlation between CMC percentage and water absorbance was found. This may imply that local conditions are more dominant than chemical composition.

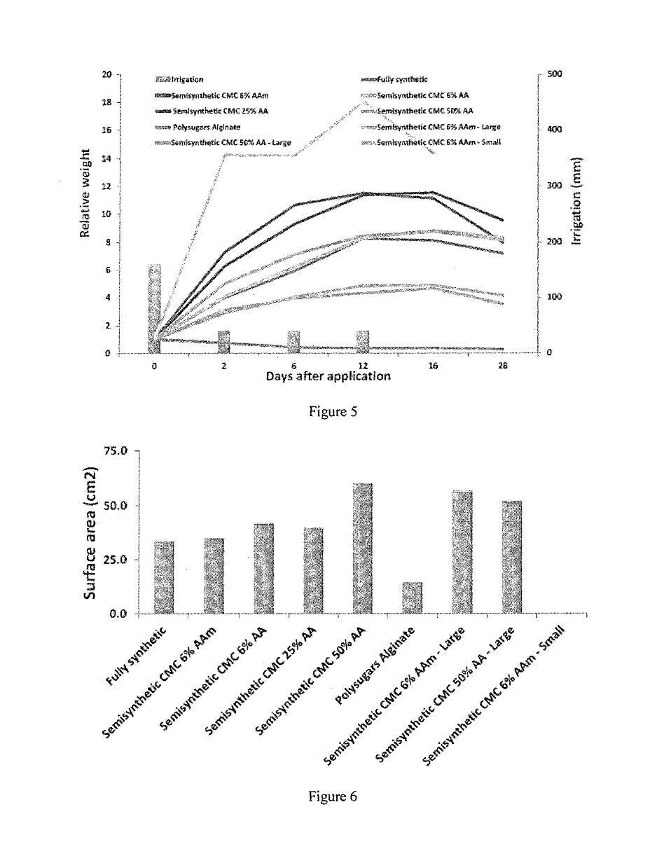

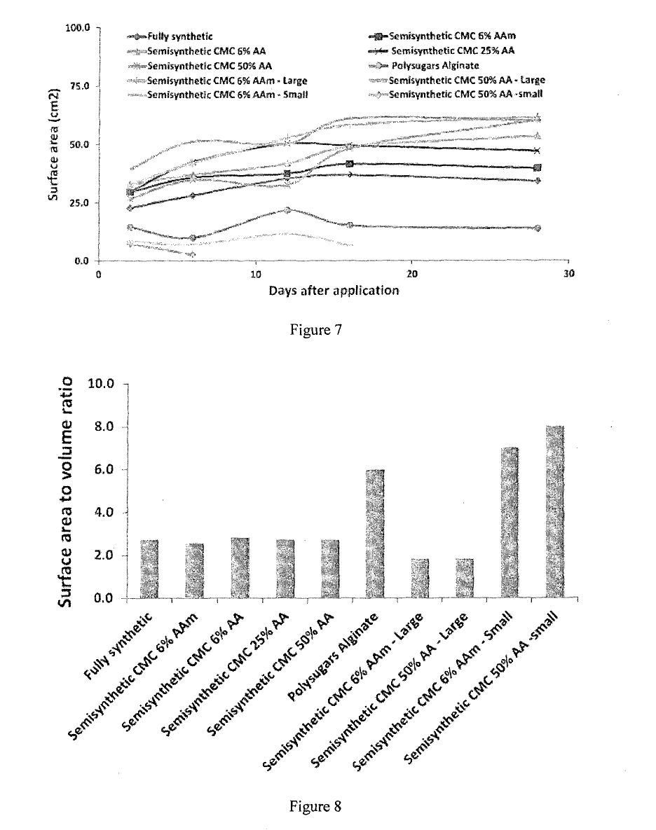

The final surface area derived from the volume and the geometry of the hydrogels is shown in FIG. 6. Initial areas ranged between 25-30 cm² for medium size, 35 cm² for large size and 10 cm² for small size. Most medium hydrogels experienced a minor increase, up to 35 cm², while Alginate decreased sharply and Semisynthetic CMC 50% AA (no. 5) increased dramatically to 60 cm². The two large sizes increased to over 50 cm′. Surface area of hydrogel units versus time is shown in FIG. 7.

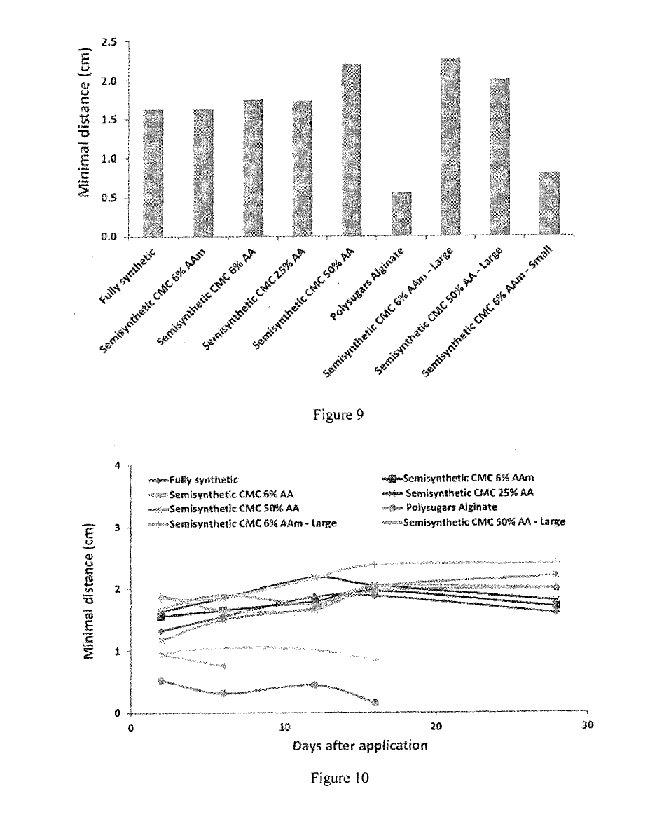

The ratio between surface areas to volume was constant to most hydrogels at the value of 2.5-3. The poly sugar Alginate and both small size hydrogels had high ratio due to their relatively small dimensions. Surface area to volume ratios for the hydrogels are shown in FIG. 9.

The distance between a chemical (positioned inside the hydrogel) and the adjacent soil determines the diffusion rates towards the soil. The minimal distance stands for the smallest edge of the hydrogel geometry. Moreover, the same value describes the potential zone for root growth. The initial minimal distance was in the range of 1-2 cm and final values increased to 1.5-2.5 cm. This entails that a chemical will need to diffuse 1-2 cm prior to reaching the soil. The poly sugar Alginate shrunk over time, reaching 0.5 cm in width. The small size hydrogel was difficult to follow, yet it stretched to 0.75 cm. Final minimal distances of the hydrogels are shown in FIG. 9. FIG. 10 shows the minimal distance of hydrogel units versus time.

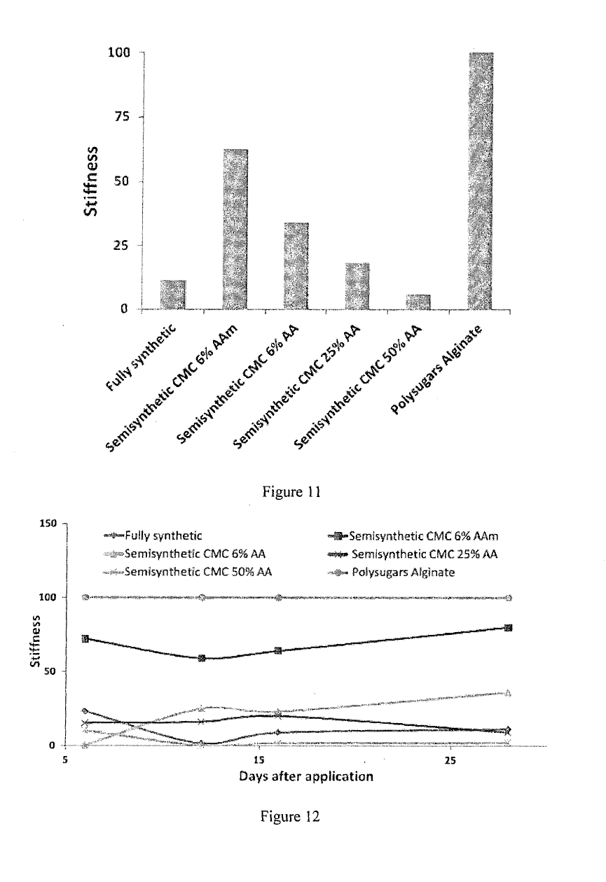

Stiffness is an important parameter related to the potential of roots to penetrate the media and the potential of water to be absorbed. Measurements of stiffness were achieved by using a penetrometer gauge and a metal disc. The values shown in FIGS. 11 and 12 are in relative scale, representing the force that was required to push the disc on the surface of the hydrogel. No differences between medium and large sizes were found. The poly sugar Alginate was consistently very stiff throughout the experiments, contrary to the fully synthetic, which was relatively flexible. A negative trend between CMC content and level of stiffness was observed.

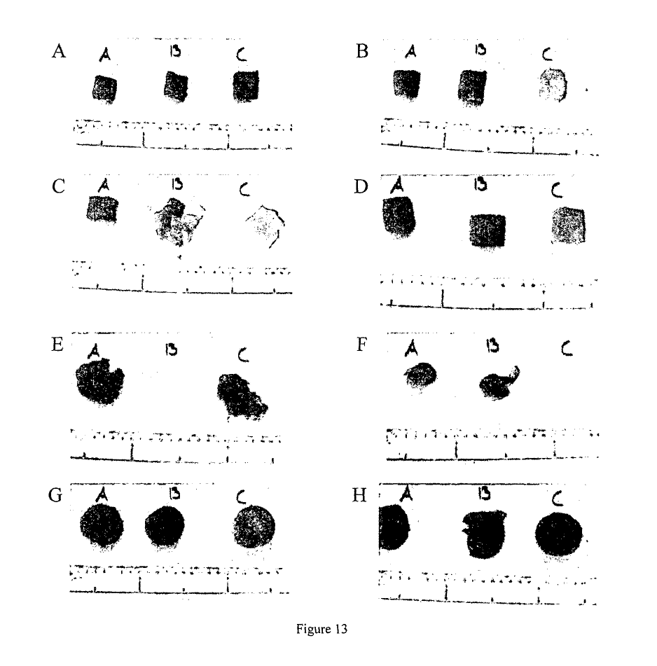

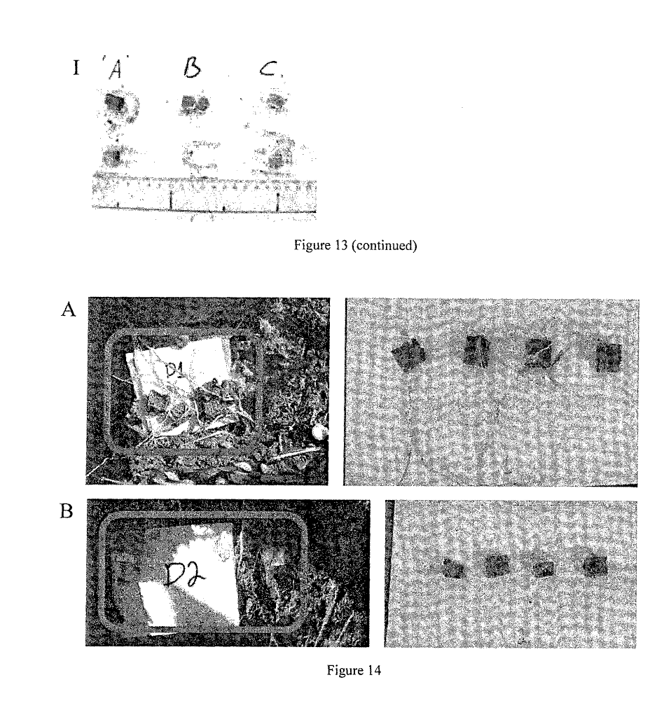

A photo of each hydrogel at the end of the experiment is shown in FIG. 13. The Fully synthetic, Semisynthetic CMC 6% AAm, Semisynthetic CMC 25% AA maintained the original box shape. Similarly, Semisynthetic CMC 6% AAm-Large, Semisynthetic CMC 50% AA-Large and Semisynthetic CMC 6% AAm-Small maintained the cylindrical geometry. Several hydrogels, made from Semisynthetic CMC 6% AA, disintegrated into small particles. Semisynthetic CMC 50% AA lost its original box geometry and turned into an undefined geometry. The poly sugars Alginate turned into a flat disc.

### Results for Plot D

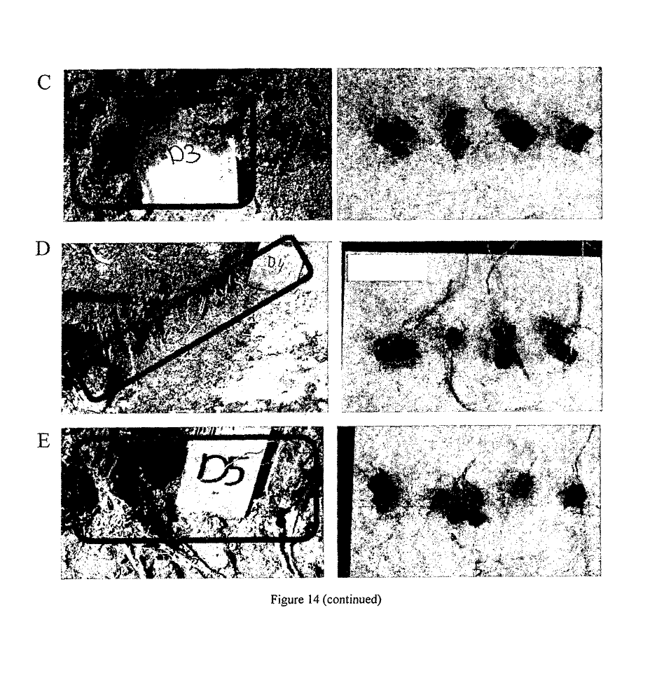

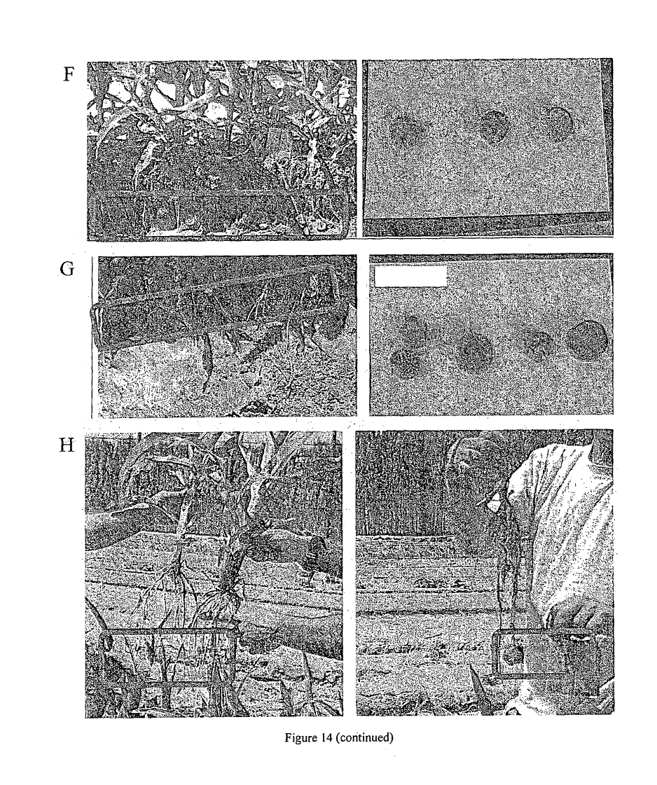

Hydrogels nos. 6, 9 and 10 could not be found in the root zone at the end of the experiment. Photos of each hydrogel type at the end of the experiment are shown in FIG. 14. The left photo shows the hydrogels in-situ and the right shows a few samples where roots penetrated through it. Fully synthetic, Semisynthetic CMC 6% AAm, and Semisynthetic CMC 25% AA maintained the original box shape. Similarly, Semisynthetic CMC 6% AAm-Large and Semisynthetic CMC 50% AA-Large maintained their cylindrical geometry. Several hydrogels, made from Semisynthetic CMC 6% AA, disintegrated into small particles. Semisynthetic CMC 50% AA lost its original box geometry and turned into an undefined geometry. All types of hydrogel experienced shrinkage relative to its maximum volume measured in the bare soil plots. Roots penetrated into all types of hydrogels. While course roots penetrated into the Fully synthetic, Semisynthetic CMC 25% AA and Semisynthetic CMC 50% AA hydrogels, only fine roots were found in the Semisynthetic CMC 6% AAm, Semisynthetic CMC 6% AA and Semisynthetic CMC 6% AAm-Large.

### SUMMARY

Six types and three sizes of hydrogels were tested in a field plot during wetting and drying periods. Most of them were in accordance with soil moisture, absorbing water (up to 10 times their initial weight) in the first period and releasing water in the second one. Final surface area was 30-50 cm². The minimal dimension of the medium and large hydrogels was 1.5-2.5 cm, allowing sufficient volume for root penetration. Small hydrogels expanded to less than 1 cm, which would constrain the amount of chemicals which could be encapsulated within the hydrogel. Stiffness was evaluated and a major difference was found between hydrogel types. While most types maintained their original 3D geometry, a few disintegrated or deformed.

Six types and three sizes of hydrogels were evaluated in a field plot for root penetration. Most types maintained their original 3D geometry, yet a few disintegrated, deformed or flushed away. Roots penetrated into all hydrogels, but a few types had only fine roots while others had fine and course roots. The amount of root penetration and development observed in the different size hydrogels suggests that a minimum volume of hydrogel is required for root penetration and development.

### Example 4. Pilot Scale Production of Fertilizer Units Based on AA-AAm-CMC Hydrogels with Onsmocote® 6 Weeks Cores

This Example describes the production of fertilizer units useful in the methods of the invention.

### Materials

Acrylic Acid (AA) (Sigma Aldrich catalog #147230)
Acrylamide (AAm) (Acros catalog #164830025)
N—N methylene bis acrylamide (MBA) (Sigma Aldrich catalog #146072)
Carboxymethylcellulose Sodium salt MW=90 K (CMC) (Sigma Aldrich catalog #419273)
Sodium persulfate (SPS) (Sigma Aldrich catalog #216232)
Deionized water (DIW)
Osmocote® start 11-11-17+2MgO+TE, Everris International B. V. (Scott).

### Methods

8 kg of a 3.8% w/w CMC stock solution is made by slowly adding 304 g of CMC powder to 7,696 g of 90° C. DIW followed by stirring for 12 hours at 50° C. Additional DIW is added to replace any water which evaporates during the 12 hours of stirring.

12 kg of a pre-monomer solution is made by first making an AA solution by slowly adding 336 g of AA to 5,990 g of DIW, then adding 384 g of KOH 50% (w/w) solution, and mixing the solution for 15 minutes at 36° C. and pH 4.7, 1,009 g of AAm and 10.09 g MBA is then added to the AA solution and mixed for 15 minutes. 4,238 g of a 3.8% CMC stock solution is then added to the solution and the solution is mixed for 30 minutes to provide the pre-monomer solution.

2 L of a monomer solution with initiator is made by adding 4.5 g of SPS into 2 kg of the pre-monomer solution and mixed for 20 minutes.

The fertilizer units are made in two polymerization steps. In the first step, a bowl-like hydrogel structure is made by adding 4 ml of the monomer solution to a beads pattern using a multi-tip dosing devise. The beads pattern is then covered with a cones matrix and placed in a furnace at 85° C. for 60 minutes, thereby forming the bowl-like hydrogel structure. 1 g of Osmocote® beads are then added to the bowl-like structures. In the second polymerization step, an additional 3.5 ml of monomer solution is added to the beads pattern using the multi-tip dosing device. The beads pattern is then placed in a furnace at 85° C. for 60 minutes, thereby forming the complete fertilizer unit.

The fertilizer units are removed from the beads pattern and washed with ethanol for 10 minutes (50 beads in 1 L ethanol). The fertilizer units are then washed with water for 10 minutes (50 beads in 1 L ethanol). The fertilizer units are then dried at room temperature to a final weight of 3.5-4 g. Beads produced using the above process are shown in FIG. 15.

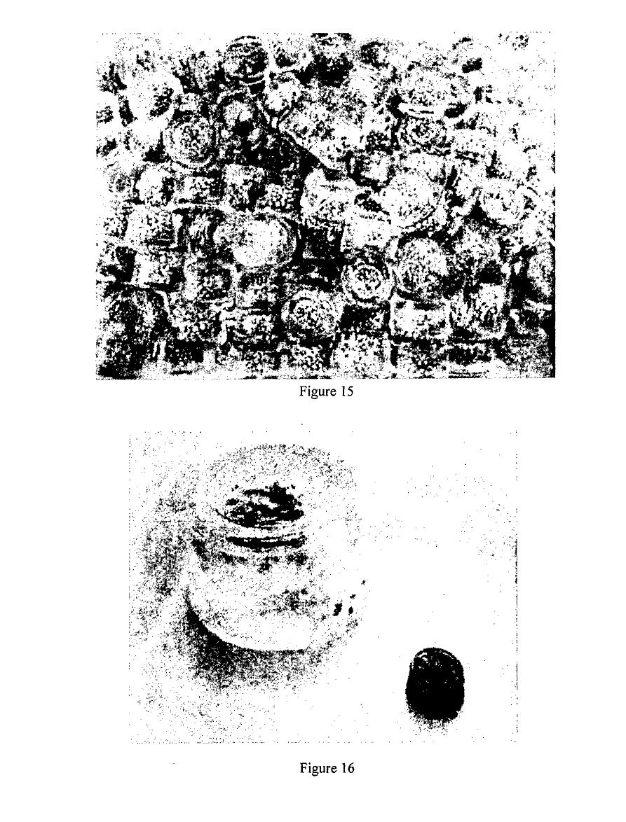

A bead produced using the above process swells to 90-100 g when placed in 200 ml DIW for 24 hours and swells to 35-50 g when placed in 200 ml saline water (0.45% NaCl by weight) for 24 hours. FIG. 16 shows a fully swelled fertilizer unit produced by the above process compared to a fully dried fertilizer unit.

### Example 5. Evaluation of Units Containing Fertilizer and a Systemic Insecticide

### Objective

The objective of this study was to evaluate the capacity of units containing fertilizer and a systemic insecticide to protect wheat plants against aphid infestation. The species targeted, the Bird Cherry aphid (Rhopalosiphum padi), belongs to the numerous family Aphididae and is characterized, in part, by phytophagous phloem-feeders with a rapid turnover of generations.

### Fertilizer/Insecticide Units

The fertilizer/insecticide units used in this example were beads having an internal zone (agrochemical zone) as shown in Table 5.

TABLE 5

| Condition | Bead Contents |
|---|---|
| Untreated | fertilizer |
| Imidacloprid 4 mg | 4 mg f.p. of Imidacloprid 700 WG (2.8 mg a.i) + |
| | fertilizer |
| Imidacloprid 2 mg | 2 mg f.p. of Imidacloprid 700 WG (1.4 mg a.i) + |
| | fertilizer |
| Imidacloprid 1 mg | 1 mg f.p. of Imidacloprid 700 WG (0.7 mg a.i) + |
| | fertilizer |
| Soil treatment | fertilizer |
| Foliar treatment | fertilizer |

f.p.: Formulated product.
a.i.: Active ingredient.

Each bead contained 1 g of AGROBLEN® 18-11-11 fertilizer (Everris). The root development zone of each bead was an acrylamide based hydrogel. The beads cube shaped (2 cm×2 cm×2 cm).

### Insects

The species of aphid used in this example was the Bird Cherry Aphid, Rhopalosiphum padi L.

### Plant Growth Conditions

7 L pots (22.5 cm×25 cm) were filled with vermiculite (medium size) up to 14 cm from the pot edge. Six beads with the same composition were placed on the vermiculite surface, then covered with vermiculite up to 3 cm from the pot edge. Six wheat seeds (Bermude variety) were sown, each over one bead, then covered with vermiculite up to the edge of the pot. Each pot was then watered with 2.2 L and placed in greenhouse (University of Paris-Sud, Orsay, France). Plant growth conditions were 16 hours at 25° C. (day), followed by 8 hours at 20° C. (night). Four pots were used for each condition, randomly distributed in 2 groups of 2 pots.

### Soil Treatment

One week after sowing, the four pots of the “soil treatment” condition were drenched with 1 L each of imidacloprid 700 WG at 24 mg f.p./L (16.8 mg a.i./L).

### Foliar Treatment

The plants were transferred to a climatic chamber with 14 hours at 20° C. (day), followed by 10 hours at 15° C. (night) 22 days after sowing. One day before the evaluation of the insecticidal efficacy, i.e. 29 days after sowing, the four pots of the “foliar treatment” condition were treated with a hand sprayer. The whole foliage of each pot was sprayed with 12 ml of imidacloprid 700 WG at 47.5 mg f.p./L resulting in 0.57 mg f.p./pot (0.4 mg a.i./pot). This amount corresponded to a dose of 100 g a.i./ha.

### Phytotoxic Assessment

One day after foliar treatment (30 days after sowing), the number of plants growing in each pot and the plant height, the tiller number and the leaf number per plant were determined. The presence of phytotoxic symptoms like yellowish, chlorosis, and necrosis was noted for each plant.

### Insecticidal Efficacy Evaluation

After the phytotoxic assessment (30 days after sowing), the oldest and youngest developed leaves of each wheat plant were cut into 2 fragments of 4 to 5 cm long. Four leaf fragments were then planted vertically in a water agar layer (50 ml of water agar 7 g/L) that covered the bottom of a microbox (plant growing trays 125×65×90 mm). One microbox was prepared per plant. Each microbox was infested with 5 adult aphids.

The living adult aphids and the living larvae on each microbox were counted 1, 4 and 7 days after infestation (DAT). The percentage of efficacy (Eff) was calculated at 7 DAI by the aim of the Abott's formula (Püntener, 1981):

Eff=[1−(N in trt after treatment/mN in Co after treatment)]×100

“mN in Co” is the mean number of living aphids per box in control condition and “N in trt”, the number of living aphids per box of each box in treated conditions.

Statistical analyses of the data was performed with XLSTAT® software (Addinsoft™). These analyses consisted of ANOVAs on the different set of data followed by Newman-Keuls tests (threshold 5%).

### Roots Observations

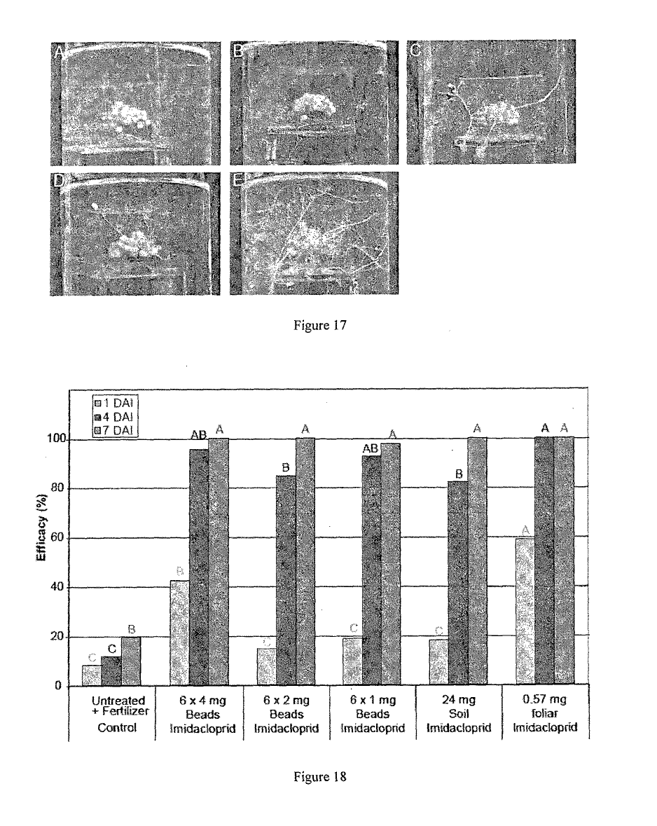

The plants of each pot were dug up 44 days after sowing. The roots and beads were cleaned. A visual notation of the bead colonization by roots was done with a scale ranging from 0: No colonization to 3: Very important colonization. An example of the visual notation scale of bead colonization by roots is shown in FIG. 17.

### Results

### Phytotoxic Assessment

Even if 1 to 2 seeds per pot failed to germinate independently of the condition, the majority of wheat plants were at the beginning of tillering stage, with 1 to 4 tillers in formation 30 days after sowing (Table 6). The number of leaves per tiller ranged from 1 to 5 leaves. Surprisingly, the number of tillers seemed to be higher in the pots containing the beads with 4 mg of imidacloprid and in the pots of the soil and foliar treatments. The plant height ranged from 8 cm (1 plant) to 41 cm with a mean at 35 cm, whatever the condition considered.

No true symptom of phytotoxicity was visible (Table 7). Some leaves showed a slight drying out at their extremity and the number of plants showing this drying out was lower in soil and foliar treatment conditions and absent in pots containing the beads with 4 mg of imidacloprid.

### Insecticidal Efficacy Evaluation

Each microbox was infested with 5 adult aphids. One day later (1 DAI), 4 DAI and 7 DAI, the number of surviving adults and larvae was counted: Results are presented in Table 8 (living adults) and Table 9 (living larvae). The percentage of efficacy (Table 10 and FIG. 18) was calculated from the addition of the number of living adults and larvae in each condition compared to the control (insecticide free condition). The infestation was successful as can be seen by the good multiplication and wheat leaf fragments colonization by the aphids between 1 DAT and 7 DAT in the control condition.

The foliar treatment with 0.57 mg of imidacloprid showed the fastest insecticidal efficacy with a reduction of the number of living adults and an absence of larvae as soon as 1 day after infestation resulting in 59% of efficacy (Table 10).

The presence of beads containing 4 mg of imidacloprid significantly reduced also the number of living adults but some larvae were present 1 day after infestation resulting in 43% of efficacy (Table 10). At this stage, no significant difference could be observed between the efficacies of soil treatment (24 mg of imidacloprid) and treatments by the use of beads containing 2 mg or 1 mg of imidacloprid (respectively 18%, 15% and 19% of efficacy) even if a slight reduction in the number of larvae was visible (Table 9). These 3 conditions were not significantly different from the control.

At 4 days after infestation the percentage of efficacy of the foliar treatment was 100% while the efficacies of the other treatments ranged from 82% to 95%.

At the end of the experiment (7 days after infestation), all the treatments showed an efficacy of 100% at the exception of the units containing 1 mg of imidacloprid (98% of efficacy) for which rare living larvae were still present (Table 9).

TABLE 8
Mean number of living adults of R. padi 1, 4 and 7 days after infestation (DAI)

| | | Adults (Mean number/condition) | | | | | | | | | |
|---|---|---|---|---|---|---|---|---|---|---|---|
| | Dose | | 1 DAI | | | 4 DAI | | | 7 DAI | | |
| Product | (mg f.p./pot) | 0 DAI | Mean | s-d | N-K | Mean | s-d | N-K | Mean | s-d | N-K |
| Control | Untreated + | 5 | 4.9 | 0.1 | A | 4.0 | 0.8 | A | 8.7 | 2.2 | A |
| | Fertilizer | | | | | | | | | | |
| Beads | 6 × 4 mg | 5 | 3.3 | 0.6 | B | 0.5 | 0.5 | C | 0.0 | 0.0 | B |
| Imidacloprid | | | | | | | | | | | |
| Beads | 6 × 2 mg | 5 | 4.5 | 0.3 | A | 1.5 | 0.5 | B | 0.0 | 0.0 | B |
| Imidacloprid | | | | | | | | | | | |
| Beads | 6 × 1 mg | 5 | 4.9 | 0.2 | A | 0.8 | 0.4 | BC | 0.2 | 0.2 | B |
| Imidacloprid | | | | | | | | | | | |
| Soil | 24 mg | 5 | 5.0 | 0.0 | A | 0.6 | 0.2 | C | 0.0 | 0.0 | B |
| Imidacloprid | | | | | | | | | | | |
| Foliar | 0.57 mg | 5 | 2.7 | 0.6 | C | 0.0 | 0.0 | C | 0.0 | 0.0 | B |
| Imidacloprid | | | | | | | | | | | |

Values are the mean number of living aphids (and s-d: standard deviation) of 4 repetitions of 6 plants. N-K: Newman-Keuls test results. Two conditions with the same letter are not significantly different from each other.

TABLE 9
Mean number of living larvae of R. padi 1, 4 and 7 days after infestation (DAI) per box

| | | Larvae (Mean number/Condition) | | | | | | | | | |
|---|---|---|---|---|---|---|---|---|---|---|---|
| | Dose | | 1 DAI | | | 4 DAI | | | 7 DAI | | |
| Product | (mg f.p./pot) | 0 DAI | Mean | s-d | N-K | Mean | s-d | N-K | Mean | s-d | N-K |
| Control | Untreated + | 0 | 1.6 | 0.7 | A | 8.6 | 2.4 | A | 12.3 | 5.9 | A |
| | Fertilizer | | | | | | | | | | |
| Beads | 6 × 4 mg | 0 | 0.4 | 0.2 | BC | 0.1 | 0.2 | B | 0.0 | 0.0 | B |
| Imidacloprid | | | | | | | | | | | |
| Beads | 6 × 2 mg | 0 | 1.0 | 0.7 | AB | 0.4 | 0.3 | B | 0.0 | 0.0 | B |
| Imidacloprid | | | | | | | | | | | |
| Beads | 6 × 1 mg | 0 | 0.4 | 0.3 | BC | 0.1 | 0.2 | B | 0.3 | 0.2 | B |
| Imidacloprid | | | | | | | | | | | |
| Soil | 24 mg | 0 | 0.4 | 0.3 | BC | 1.7 | 0.7 | B | 0.0 | 0.0 | B |
| Imidacloprid | | | | | | | | | | | |
| Foliar | 0.57 mg | 0 | 0.0 | 0.0 | C | 0.0 | 0.0 | B | 0.0 | 0.0 | B |
| Imidacloprid | | | | | | | | | | | |

TABLE 10
Efficacies calculated from the combined number of larvae and
adults 1, 4 and 7 days after infestation (DAI) per box

| | | Adults + Larvae (% efficacy) | | | | | | | | |
|---|---|---|---|---|---|---|---|---|---|---|
| | Dose | 1 DAI | | | 4 DAI | | | 7 DAI | | |
| Product | (mg f.p./pot) | Mean | s-d | N-K | Mean | s-d | N-K | Mean | s-d | N-K |
| Control | Untreated + | 8 | 7 | C | 12 | 15 | C | 20 | 20 | B |
| | Fertilizer | | | | | | | | | |
| Beads | 6 × 4 mg | 43 | 10 | B | 95 | 4 | AB | 100 | 0 | A |
| Imidacloprid | | | | | | | | | | |
| Beads | 6 × 2 mg | 15 | 9 | C | 85 | 6 | B | 100 | 0 | A |
| Imidacloprid | | | | | | | | | | |
| Beads | 6 × 1 mg | 19 | 4 | C | 92 | 4 | AB | 98 | 2 | A |
| Imidacloprid | | | | | | | | | | |
| Soil | 24 mg | 18 | 3 | C | 82 | 6 | B | 100 | 0 | A |
| Imidacloprid | | | | | | | | | | |
| Foliar | 0.57 mg | 59 | 9 | A | 100 | 0 | A | 100 | 0 | A |
| Imidacloprid | | | | | | | | | | |

Values are the mean (and s-d: standard deviation) of the percentage of efficacy calculated from the number of living adults and larvae of 4 repetitions of 4 to 6 plants. N-K: Newman-Keuls test results. Two conditions with the same letter are not significantly different from each other

### Roots Observation

After the insecticidal test, the plants were dug up and carefully washed in order to observe the bead colonization by the roots. Globally, a majority of roots grows outside the beads. As the roots of the 6 plants in a pot were interfering greatly and were mixed all together, they formed a nested mass; it was not possible to determine which plant colonized which beads. In fact, the roots of several plants were observed to penetrate the same bead while some beads were not colonized at all. At least, we were able to count 3 beads colonized by roots in each pot. No difference in the average degrees of bead colonization could be observed between the different conditions even though the beads of the control condition seemed to be slightly less colonized by the roots (Table 11).

TABLE 11
Visual notation of bead colonization by roots

| | Dose | Visual notation of bead colonization | | | | |
|---|---|---|---|---|---|---|
| Product | (mg f.p./pot) | Pot | Mean/pot | s-d | Mean/cond | s-d |
| Control | Untreated + | Pot 1 | 0.3 | 0.4 | 0.6 | 0.3 |
| | Fertilizer | Pot 2 | 0.8 | 0.7 | | |
| | | Pot 3 | 0.9 | 0.7 | | |
| | | Pot 4 | 0.5 | 0.8 | | |
| Beads | 6 × 4 mg | Pot 1 | 1.3 | 1.1 | 1.4 | 0.3 |
| Imidacloprid | | Pot 2 | 1.8 | 1.1 | | |
| | | Pot 3 | 1.1 | 0.8 | | |
| | | Pot 4 | 1.7 | 1.0 | | |
| Beads | 6 × 2 mg | Pot 1 | 2.0 | 0.6 | 1.7 | 0.4 |
| Imidacloprid | | Pot 2 | 1.4 | 0.9 | | |
| | | Pot 3 | 2.1 | 0.9 | | |
| | | Pot 4 | 1.3 | 0.5 | | |
| Beads | 6 × 1 mg | Pot 1 | 1.1 | 0.5 | 1.2 | 0.3 |
| Imidacloprid | | Pot 2 | 0.8 | 1.1 | | |
| | | Pot 3 | 1.7 | 1.2 | | |
| | | Pot 4 | 1.2 | 1.0 | | |
| Soil | 24 mg | Pot 1 | 1.3 | 1.1 | 1.3 | 0.3 |
| Imidacloprid | | Pot 2 | 1.3 | 1.1 | | |
| | | Pot 3 | 1.7 | 1.4 | | |
| | | Pot 4 | 0.8 | 0.8 | | |
| Foliar | 0.57 mg | Pot 1 | 1.1 | 1.0 | 1.7 | 0.4 |
| Imidacloprid | | Pot 2 | 2.0 | 0.9 | | |
| | | Pot 3 | 1.8 | 0.8 | | |
| | | Pot 4 | 1.8 | 1.1 | | |

Values are the mean (and s-d: standard deviation) of the visual notation of 6 beads per pot of 4 pots per condition.

### Conclusions

Despite the lack of germination of some wheat seeds, the majority of plants were well developed 30 days after sowing, whatever the conditions tested while the plants were sown in absence of soil nutriments. This observation suggests that the fertilizer present into the beads allowed normal plant growth even if not all the beads were colonized by roots. The addition of imidacloprid to beads containing fertilizer had no effect on the plant growth as well as the soil or the foliar treatment with imidacloprid.

No typical symptom of phytotoxicity was visible whatever the treatment tested even though some weak symptoms of drying out were visible at the apex of some leaves. This symptom of drying out was probably caused by an overheating during their growth and the slight difference observed between the conditions was probably dependent of the pots position in the greenhouse.

The insecticide bioassays allowed testing and comparing different insecticide treatments against bird cherry aphids. The foliar treatment showed the fastest insecticidal activity, but all the treatments resulted in a complete protection against aphid, with the exception of the beads containing 1 mg of imidacloprid for which rare larvae were still alive 7 days after infestation.

### Example 6. Evaluation of Units Containing Fertilizer and a Fungicide

### Objective

The objective of this study was to evaluate the capacity of units containing fertilizer and a fungicide to protect wheat plants against Microdochium majus.

### Fertilizer/Fungicide Units

The fertilizer/fungicide units used in this example were beads having agrochemical zones (an internal zone) as shown in Table 12.

TABLE 12

| Condition | Bead Contents |
|---|---|
| Untreated | fertilizer |
| Azoxystrobin 6 mg | 6 mg f.p. of Azoxystrobin 500 WG (3 mg a.i) + |
| | fertilizer |
| Azoxystrobin 3 mg | 3 mg f.p. of Azoxystrobin 500 WG (1.5 mg |
| | a.i.) + fertilizer |
| Azoxystrobin 1.5 mg | 1.5 mg f.p. of Azoxystrobin 500 WG (0.75 mg |
| | a.i.) + fertilizer |
| Soil treatment | fertilizer |
| Foliar treatment | fertilizer |

f.p.: Formulated product.
a.i.: Active ingredient.

Each bead contained 1 g of AGROBLEN® 18-11-11 fertilizer (Everris). The root development zone of each bead was an acrylamide based hydrogel. The beads cube shaped (2 cm×2 cm×2 cm).

### Fungal Pathogen

The strain Mm E11 of Microdochium majus used in this study was isolated from naturally infected wheat seeds. This strain was stored at 10° C. on Malt-Agar medium.

### Plant Growth Conditions

7 L pots (22.5 cm×25 cm) were filled with vermiculite (medium size) up to 14 cm from the pot edge. Six beads with the same composition were placed on the vermiculite surface, then covered with vermiculite up to 3 cm from the pot edge. Six wheat seeds (Bermuda variety) were sown, each over one bead, then covered with vermiculite up to the edge of the pot. Each pot was then watered with 2.2 L and placed in greenhouse (University of Paris-Sud, Orsay, France). Plant growth conditions were 16 hours at 25° C. (day), followed by 8 hours at 20° C. (night). Four pots were used for each condition, randomly distributed in 2 groups of 2 pots.

### Soil Treatment

One week after sowing, the four pots of the “soil treatment” condition were drenched with 1 L each of azoxystrobin 500 WG at 60 mg f.p./L (30 mg a.i./L).

### Foliar Treatment

The plants were transferred to a climatic chamber with 14 hours at 20° C. (day), followed by 10 hours at 15° C. (night) 22 days after sowing. One day before inoculation, i.e. 29 days after sowing, the four pots of the “foliar treatment” condition were treated with a hand sprayer. The whole foliage of each pot was sprayed with 9 ml of azoxystrobin 500 WG at 1250 mg f.p./L resulting in 11.25 f.p./pot (5.625 mg a.i./pot). This amount corresponds to a dose of 250 g a.i./ha prepared in a volume of 200 L/ha.

Microdochium majus Plant Inoculation

Untreated and treated plants were inoculated with a suspension of calibrated conidial spores of M. majus strain Mml supplemented with Tween 80. The inoculation was carried out by spraying the conidia suspension on the entire surface of wheat plant with a hand atomizer. After the inoculation, plants were covered with plastic bags in order to ensure saturating moisture for 48 hours.

### Phytotoxic Assessment

At 30 days after sowing (d.a.s.), 37 d.a.s., and 42 d.a.s., the tiller number and the leaf number per plant were determined. The physiological state of the plants was assigned a 0 if no wiltering was observed, + if slight wiltering was observed, ++ if moderate wiltering was observed, +++ if strong wiltering was observed, and ++++ if maximal wiltering was observed.

### Plant Disease Assessment

Disease severity was visually assessed 30 d.a.s., 37 d.a.s., and 42 d.a.s. using a percentage scale, where 0 indicates no symptoms of disease in an examined leaf and 100 indicates that the leaf is completely infected.

Wheat Plantlet Observations at the End of the Experimentation (42 Days after Sowing)

The plants of each pot were dug up 42 days after sowing. Root colonization of the beads and fresh and dry weight of the shoots were measured.

### Results

### Phytotoxic Assessment

No characteristic phytotoxic symptoms were observed in plants grown with beads containing azoxystrobin.

### Disease Assessment

Percentage of disease per condition at 30, 37 and 42 days after sowing is shown in Table 13.

TABLE 13

| | Bead | 30 d.a.s | | | 37 d.a.s | | | 42 d.a.s | | |
|---|---|---|---|---|---|---|---|---|---|---|
| Condition | composition | Mean | s-d | N-K | Mean | s-d | N-K | Mean | s-d | N-K |
| Control | fertilizer | 19 | 3 | A | 47 | 6 | A | 65 | 9 | A |
| Beads | 6 × 1.5 mg | 10 | 9 | B | 24 | 8 | B | 44 | 6 | AB |
| Azoxystrobin | azoxystrobin + | | | | | | | | | |
| | fertilizer | | | | | | | | | |
| | 6 × 3 mg | 10 | 8 | B | 18 | 3 | B | 34 | 6 | B |
| | azoxystrobin + | | | | | | | | | |
| | fertilizer | | | | | | | | | |
| | 6 × 6 mg | 7 | 10 | B | 19 | 10 | B | 29 | 8 | B |
| | azoxystrobin + | | | | | | | | | |
| | fertilizer | | | | | | | | | |
| Soil | fertilizer | 7 | 2 | B | 21 | 4 | B | 32 | 3 | B |
| treatment | | | | | | | | | | |
| Foliar | fertilizer | 12 | 2 | B | 28 | 5 | B | 62 | 6 | A |
| treatment | | | | | | | | | | |

N-K: Newman-Keuls test results. Two conditions with the same letter are not significantly different from each other

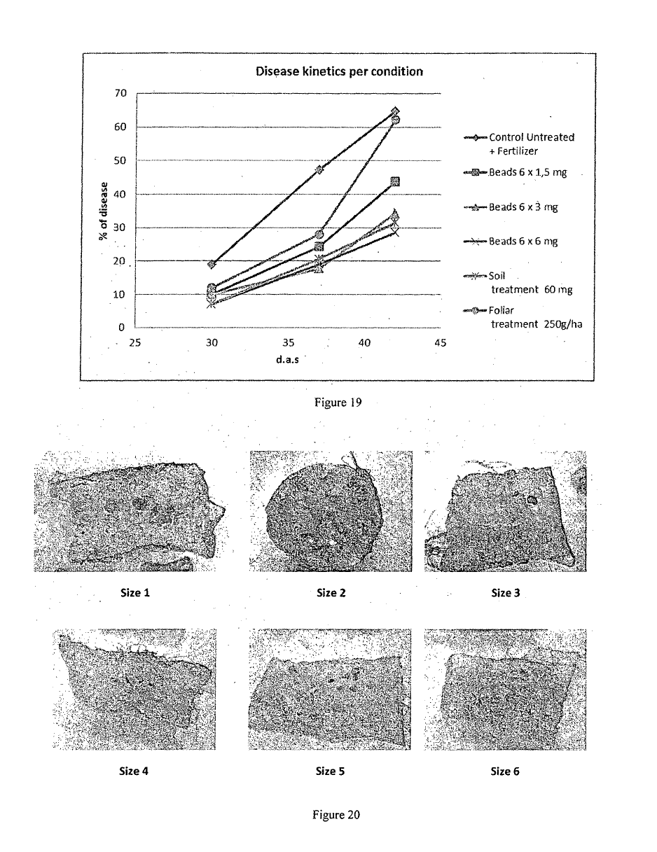

Disease kinetics is shown in FIG. 19.

At 30 and 37 d.a.s., each of the azoxystrobin beads provided disease protection comparable to the soil treatment and foliar treatment conditions. At 42 d.a.s., the 3 mg azoxystrobin and 6 mg azoxystrobin beads provided disease protection comparable to the soil treatment condition and better than the foliar treatment condition. At 42 d.a.s., the 1.5 mg azoxystrobin beads offered a lower level of disease protection than the 3 mg and 6 mg azoxystrobin beads, but still provided a level of disease protection greater than that provided by foliar treatment.

Influence of the treatments on the shoots is shown in Table 14.

TABLE 14

| | Bead | Fresh weight | | | Dry weight | | |
|---|---|---|---|---|---|---|---|
| Condition | composition | Mean | s-d | N-K | Mean | s-d | N-K |
| Control | fertilizer | 0.8507 | 0.106 | A | 0.1170 | 0.013 | A |
| Beads | 6 × 1.5 mg | 1.0133 | 0.069 | A | 0.1270 | 0.011 | A |
| Azoxystrobin | azoxystrobin + | | | | | | |
| | fertilizer | | | | | | |
| | 6 × 3 mg | 1.0245 | 0.143 | A | 0.1453 | 0.070 | A |
| | azoxystrobin + | | | | | | |
| | fertilizer | | | | | | |
| | 6 × 6 mg | 1.2412 | 0.127 | A | 0.1415 | 0.015 | A |
| | azoxystrobin + | | | | | | |
| | fertilizer | | | | | | |
| Soil | fertilizer | 1.0441 | 0.094 | A | 0.1150 | 0.013 | A |
| treatment | | | | | | | |
| Foliar | fertilizer | 0.9168 | 0.129 | A | 0.1137 | 0.012 | A |
| treatment | | | | | | | |

N-K: Newman-Keuls test results. Two conditions with the same letter are not significantly different from each other

As shown in Table 14, no negative effect on shoot weight was observed for plants grown with azoxystrobin containing beads.

TABLE 15
Visual notation of bead colonization by roots

| | Bead | | |
|---|---|---|---|
| Condition | composition | Mean/condition | s-d |
| Control | fertilizer | 0.3 | 0.3 |
| Beads | 6 × 1.5 mg | 1.2 | 0.5 |
| Azoxystrobin | azoxystrobin + | | |
| | fertilizer | | |
| | 6 × 3 mg | 0.4 | 0.3 |
| | azoxystrobin + | | |
| | fertilizer | | |
| | 6 × 6 mg | 0.9 | 0.1 |
| | azoxystrobin + | | |
| | fertilizer | | |
| Soil | fertilizer | 0.8 | 0.3 |
| treatment | | | |
| Foliar | fertilizer | 0.9 | 0.3 |
| treatment | | | |

Visual notation was made using a scale ranging from 0: No colonization to 3: Very important bead colonization

### Conclusions

The addition of azoxystrobin to beads containing fertilizer did not negatively effect plant growth, and no characteristic phytotoxic symptoms were observed in plants grown in pots containing the azoxystrobin containing beads. Surprisingly, all treatment groups provided comparable disease protection at 30 and 37 d.a.s., while all the treatment groups having azoxystrobin containing beads provided better disease protection than foliar treatment at 42 d.a.s, and azoxystrobin beads containing 3 mg and 6 mg azoxystrobin provided protection comparable to the soil treatment at 42 d.a.s.

### Example 7. Root Distribution within Variable Sized Fertilizer Units

### Objective

The objective of this example was to study the effect of unit dimensions on root growth within the root development zones.

### Experimental Setup:

The experiment took place at the R&D station in Kibbutz Magal. Eighteen 10 liters pots with a drainage system were filled with red-brown sandy soil. On day 0, 10 fertilizer units of variable sizes (see Table 16) were placed 10 cm below the soil surface. Subsequently, the pots were irrigated intensively and were planted with cucumbers seedlings. Daily drip irrigation maintained high soil water availability throughout the entire experiment. Due to the different fertilizer doses, a supplementary fertilizer application was applied 30 days after transplanting. Fertilizer units were polymerized from hydroxyethyl acrylamide, acrylic acid, carboxymethyl cellulose, sodium persulfate, N—N methylene bis acrylamide and OSMOCOTE® start (Everris LTD).

TABLE 16
Fertilizer unit weight and dimensions - lab results.

| | | | Fully | | Fully | |
|---|---|---|---|---|---|---|
| | | | swollen | Fully swollen | swollen | |
| | | Fertilizer | weight | diameter | height | |
| Label | Geometry | (g) | (g)* | (mm)* | (mm)* | Note |
| Size 1 | Disc | 1 | 1.6 | 7 | 15 | smallest |
| Size 2 | Disc | 0.79 | 5.5 | 9.5 | 30 | |
| Size 3 | Cylinder | 0.48 | 5.3 | 20 | 17 | |
| Size 4 | Box | 0.16 | 10.9 | 17.1 × 31 × 22 | | |
| Size 5 | Cylinder | 0.12 | 20.4 | 24 | 35 | |
| Size 6 | Cylinder | 0.03 | 24.7 | 27 | 37 | largest |

*After 24 hours in 1000 ppm (CaCl/NaCl) solution

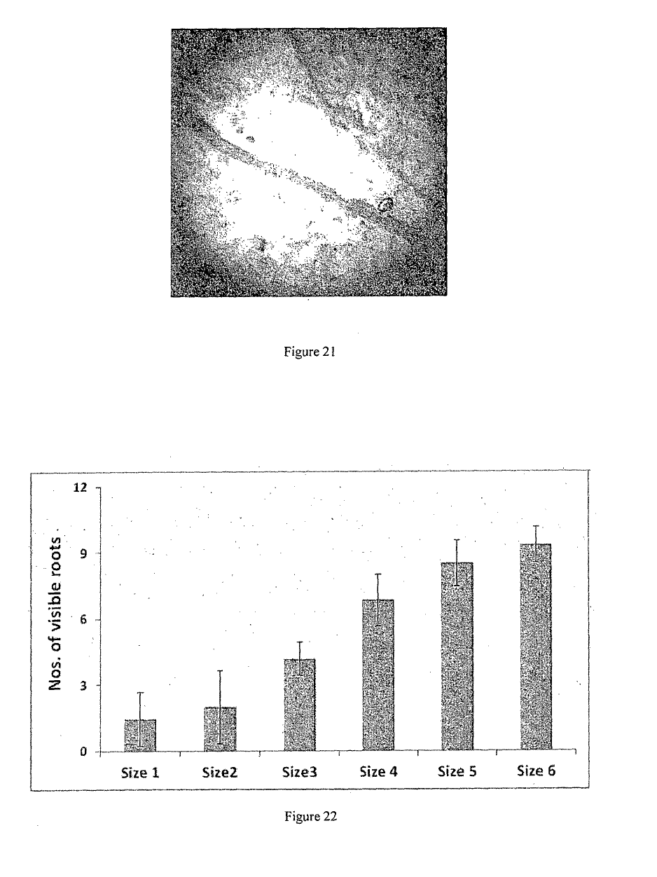

On day 51 the soil from each pot was washed and separated from the fertilizer units. Roots penetrated into the fertilizer units were cut leaving the roots within the units intact. The final weight and dimension of 6 random subsamples from each size (Table 17) was measured. Root distribution was evaluated in two stages: At the first stage, transects from the center (where fertilizer is located) of the 6 fertilizer units of each size were analyzed for a visual root count (FIG. 20). At the second stage, similar transects with equal dimensions (10 mm in diameter; 5 mm in height) were analyzed for root distribution. The root density was evaluated by placing the samples under a microscope and counting the roots which cross its main vertical and horizontal axis. The root number in the sample was the sum of both vertical and horizontal roots, subtracting 25%, assumed as overlap roots (crossing both axis). A sample for root, as seen under the microscope is presented in FIG. 21.

TABLE 17
Fertilizer unit weight and dimensions at the end of the experiment.

| | | Final | | Final | |
|---|---|---|---|---|---|
| | | weight | Final diameter | height | |
| Label | Geometry | (g) | (mm) | (mm) | Note |
| Size 1 | Disc | 1.1 ± 0.2 | 11.8 ± 1.0 | 6.3 ± 0.5 | smallest |
| Size 2 | Disc | 2.7 ± 0.7 | 21.0 ± 0.9 | 10.8 ± 1.8 | |
| Size 3 | Cylinder | 2.6 ± 0.4 | 10.7 ± 0.1 | 26.3 ± 3.4 | |
| Size 4 | Box | 4.8 ± 1.4 | 21 ± 4.7 × 12 ± | | |
| | | | 2.4 × 21 ± 4.7 | | |
| Size 5 | Cylinder | 7.1 ± 1.4 | 27.5 ± 3.3 | 14.7 ± 4.4 | |
| Size 6 | Cylinder | 9.5 ± 2.1 | 25.2 ± 4.1 | 17.7 ± 3.4 | largest |

### Results

The number of visible roots for each size is depicted in FIG. 22. The greater the size, more roots were visible. The large variability in the two smallest sizes (height of 6.3 and 10.8 mm) was attributed to the zero values measured in part of the samples. This observation suggested that a minimum distance is required for root to penetrate and develop within the external casing. Additional support of this assumption is the significant difference between size 1 and 3 (4.2 vs. 1.4 roots). Both have similar diameters (11.8 and 10.7 mm), yet size 3 is 20 mm higher than 1. No significant differences were found between the two largest sizes (height of 14.7 and 17.7 mm), suggesting an optimal size for root development.

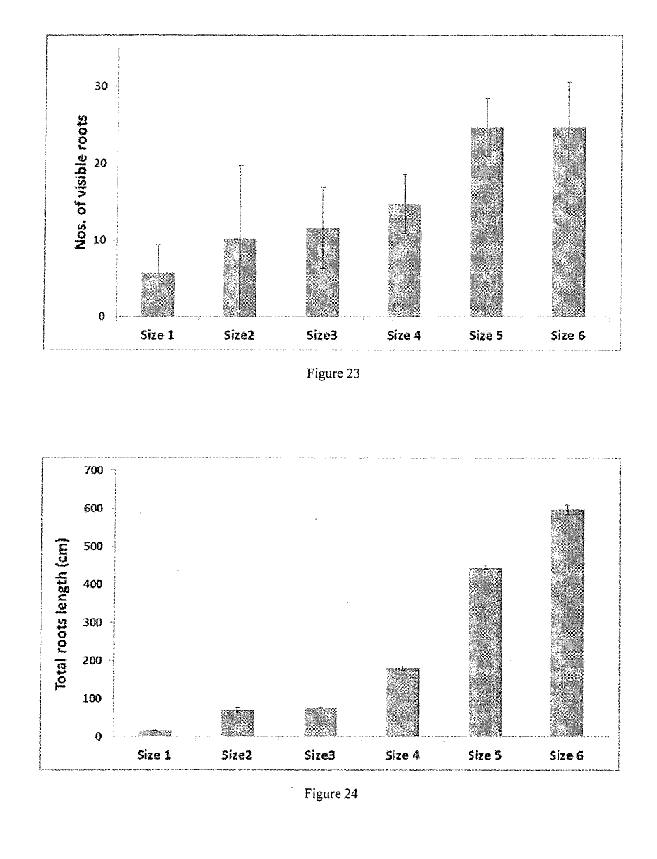

More accurate data on root density was achieved by improving the detection resolution. Number of roots per equivalent transect is depicted in FIG. 23. Larger units were observed to yield more roots, and the size 5 units appeared to be the optimal size for root development. The high variability at smaller scales was due to a lack of roots. The results showed that a minimum thickness is required for root development.

The total root length within each size was calculated and presented in FIG. 24. The equivalent transects (0.4 g) were normalized to the total weight of each sample, which yields the total roots per size. Total length was achieved by multiplying the total roots by the length of a single root (10 mm, the size of transect). The data shows more than an order of magnitude difference between the larger and smaller sizes.

The minimum total root length required for sufficient mineral uptake at peak demand can be estimated from the maximum momentary plant mineral uptake rate (Mass of nutrient per unit root length per time) and root mineral influx rate (Mass of nutrient per unit root length per time). Maximum nitrogen (highest quantity of required mineral) momentary uptake rates vary between 50 to 125 mg per day per plant (Kafkafi and Tarchitzky, 2011). Nitrogen uptake rates per root segment (lengh or weight) were found between 10-140 g of N/day per cm of root (BassiriRad et al., 1999; Gao et al., 1998). This yields a minimum total active root length of about 400 cm. The number of fertilizer units required for sufficient mineral uptake at peak demand can be calculated, assuming 50% are active roots (table 3). Each plant required 49 size 1 units to satisfy mineral uptake versus 1-2 units of large units, as shown in Table 18. It can be conclude that smaller size FODs are not efficient for mineral uptake.

TABLE 18

| | No. of |
|---|---|
| | FOD |
| | units |
| | per |
| Label | plant |
| Size 1 | 49 |
| Size 2 | 12 |
| Size 3 | 10 |
| Size 4 | 4 |
| Size 5 | 2 |
| Size 6 | 1 |

### Conclusions

Smaller units do not generate a preferred root uptake environment for the following reasons:
Smaller units have limited amounts of root growth and development (are not condusive to required amounts of root growth and development).
A minimum thickness is required for optimal root growth and development.
Ten small size units per plant are required to satisfy mineral uptake at peak time.
An optimal size exists for large size units.

### Example 8. Demonstration of Fertilizer Units Characterized with High Fertilizer to Polymer Ratios

### Materials

The fertilizer used to make the agrochemical zone of the fertilizer units of this example contained Urea (60%) and KCl (40%) by weight.

The agrochemical zone was coated with a coat comprising sulfur, pentadiene, and D-Triethylphosphate 3%

The root development zone was made from a Hydroxy Ethyl Acryl Amid solution.

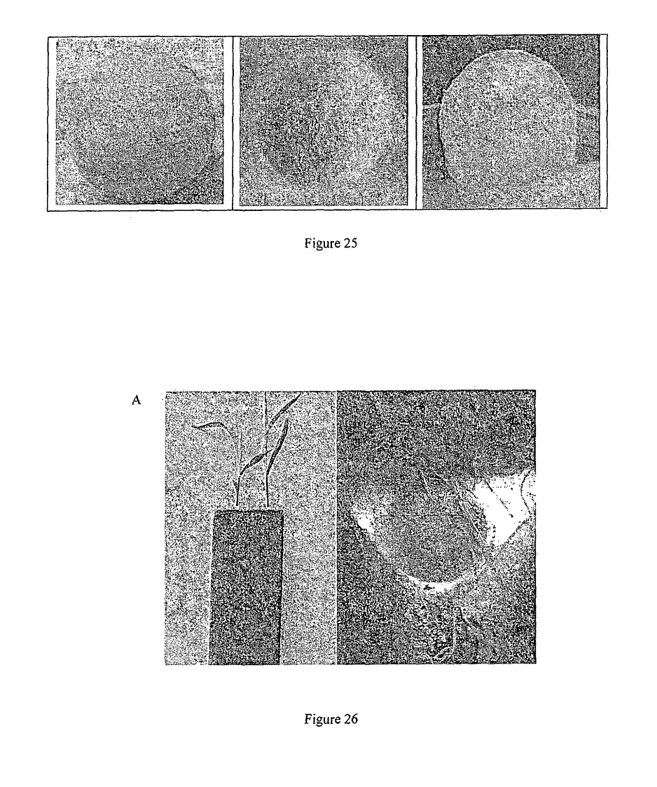

Polymerization of the root development zone was conducted at 80° C. for 40 minutes, with two stages, with cotton fibers (FIG. 25)

### Fertilizer:Polymer (Agrochemical Zone:Root Development Zone) Ratio

1. Fertilizer units prepared from 12% polymer solution—3.5 g of fertilizer to 0.75 g of dry polymer. Ratio—5:1
2. Fertilizer units prepared from 9% polymer solution—3.5 g of fertilizer to 0.54 g of dry polymer. Ratio—6.7:1
3. Fertilizer units prepared from 9% polymer solution—3.5 g of fertilizer to 0.54 g of dry polymer. Final ratio (after swelling and trimming the edges):3.5 g of fertilizer to 0.48 g of dry polymer. Ratio—7.2:1
4. Fertilizer units prepared from 9% polymer solution—3.5 g of fertilizer to 0.54 g of dry polymer; Final ratio (after swelling and trimming the edges):3.5 g of fertilizer to 0.42 g of dry polymer. Ratio—8.2:1
5. Fertilizer units prepared from 9% polymer solution—3.5 g of fertilizer to 0.54 g of dry polymer; Final ratio (after swelling and trimming the edges):3.5 g of fertilizer to 0.53 g of dry polymer. Ratio—10:1

### Description of the Experiment

Six growth cells with drainage at the bottom (dimensions: 25×10×2.5 cm) were filled with quartz sand. Two fertilizer units of the same type were placed in each of the cells at depths of 5 and 15 cm. Two corn seeds were planted on day 0.

After two weeks, photos of the growth chamber and the upper fertilizer unit were taken, focusing on root penetration and development.

Growth chamber no. 6 with fertilizer units of type 1 served to monitor root penetration/development for the 14 days since germination.

### Results

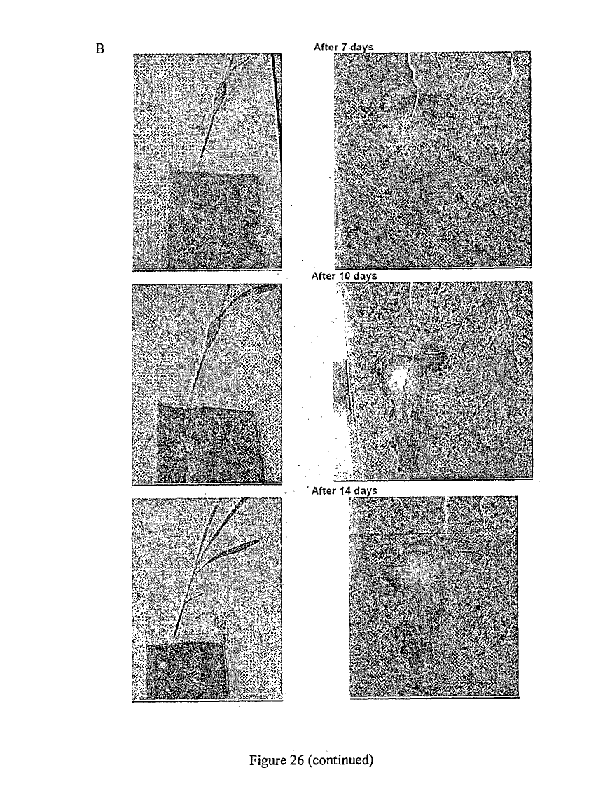

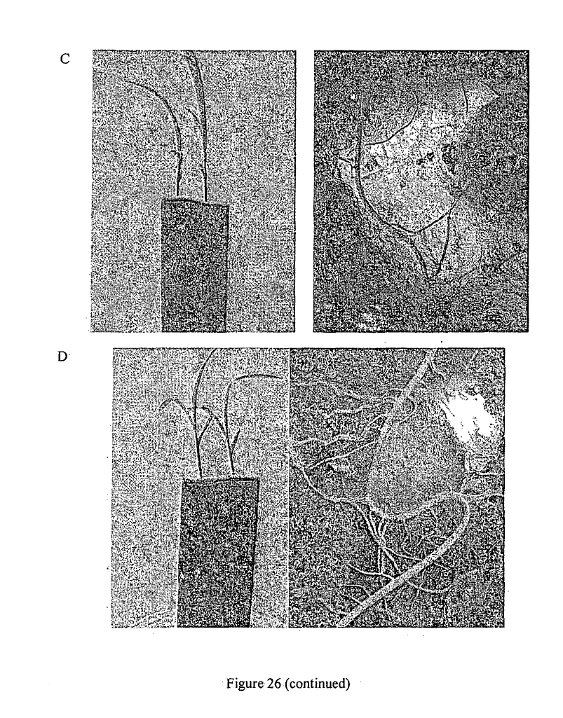

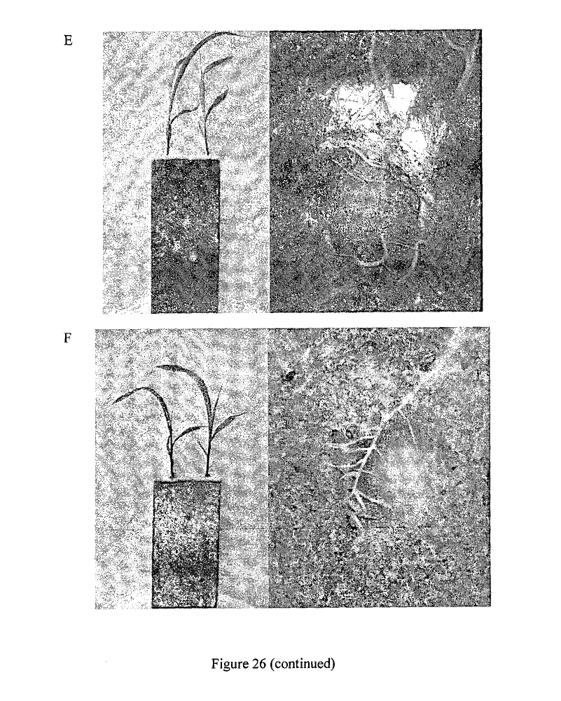

Root penetration and development was observed for fertilizer units of each ratio (FIG. 26).

### Example 9. Evaluation of Units Containing Fertilizer and a Fungicide

### Objective

The objective of this study was to evaluate the capacity of units containing fertilizer and a fungicide to protect wheat plants against Microdochium majus.

### Fertilizer/Fungicide Units

The fertilizer/fungicide units used in this example were beads having agrochemical zones (an internal zone) as shown in Table 12.

### Fungal Pathogen

The fungal pathogen used in this Example was the same as Example 6.

### Plant Growth Conditions

The plant growth conditions used in this Example were the same as Example 6.

### Soil Treatment

One week after sowing, the four pots of the “soil treatment” condition are drenched with 1 L each of AZ 500 WG at 36 mg f.p./L (18 mg a.i./L).

### Foliar Treatment

The foliar treatment used in this Example is the same as Example 6.

### Phytotoxic Assessment

One day after foliar treatment (30 days after sowing), the number of plants growing in each pot, the plant height, the tiller number and the leaf number per plant were determined. The presence of phytotoxic symptoms like yellowish, chlorosis, and necrosis was also noted for each plant.

### Wheat Plant Inoculation

Thirty days after sowing (30 das), the wheat plants present in each 7 L plastic pot were inoculated by spraying them with 20-ml of the M. majus spore suspension adjusted to 5×10⁵ spores/ml in sterile 0.1% Tween 80 with an hand sprayer at 2 bars. For each condition tested, 4 plastic pots were used.

After the inoculation, each 7 L plastic pot was covered with a plastic bag in order to maintain the humidity at 100% during all the experiment. All the pots were then placed in a climatic chamber with 14 hours at 20° C. (day) and 10 hours at 15° C. (night).

### Fungicide Efficiency Assessment

The intensity of the infection of the first, the second, the third and the fourth wheat leaves was evaluated 7 days (37 days after sowing), 14 days (44 days after sowing) and 19 days (49 days after sowing) after the inoculation by dividing the diseased leaf length by the total leaf length leaves multiplied by 100.

The Area Under the Disease Progress Curve (AUDPC) is a quantitative measure of the progress of the disease intensity over time. The most commonly used method for estimating the AUDPC, the trapezoidal method, is performed by multiplying the average disease intensity between each pair of adjacent time points by the time interval corresponding and this for each interval time. The AUDPC is determined by adding all of the trapezoids.

The AUDPC was calculated as follows for each leaf analyzed:

$${A}_{k} = {\sum }_{i = 1}^{{N}_{i} - 1} \frac{( {y}_{i} + {y}_{i + 1} )}{2} ( {l}_{i + 1} - {l}_{i} )$$

In which yi=disease severity at the ith observation, ti=time (days) at the ith observation, and N=total number of observations.

The global AUDPC corresponds to the sum of the AUDPC obtained for each leaf analyzed (1^{st} leaf to 4^{th} leaf). The level of efficacy of each fungicide treatment was determined by comparison of the global AUDPC with that of the untreated control.

Statistical analyses of the data was performed with XLSTAT® software (Addinsoft™). These analyses consisted of ANOVAs on the different set of data followed by Newman-Keuls tests (threshold 5%).

### Roots Observations

After the third timing of disease assessment (49 days after sowing), the roots were cleaned as well as possible taking care of the beads. A visual notation of the bead colonization by roots was done with a scale ranging from 0: No colonization to 3: Very important bead colonization.

### Results

### Phytotoxic Assessment

Even if 1 to 2 seeds per pot failed to germinate independently of the condition, the majority of wheat plants were at the very beginning of the tillering stage with mainly 1 tiller present 30 days after sowing (Table 19).

It is interesting to note that a soil application of Azoxystrobin did not have significant effect on the development of winter wheat plant cv. Bermude, whatever the mode of application (hydrogel beads or soil drenching) and the dose of active ingredient used (Table 20). Thus, 30 days after sowing wheat plants treated with hydrogel beads containing 9, 18 and 36 mg f.p./pot of AZ 500 WG or by soil drenching with 36 mg f.p./pot, exhibit the same number of leaves per plant as well as the same size than untreated wheat plants.

TABLE 19
Plant height, number of tillers, number of leaves per tiller and phytotoxicity^{α} determined
30 days after sowing of winter wheat seeds cv. Bermude in controlled conditions.

| Treatment | Dose (mg f.p./pot) | Plant height (cm) | Leaves/plant | Tillers/plant | Phytotoxicity (%) |
|---|---|---|---|---|---|
| Beads | 0 | 34.13 +/− 2.42a^{β} | 3.88 +/− 0.33a | 1.04 +/− 0.20a | 25 +/− 43a |
| Control | | | | | |
| Beads | 9 | 34.50 +/− 2.69a | 3.96 +/− 0.20a | 1.00 +/− 0.00a | 44 +/− 50a |
| AZ | | | | | |
| Beads | 18 | 31.70 +/− 5.13a | 3.78 +/− 0.41a | 1.00 +/− 0.00a | 26 +/− 44a |
| AZ | | | | | |
| Beads | 36 | 34.57 +/− 3.59a | 3.91 +/− 0.29a | 1.00 +/− 0.00a | 41 +/− 49a |
| AZ | | | | | |
| Soil drenching | 36 | 31.65 +/− 3.73a | 3.79 +/− 0.41a | 1.04 +/− 0.20a | 38 +/− 48a |
| AZ | | | | | |
| Foliar application | 11.25 | 33.76 +/− 3.47a | 4.00 +/− 0.00a | 1.00 +/− 0.00a | 39 +/− 49a |
| AZ | | | | | |

^{α}Phytotoxicity: frequency of wheat plants exhibiting a slight yellowing of their 3^{rd} or 4^{th} leaves apex.
^{β}Values are the means of four repetitions (pots) of 6 plants each +/− standard deviation. Numbers within columns followed by the same letter are not significantly different according to the Newman-Keuls test (P ≦ 0.05).

TABLE 20
Evolution of the intensity of infection of the 1^{st} leaf of wheat plants cv.
Bermude 7 days, 14 days and 19 days post inoculation (dpi) by
spores of M. majus strain Mm E11 in controlled conditions.

| Treatment | Dose (mg f.p./pot) | 7 dpi | 14 dpi | 19 dpi |
|---|---|---|---|---|
| Beads | 0 | 56.1 +/− 30.4a^{β} | 95.4 +/ 17.9a | 100.0 +/− 0.0a |
| Control | | | | |
| Beads | 9 | 30.3 +/− 36.3ab | 61.3 +/− 39.9b | 84.6 +/− 32.6ab |
| AZ | | | | |
| Beads | 18 | 34.0 +/− 34.3ab | 61.2 +/− 43.5b | 78.5 +/− 40.9ab |
| AZ | | | | |
| Beads | 36 | 24.2 +/− 31.2b | 50.1 +/− 42.4b | 66.2 +/− 43.4b |
| AZ | | | | |
| Soil drenching | 36 | 23.6 +/− 26.0b | 65.5 +/− 39.5b | 86.3 +/− 28.1ab |
| AZ | | | | |
| Foliar application | 11.25 | 35.7 +/− 32.8ab | 75.7 +/− 36.1ab | 97.3 +/− 12.5a |
| AZ | | | | |

^{α}Values are the means of four repetitions (pots) of 6 plants each +/− standard deviation. Numbers within columns followed by the same letter are not significantly different according to the Newman-Keuls test (P ≦ 0.05).

The presence of a slight yellowing at the apex of some 3^{rd} or 4^{th} leaves was observed. However, the presence of these yellowing appeared to be unrelated to treatment with AZ 500 WG applied with Hydrogel beads or by soil drenching as far as it is also observed in untreated wheat plants at an almost similar frequency (Table 19).

### Fungicidal Efficiency Evaluation

M. majus disease progress evaluation
On the first wheat leaf

AZ 500 WG slowed the progression of M. majus strain Mm E11 in the tissues of the first leaf sheath relative to the untreated control, whatever the mode of treatment and the dose used (Table 20). However, there was a slight difference of efficacy between the treatments within 7 days of treatment. Thus, AZ 500 WG applied at a dose of 36 mg f.p./pot with the hydrogel beads or by soil drenching had a slightly greater efficacy than when this compound was used at 9 or 18 mg f.p./pot with the hydrogel beads or at 11.25 mg f.p./pot by foliar application.
On the second wheat leaf

AZ 500 WG slowed the progression of M. majus strain Mm E11 in the tissues of the second leaf sheath relative to the untreated control, whatever the mode of treatment and the dose used (Table 21). However, there was a slight difference of efficacy between the treatments within 19 days of treatment.

Thus, AZ 500 WG applied at doses of 9, 18 or 36 mg f.p./pot with the hydrogel beads or at 36 mg f.p./pot by soil drenching as well as had a slightly higher efficacy towards M. majus than when applied at 11.25 mg f.p./pot by foliar application.

TABLE 21
Evolution of the intensity of infection of the 2^{nd} leaf of wheat plants cv.
Bermude 7 days, 14 days and 19 days post inoculation (dpi) by
spores of M. majus strain Mm E11 in controlled conditions.

| Treatment | Dose (mg f.p./pot) | 7 dpi | 14 dpi | 19 dpi |
|---|---|---|---|---|
| Beads | 0 | 12.6 +/− 16.3a^{β} | 71.1 +/ 27.7a | 100.0 +/− 0.0a |
| Control | | | | |
| Beads | 9 | 3.9 +/− 5.8b | 24.9 +/− 29.4b | 57.4 +/− 42.1b |
| AZ | | | | |
| Beads | 18 | 7.6 +/− 11.4ab | 22.7 +/− 26.3b | 66.1 +/− 39.4b |
| AZ | | | | |
| Beads | 36 | 3.0 +/− 4.4b | 26.0 +/− 31.9b | 42.7 +/− 35.6b |
| AZ | | | | |
| Soil drenching | 36 | 2.3 +/− 4.6b | 19.9 +/− 29.3b | 40.8 +/− 38.6b |
| AZ | | | | |
| Foliar application | 11.25 | 9.4 +/− 12.1ab | 39.0 +/− 34.3b | 92.3 +/− 21.5a |
| AZ | | | | |

^{α}Values are the means of four repetitions (pots) of 6 plants each +/ − standard deviation. Numbers within columns followed by the same letter are not significantly different according to the Newman-Keuls test (P ≦ 0.05).

On the third wheat leaf

AZ 500 WG slowed the progression of M. majus strain Mm E11 in the tissues of the third leaf sheath relative to the untreated control, whatever the mode of treatment and the dose used (Table 22). However, there was a slight difference of efficacy between the treatments within 19 days of treatment. Thus, AZ 500 WG applied at doses of 18 or 36 mg f.p./pot with the hydrogel beads or by soil drenching at 36 mg f.p./pot had a slightly greater efficacy than when this compound was used at 9 mg f.p./pot with the hydrogel beads or at 11.25 mg f.p./pot by foliar application.
On the fourth wheat leaf

AZ 500 WG slowed the progression of M. majus strain Mm E11 in the tissues of the fourth leaf sheath relative to the untreated control, whatever the mode of treatment and the dose used (Table 23). However, there was a slight difference of efficacy between the treatments within 19 days of treatment. Thus, AZ 500 WG applied at doses of 18 or 36 mg f.p./pot with the hydrogel beads or by soil drenching at 36 mg f.p./pot had a slightly greater efficacy than when this compound was used at 9 mg f.p./pot with the hydrogel beads or at 11.25 mg f.p./pot by foliar application.
Global AUDPC of M. majus

AZ 500 WG applied with hydrogel beads, by soil drenching and by foliar application reduced significantly the progression of the infection on the four leaves of wheat plants cv. Bermudes by M. majus in controlled conditions, whatever the dose tested (Table 24). However, we noted some difference on the efficacy of these treatments according to the global AUDPC (Table 24). The highest efficacy was observed with AZ 500 WG applied at 36 mg f.p./pot with hydrogel beads or by soil drenching, followed by AZ 500 WG applied at 9 or 18 mg f.p./pot with hydrogel beads. The lowest efficiency was obtained with AZ 500 WG applied at 11.25 mg f.p./pot by foliar application.

Roots Observation

After the third observation (49 days after sowing), the plants were dug up and carefully washed in order to observe the bead colonization by the roots. Globally, a majority of roots grows outside the beads.

TABLE 22
Evolution of the intensity of infection of the 3^{rd} leaf of wheat plants cv.
Bermude 7 days, 14 days and 19 days post inoculation (dpi) by
spores of M. majus strain Mm E11 in controlled conditions.

| Treatment | Dose (mg f.p./pot) | 7 dpi | 14 dpi | 19 dpi |
|---|---|---|---|---|
| Beads | 0 | 5.3 +/− 5.8^{β} | 43.5 +/ 26.0a | 79.0 +/− 27.4a |
| Control | | | | |
| Beads | 9 | 6.0 +/− 17.9a | 25.1 +/− 27.5b | 53.2 +/− 38.6b |
| AZ | | | | |
| Beads | 18 | 2.2 +/− 2.3a | 5.9 +/− 6.9c | 27.0 +/− 27.0c |
| AZ | | | | |
| Beads | 36 | 1.9 +/− 3.3a | 9.2 +/− 14.1c | 22.1 +/− 26.8c |
| AZ | | | | |
| Soil drenching | 36 | 1.5 +/− 1.8a | 9.3 +/− 19.9c | 22.3 +/− 26.9c |
| AZ | | | | |
| Foliar application | 11.25 | 5.6 +/− 5.8a | 15.5 +/− 11.9bc | 71.6 +/− 34.6a |
| AZ | | | | |

^{α}Values are the means of four repetitions (pots) of 6 plants each +/− standard deviation. Numbers within columns followed by the same letter are not significantly different according to the Newman-Keuls test (P ≦ 0.05).

TABLE 23
Evolution of the intensity of infection of the 4^{th} leaf of wheat plants cv.
Bermude 7 days, 14 days and 19 days post inoculation (dpi) by
spores of M. majus strain Mm E11 in controlled conditions.

| Treatment | Dose (mg f.p./pot) | 7 dpi | 14 dpi | 19 dpi |
|---|---|---|---|---|
| Beads | 0 | 16.7 +/− 11.5a^{β} | 40.8 +/ 18.1a | 64.3 +/− 19.9a |
| Control | | | | |
| Beads | 9 | 6.0 +/− 4.5b | 20.0 +/− 17.5b | 41.1 +/− 23.7b |
| AZ | | | | |
| Beads | 18 | 3.4 +/− 4.2b | 8.2 +/− 8.0c | 21.7 +/− 17.4c |
| AZ | | | | |
| Beads | 36 | 3.8 +/− 3.2b | 12.7 +/− 12.6bc | 20.9 +/− 20.8c |
| AZ | | | | |
| Soil drenching | 36 | 4.5 +/− 3.9b | 8.6 +/− 5.8c | 14.6 +/− 9.3c |
| AZ | | | | |
| Foliar application | 11.25 | 5.1 +/− 3.7b | 15.3 +/− 11.7bc | 57.0 +/− 26.9a |
| AZ | | | | |

^{α}Values are the means of four repetitions (pots) of 6 plants each +/− standard deviation. Numbers within columns followed by the same letter are not significantly different according to the Newman-Keuls test (P ≦ 0.05).

TABLE 24
Global AUDPC evaluation of M. majus on winter wheat cv.
Bermude in controlled conditions.

| | Dose | | Treatment |
|---|---|---|---|
| Treatment | (mg f.p./pot) | Global AUDPC^{α} | efficacy^{β} |
| Beads | 0 | 2328 +/− 632a^{χ} | — |
| Control | | | |
| Beads | 9 | 1226 +/− 890bc | 47.3 |
| AZ | | | |
| Beads | 18 | 1037 +/− 641bc | 55.5 |
| AZ | | | |
| Beads | 36 | 900 +/− 712c | 61.3 |
| AZ | | | |
| Soil drenching | 36 | 935 +/− 659c | 59.9 |
| AZ | | | |
| Foliar application | 11.25 | 1403 +/− 702b | 39.7 |
| AZ | | | |

^{α}Global AUDPC = AUDPC 1^{st} leaf + AUDPC 2^{nd} leaf + AUDPC 3^{rd} leaf + AUDPC 4^{th} leaf.
^{β}Treatment efficacy: in percent of the untreated control.
^{χ}Values are the means of four repetitions (pots) of 6 plants each +/− standard deviation. Numbers within columns followed by the same letter are not significantly different according to the Newman-Keuls test (P ≦ 0.05).

As the roots of the 6 plants in a pot were interfering greatly and were mixed all together, forming a nested mass; it was not possible to determine which plant colonized which bead. In fact, the roots of several plants were observed to penetrate the same bead while some beads were not colonized at all. No difference in the average degrees of bead colonization could be observed between the different conditions even if the beads of the control condition seem to be slightly less colonized by the roots (Table 25).

TABLE 25
Visual estimation of the hydrogel beads colonization by
roots of winter wheat plants cv. Bermude after
49 days of incubation in controlled conditions.

| | Dose | | Root colonization of beads | |
|---|---|---|---|---|
| Treatment | (mg f.p./pot) | Pot | per pot | per treatment |
| Beads | 0 | Pot 1 | 0.0 +/− 0.0^{α} | 0.3 +/− 0.5^{β} |
| Control | | Pot 2 | 0.0 +/− 0.0 | |
| | | Pot 3 | 0.4 +/− 0.4 | |
| | | Pot 4 | 0.7 +/− 0.7 | |
| Beads | 9 | Pot 1 | 1.1 +/ 1.0 | 1.3 +/− 0.9 |
| AZ | | Pot 2 | 1.7 +/− 0.9 | |
| | | Pot 3 | 1.6 +/− 0.8 | |
| | | Pot 4 | 0.5 +/− 0.4 | |
| Beads | 18 | Pot 1 | 0.1 +/− 0.1 | 0.5 +/− 0.5 |
| AZ | | Pot 2 | 0.7 +/− 0.4 | |
| | | Pot 3 | 0.8 +/− 0.6 | |
| | | Pot 4 | 0.2 +/− 0.4 | |
| Beads | 36 | Pot 1 | 1.1 +/− 0.7 | 1.0 +/− 0.6 |
| AZ | | Pot 2 | 0.8 +/− 0.6 | |
| | | Pot 3 | 0.8 +/− 0.5 | |
| | | Pot 4 | 1.2 +/− 0.4 | |
| Soil drenching | 36 | Pot 1 | 0.8 +/− 0.5 | 0.8 +/− 0.8 |
| AZ | | Pot 2 | 0.3 +/− 0.5 | |
| | | Pot 3 | 1.2 +/− 1.0 | |
| | | Pot 4 | 1.0 +/− 0.8 | |
| Foliar application | 9 | Pot 1 | 0.7 +/− 0.7 | 1.0 +/− 0.6 |
| AZ | | Pot 2 | 0.5 +/− 0.5 | |
| | | Pot 3 | 1.2 +/− 0.4 | |
| | | Pot 4 | 1.3 +/− 0.4 | |

^{α}Values are the means of six repetition per pot +/− standard deviation.
^{β}Values are the means of four repetitions (pots) of 6 plants each +/− standard deviation.

### Discussion and Conclusions

Despite the lack of germination of some wheat seeds, the majority of plants were well developed 30 days after sowing, whatever the conditions tested. This was observed although the plants were sown in absence of soil nutriments. This observation suggests that the fertilizer present into the beads allowed normal plant growth even if not all the hydrogel beads were colonized by roots.

The addition of azoxystrobin in hydrogel beads containing fertilizer or by soil drenching had no effect on the plant growth. However, a slight yellowing was observed on the apex of some 3^{rd} or 4^{th} leaves of wheat plants treated or not with AZ 500 WG. This result suggests that the slight phytotoxicity was not due to the presence of azoxystrobin, but perhaps to the presence of the fertilizer in the hydrogel beads.

The results clearly show that, although the majority of the roots did not grow inside the hydrogel beads, the integration of AZ 500 WG in these beads reduced significantly the progression of M. majus grown in controlled conditions.

The level of protection observed with AZ 500 WG used at 36 mg f.p./pot in hydrogel beads was comparable to that observed when this formulated product was applied by soil drenching at the same rate of application (36 mg f.p./pot).

When AZ 500 WG was used at lower rates of 9 and 18 mg f.p./pot in hydrogel beads, this active ingredient exhibited a lower efficiency level towards M. majus than when used at 36 mg f.p./pot. On the other hand, AZ 500 WG applied at a rate of 11.25 mg f.p./pot by foliar application exhibited a quite lower efficiency level than when AZ 500 WG was used at 9 mg f.p./pot in hydrogel beads.

### Example 10. Demonstration of Units Having Varying Amounts of Pesticide, Fertilizer, and Polymer

### Objective

The objective of this example is to study the effect of units having different pesticide, fertilizer, and polymers amounts.

### First Set of Units

Units in the form of beads are prepared having the compositions as shown in Tables 26-32. The agrochemical zones containing the fertilizer and pesticide are the internal zone of the beads.

TABLE 26

| | Hydroxyethyl | | | | |
|---|---|---|---|---|---|
| | acrylamide | Fertilizer (g) | | Standard | |
| Experiment | dry weight | AGROBLEN ® | | application | % pesticide by |
| number | (g) | 18:11:11 | Pesticide | rate (g/ha) | weight of unit |
| 1 | 0.3 | 1.5 | Trifloxysulfuron | 5.6 | 0.00055 |
| 2 | 0.3 | 1.5 | Imidacloprid | 300 | 0.033 |
| 3 | 0.3 | 1.5 | Fluensulfone | 2000 | 0.22 |

TABLE 27

| | Hydroxyethyl | | | | |
|---|---|---|---|---|---|
| | acrylamide | Fertilizer (g) | | Standard | % insecticide |
| Experiment | dry weight | AGROBLEN ® | | application | by weight of |
| number | (g) | 18:11:11 | Insecticide | rate (g/ha) | unit |
| 4 | 0.3 | 1.5 | Acetamiprid | 30 | 0.003 |
| 5 | 0.3 | 1.5 | Imidacloprid | 300 | 0.033 |
| 6 | 0.3 | 1.5 | Acephate | 1500 | 0.16 |

TABLE 28

| | Hydroxyethyl | | | | |
|---|---|---|---|---|---|
| | acrylamide | Fertilizer (g) | | Standard | |
| Experiment | dry weight | AGROBLEN ® | | application | % herbicide by |
| number | (g) | 18:11:11 | Herbicide | rate (g/ha) | weight of unit |
| 7 | 0.3 | 1.5 | Trifloxysulfuron | 5.6 | 0.00055 |
| 8 | 0.3 | 1.5 | Foramsulfuron | 11.25 | 0.00145 |
| 9 | 0.3 | 1.5 | Atrazine | 1000 | 0.11 |

TABLE 29

| | Hydroxyethyl | | | | |
|---|---|---|---|---|---|
| | acrylamide | Fertilizer (g) | | Standard | |
| Experiment | dry weight | AGROBLEN ® | | application | % fungicide by |
| number | (g) | 18:11:11 | Fungicide | rate (g/ha) | weight of unit |
| 10 | 0.3 | 1.5 | Flutriafol | 100 | 0.01 |
| 11 | 0.3 | 1.5 | Azoxystrobin | 350 | 0.038 |
| 12 | 0.3 | 1.5 | Propamocarb | 1000 | 0.11 |

TABLE 30

| | Hydroxyethyl | | | | |
|---|---|---|---|---|---|
| | acrylamide | Fertilizer (g) | | Standard | |
| Experiment | dry weight | AGROBLEN ® | Pesticide for soil pests | application | % pesticide by |
| number | (g) | 18:11:11 | and pathogens | rate (g/ha) | weight of unit |
| 13 | 0.3 | 1.5 | Propamocarb | 100 | 0.011 |
| 14 | 0.3 | 1.5 | Fluensulfone | 2000 | 0.22 |

TABLE 31

| | Hydroxyethyl | | | | |
|---|---|---|---|---|---|
| | acrylamide | Fertilizer (g) | | Standard | weight ratio of |
| Experiment | dry weight | AGROBLEN ® | | application | pesticide to |
| number | (g) | 18:11:11 | Pesticide | rate (g/ha) | fertilizer |
| 15 | 0.3 | 1.5 | Trifloxysulfuron | 5.6 | 7.55 × 10⁻⁶ |
| 16 | 0.3 | 1.5 | Imidacloprid | 300 | 4 × 10⁻⁴ |
| 17 | 0.3 | 1.5 | Fluensulfone | 2000 | 2.6 × 10⁻³ |

TABLE 32

| | Hydroxyethyl | | | | |
|---|---|---|---|---|---|
| | acrylamide | Fertilizer (g) | | Standard | |
| Experiment | dry weight | AGROBLEN ® | | application | weight of |
| number | (g) | 18:11:11 | Pesticide | rate (g/ha) | pesticide (mg) |
| 18 | 0.3 | 1.5 | Trifloxysulfuron | 5.6 | 0.01 |
| 19 | 0.3 | 1.5 | Imidacloprid | 300 | 0.6 |
| 20 | 0.3 | 1.5 | Fluensulfone | 2000 | 4 |

### Second Set of Units

Beads as described in Tables 26-32 are also prepared with the polymers described in Examples 2 and 4, and with agrochemical zone to root development zone ratios of 0.05:1, 0.1:1, 0.15:1, 0.25:1, and 0.32:1 while adjusting the amount of fertilizer, polymer, and pesticide as necessary to maintain the percent pesticide and weight of pesticide to fertilizer ratios shown in Tables 26-32.

### Plant Growth Conditions

The first set of units is applied to a field plot at a depth of 20 cm at an application rate of 500,000 units per hectare. Units as defined in Tables 26-32 but without pesticide are applied at the same depth in a second field plot of the same size at 500,000 units per hectare.

The second set of units is applied to a third field plot at a depth of 20 cm at varying application rates to provide the same pesticide application rates as in the first field plot. Units corresponding to the second set of units but without pesticide are applied to a fourth filed plot at the same depth and application rate.

Sunflowers are then grown on the field plots with twice a week irrigation. Pesticides corresponding to those contained in the first and second set of units are applied to the second and fourth field plots according to the pesticides' product labels at the standard application rates noted in Tables 26-32.

### Results

Similar levels of pest protection are seen in plants grown in the first field plot and plants grown in the second field plot. However, the total amount of each pesticide applied in the first field plot is less than the total amount of each pesticide applied in the second field plot.

Similar levels of pest protection are seen in plants grown in the third field plot and plants grown in the fourth field plot. However, the total amount of each pesticide applied in the third field plot is less than the total amount of each pesticide applied in the fourth field plot.

### Conclusions

Units containing pesticides provide levels of pest protection comparable to the levels of pest protection achieved using traditional application methods.

### Example 11: Study of Units Containing Fertilizer and Variable Doses of Herbicide

The objective of the study was to control weed growth in cultivated soil.

### Material and Methods

Soil: 10 liter pots (surface area of 0.045 m²) filled with Rehovot Sand (High sand fraction, low OM, low EC, low CEC, and High pH).

Crops: 6 maize plants per pot following herbicide application (high demand to fertilizers with selectivity).

Weeds: 30 seeds of Solanum Nigrum per pot.

Herbicides: Atrazine, Mesotrione. Both are initially taken up by the roots. Plants emerging from treated soil turn necrotic or bleached prior dying. Physio-chemical properties of the herbicides:

| * | Atrazine | Mesotrione |
|---|---|---|
| Water solubility in std. | 33 | 20,000 |
| conditions (mg/L) | | |
| K_{OC} (mL/g) | 39-155 | 14-390 |
| DT₅₀ (days) | 60 | 5-15 |

*Source: Pesticide Fate in the Environment: A Guide for Field Inspectors. 2011. William E. Gillespie, George F. Czapar, and Aaron G. Hager. Illinois State Water Survey.

TABLE 33
Treatment - Control (no herbicide), Standard (spray at standard dose
and incorporate), unit (standard, double, and fourfold doses).

| | a.i. | dose (g | | | Formulated | Total | Formulate |
|---|---|---|---|---|---|---|---|
| | content | a.i./ | dose (mg | dose (mg | dose (mg/ | no. of | dose (mg/ |
| Herbicide | (w/w) | 1000 m²) | a.i./pot) | a.i./unit) | unit) | units* | total units) |
| Atrazine | 0.5 | 75 | 3.375 | 0.3375 | 0.675 | 30 | 20.25 |
| standard | | | | | | | |
| Atrazine | 0.5 | 150 | 6.75 | 0.675 | 1.35 | 30 | 40.5 |
| double | | | | | | | |
| Atrazine | 0.5 | 300 | 13.5 | 1.35 | 2.7 | 30 | 81 |
| fourfold | | | | | | | |
| Mesotrione | 0.4 | 50 | 2.25 | 0.225 | 0.5625 | 30 | 16.875 |
| standard | | | | | | | |
| Mesotrione | 0.4 | 100 | 4.5 | 0.45 | 1.125 | 30 | 33.75 |
| double | | | | | | | |
| Mesotrione | 0.4 | 200 | 9 | 0.9 | 2.25 | 30 | 67.5 |
| fourfold | | | | | | | |

Unit application: 10 units contain 1.5 g of 18-11-11 Osmocote 3-4M per pot. At 7.5-10 cm depth.

TABLE 33
Experimental setup:

| Reps | Weed | Fert. | Herbicide | Treatments | Objective | Pots |
|---|---|---|---|---|---|---|
| 3 | Yes | Yes | No | Fert. only within units | Proper growth of | 6 |
| | | | | | crops & weeds | |
| | | | | | without herbicide | |
| 3 | Yes | Yes | Yes-2 | Fert. only within units & | Weeds growth with | 6 |
| | | | | standard Herbicides | herbicide - | |
| | | | | application | Standard practice | |
| 3 | Yes | Yes | Yes-2 | Fert. & Herbicides within | unit effect in | 18 |
| | | | | units | variable doses | |
| | | | | | (×1, ×2, ×4) | |

| | |
|---|---|
| Total pots | 30 |

Irrigation: mini sprinklers foggers—every day.

Analysis of crop development parameters: Height and fresh biomass.

Analysis of weeds parameters: Fresh biomass, size and total area covered by weeds per pot.

Following the experimental assessment: Penetration of roots into units, and residual herbicides within units.

Quantified the diffused concentration of Atrazine and Mesotrione over time while submerged in free water. A unit (each from the table above) was placed within a 500 cc vial. 250 cc of DI water were added. The vial was cover with punched Parafilm and stored at room temperature. After 24 hours, the free water, which didn't absorbed by the polymer, were drained and stored in a cold room. DI water at the same volume was refilled into the vial. Repeated this stage after 72 and 120 hours. Atrazine or Mesotrione concentrations in water samples were analyzed with LC_MS_MS and doses were calculated.

### Results

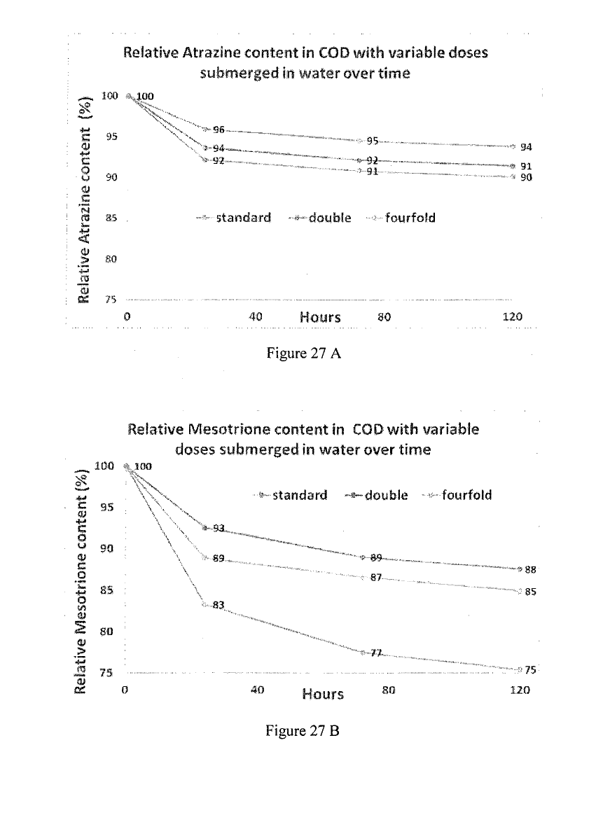

The unit was studied prior and after the trial. The diffusion of both AIs (active) from new and used units into free water was studied. Atrazine and Mesotrione content within units over time while submerged in water. Only minor doses of Atrazine (up to 10%) were released from the new units to the surrounding area over 5 days. Mesotrione release rates were double (up to 25%) due to its high water solubility. See Table 34 and FIGS. 27A and 27B.

TABLE 34

| | | | | | | |
|---|---|---|---|---|---|---|
| | ATR | ATR | ATR | MES | MES | MES |
| Time | standard | double | fourfold | standard | double | fourfold |

| | |
|---|---|
| days | mg |

Content of new units

| | | | | | | |
|---|---|---|---|---|---|---|
| 0 | 0.34 | 0.67 | 1.35 | 0.22 | 0.45 | 0.90 |
| 24 | 0.31 | 0.63 | 1.29 | 0.18 | 0.41 | 0.80 |
| 72 | 0.31 | 0.62 | 1.27 | 0.17 | 0.40 | 0.78 |
| 120 | 0.30 | 0.62 | 1.26 | 0.17 | 0.39 | 0.76 |

Diffused out from used units

| | | | | | | |
|---|---|---|---|---|---|---|
| 24 | 0.4 | 0.7 | 1.2 | 0.04 | 0.16 | 0.19 |

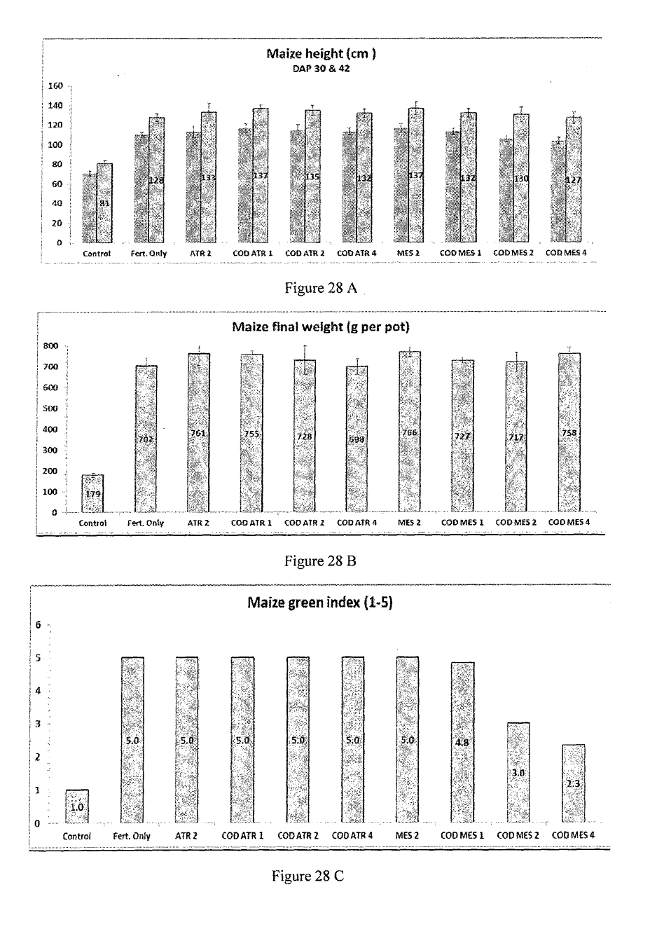

Crop selectivity was monitored by crop height, color and final fresh biomass. Maize was found selective to Atrazine at all doses and Mesotrione at standard dose. Plants exposed to double and fourfold doses of Mesotrione were yellowish and slight shorter (fourfold only), yet no difference was found in fresh biomass. See FIGS. 28A-28C.

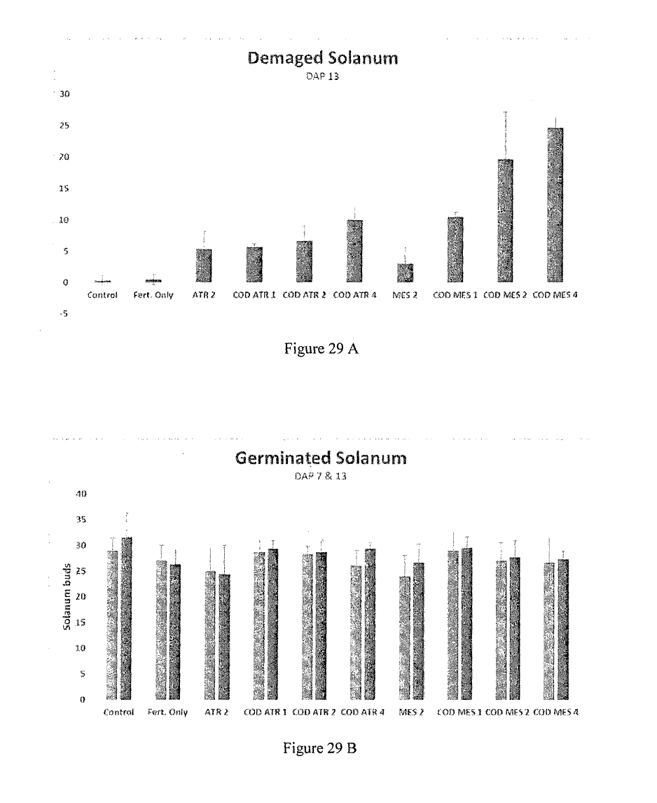

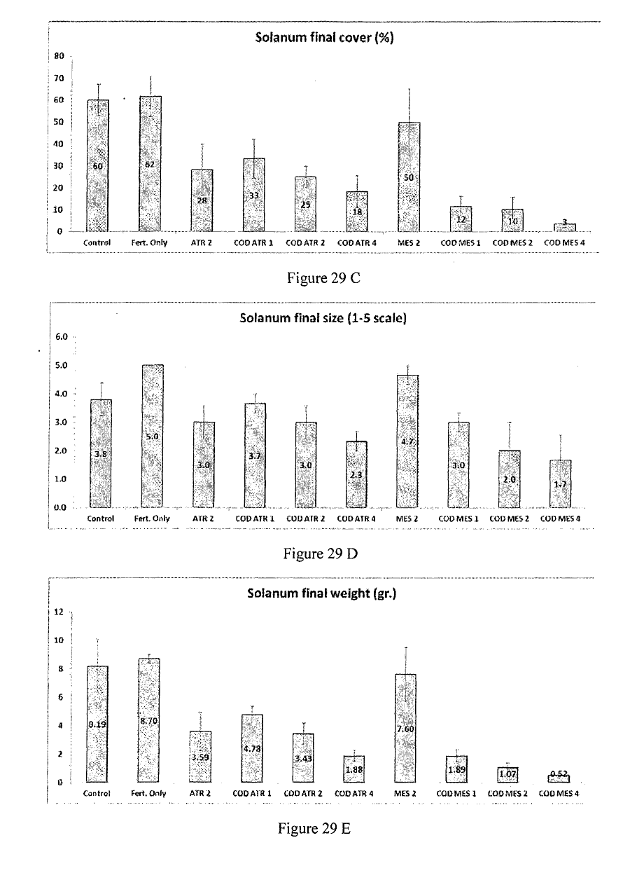

Weeds development and mortality was monitored over time. Weeds germination rates were found similar for all treatments. Damaged buds were recorded at DAP 13 and was found to already have significant differences between treatments that were lasted till the end of the trial. Meaning, the first two weeks are the effective/relevant period. Weeds size, cover rate and final weight were measured at harvesting. See FIGS. 29A-29E. Both maize and solanum roots penetrated and developed within the units of all treatments.

### SUMMARY

The unit, containing combined fertilizer and herbicide, was evaluated for its efficiency controlling weed germination and development relative to the common practice of spray on soil surface. Two herbicides were studied: Atrazine and Mesotrione, both are initially taken up by the roots of treated plants, which turn necrotic or bleached prior dying. Equal quantities were applied in both practices. Half and double doses were tested with the unit as well. Due to its inherent selectivity to the above herbicides, Maize served as the commercial crop. Solanum Nigrum served as the targeted weed. Solanum count, appearance and crop selectivity were evaluated over time after planting/spraying. Only minor doses (up to 10%) of Atrazine and low doses (up to 25%) of Mesotrione diffused from the units into free water after 5 days.

While Maize was not negatively affected by Atrazine at all application rates, some negative effects (yellowish) were noticeable at double and fourfold rates of Mesotrione. Weed germination rate was similar for all treatments. Yet, the different damage levels of weed buds exposed to the herbicides was noticeable after 13 days. These differences lasted until the end of the trial. While, no difference between unit and spray practices was measured with Atrazine, significant advantages of unit over spray was measured with Mesotrione, probably due to its high potential of leaching.

### Conclusions

1. The unit was found controlling weeds growth in cultivated fields while avoiding the health and environmental negative effects associated to spraying herbicides.
2. The unit was proved to retain the AIs inside and therefore eliminate potential loss due to leaching. Meaning, sustain its effectiveness over time.
3. Half application rate was more effective than full spray rate in Mesotrione.

### Example 12: Study of Units Containing Fungicide and Variable Amounts of Fertilizer

### Background

Root development within the unit depends mainly on fertilizer concentration in the root development zone (e.g., hydrogel). When pesticide is combined with the fertilizer, it is expected to remain within the root development zone due to low water solubility, scale of few mg/L and long half-life time. Enhanced roots density inside the root development zone possibly will improve uptake of pesticide which known to be absorbed well by roots, such as Azoxystrobin.

Objective: to study reduced fertilizer.

### Material and Methods

Soil: Red-Brown Sand (High sand fraction, low OM, low EC, low CEC and High pH).

Crops: Pepper, 2 plants per pot.

Fungicide: Azoxystrobin. Water solubility-6 mg/L. Log (Koc)-2.69. DT₅₀-100-150 days.

Units application rate: 12 units per pot.

Fertilizer type: 18-11-11 Osmocote 3-4 M.

TABLE 35
Treatment: Control (no fertilizer),
unit (full, half, quarter, tenth fertilizer doses).

| | | Azoxy | | |
|---|---|---|---|---|
| Fertilizer | Osmocote | WG500 | | Total Azoxy |
| (%) | (g/unit) | (mg/unit) | Total N (g) | WG500 (mg) |
| 100 | 1.5 | 1 | 14 | 12 |
| 50 | 0.75 | | 7 | |
| 25 | 0.375 | | 3.5 | |
| 10 | 0.15 | | 1.4 | |
| 0 | 0 | | 0 | |

| | | Total | |
|---|---|---|---|
| fertilizer | No. | fertilizer per | Total |
| application rate | of Units | unit | fertilizer per |
| (%) | per plant | (g) | plant (g) |
| 100 | 6 | 1.35 | 8.1 |
| 50 | | 0.68 | 4.1 |
| 25 | | 0.34 | 2.0 |
| 10 | | 0.14 | 0.8 |
| 0 | | 0 | 0 |

Planting/harvesting dates: (47 days). Following harvest, unit samples from all treatments were excavated gently and were quantified for roots penetration and total root length. A core from the middle of each sample was cut and analyzed for root content. Root count in both vertical and horizontal axes and total volume were used estimating the root total length within a single unit. Total leaves biomass of each plant was analyzed to Azoxystrobin content in qualified laboratory (Bactochem, Israel).

### Results:

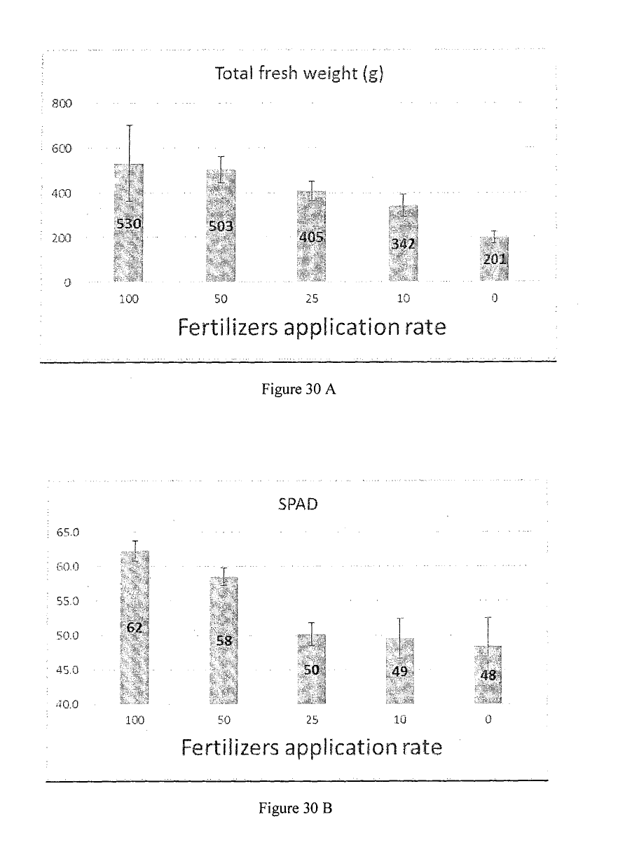

Pepper plant fresh biomass and nitrogen (N) content were strongly correlated to fertilizer application rate. The fresh biomass of 100% and 50% fertilizer rate were not different due to the short trial time (47 days), meaning sufficient fertilizer. Yet, lower rates resulted with smaller plants. Similarly, the N content of 100% and 50% treatments was high and sufficient, while lower rates had equal lower value. See FIGS. 30A-30B.

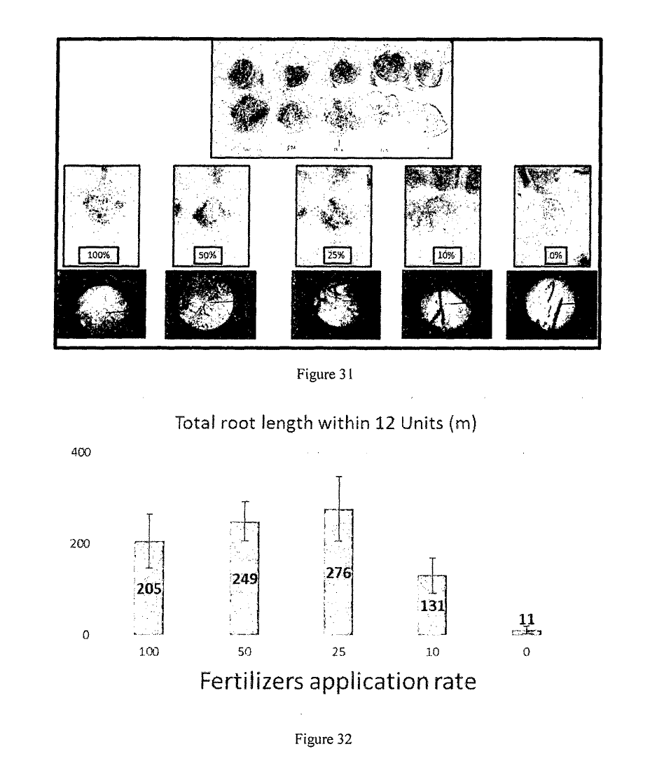

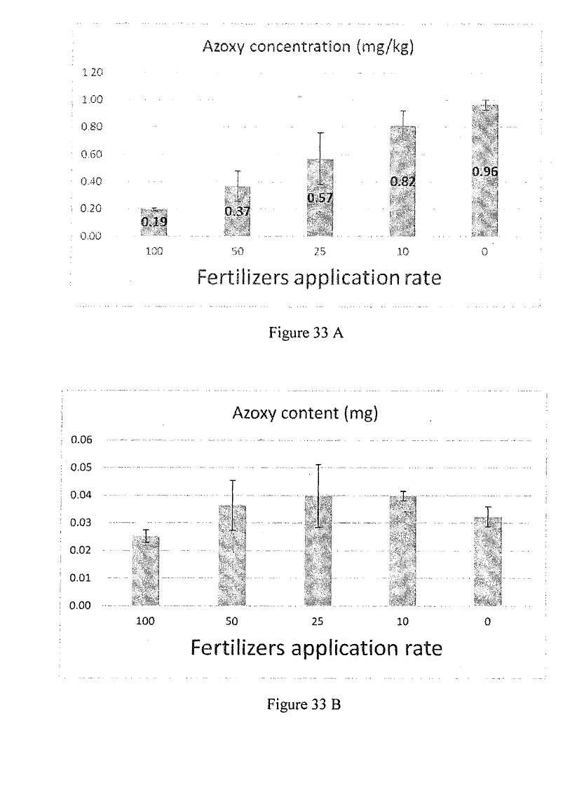

Root growth of pepper plants within the unit was affected by fertilizer content. The photos of complete units and roots density within the core demonstrate the root density in each fertilizer application rate. Only few roots were observed within the root development zone without fertilizer. Higher values were observed in 10% treatment. Very dense root population occupied the root growing zone in 25%, 50% and 100% treatments. Extrapolating the total root length within the sampled core to entire 12 units yielded about 200 m in the high fertilizer application rate treatments, 130 m in 10% treatment and only 11 m in the units without fertilizer. See FIGS. 31-32. Azoxystrobin content in leaves is a kinetic process depends on influx from roots and biodegradation within the plants tissues. A reverse correlation was found between Azoxystrobin concentration in leaves and fertilizer content at DAP 47. The difference in concentration between fully fertilized and no fertilizer was 5 fold. Total Azoxystrobin content within plant leaves was similar in all treatments, except the fully fertilized plants, where lower content was measured. See FIGS. 33A-33B.

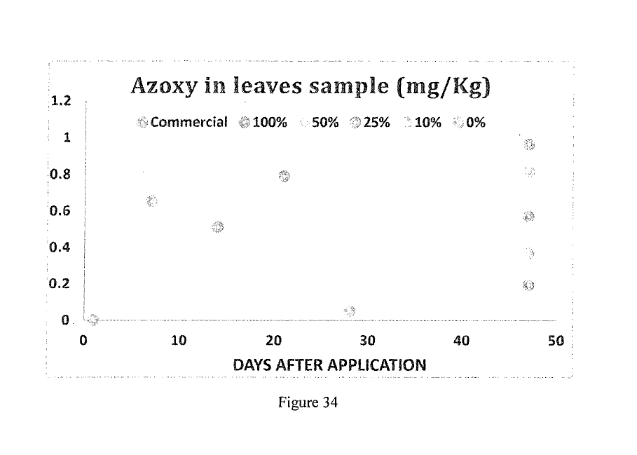

Azoxystrobin application through the soil was studied as part of its registration process. The concentration in pepper leaves was measured over time from application. Similar Azoxystrobin concentrations in leaves were found in both commercial and current trial (tenth of ppm). While no residue were found in commercial leaves at 28 DAP, effective concentrations were found in unit leaves at 47 DAP. This significant difference may inform the potential of the unit for protecting the plant for longer periods compared to current application practice. See FIG. 34.

### Summary

Fertilizer content within the unit was strongly correlated to root development and total root length in the root growing zone. Although this correlation, Azoxystrobin content in pepper plant leaves was similar, suggesting, that either Azoxystrobin influx from roots and/or biodegradation within the plants tissues were influenced by the roots morphology. Effective Azoxystrobin concentrations were found in unit treated plants 19 days after commercial plants.

### Conclusions

1. Fertilizer content is an important parameter in roots growth within the root growing zone (e.g., hydrogel).
2. Azoxystrobin was up taken by all plants, regardless fertilizer content.
3. The unit has the potential to protect the plant for longer periods relative to current practice.

### Discussion

PCT International Application No. PCT/IB2014/001194, hereby incorporated by reference in its entirety, describes compositions and methods for efficiently delivering agrochemicals to the roots of plants. The present invention improves upon the invention described therein and is, in part, based upon the discovery that fertilizer units formulated with low amounts of pesticide can provide a level of pest protection which is comparable to, and in some cases superior to, the level of pest protection achieved using traditional foliar and/or soil treatments.

The artificial environment formed by the units of the present invention encourages root growth and development within the unit, which enhances and promotes efficient nutrient and pesticide (when present) uptake. Thus, plants fertilized using the units of the present invention can grow faster and/or produce a greater yield than crops fertilized by traditional methods, and the need for separate pesticide application by conventional treatments is avoided when units containing a pesticide are used. The data herein show that the total amount of pesticide needed when using the units of the invention is reduced compared to the amount of pesticide needed to achieve pest protection when using traditional foliar and/or soil treatments. It was unexpectedly found that the amount of pesticide needed when using the units of the invention can be reduced by 50% or more compared to the amount of pesticide needed when using traditional application methods.

Units of the invention formulated with insecticides can be used to control and/or prevent insect damage to plant canopy and/or roots. By using a systemic insecticide, which is up taken by the plant roots and mobilized within the plant into the above and/or below ground plant parts, the units of the invention can be used to provide protection from various insects, e.g. aphids and sucking pests.

Units of the invention formulated with fungicides can be used to prevent and/or control bacterial and/or fungal diseases. By using a systemic fungicide, which is taken up by the plant roots and mobilized within the plant, the units of the invention can be used to provide protection from various fungi, e.g. Powdery Mildew, Fusarium.

Units of the invention formulated with nematocide can be used to control and/or prevent soil nematodes. Units containing a nematocide/fungicide/insecticide can be formulated to release the active ingredients in a controlled manner into the adjacent soil to provide protection from pests including nematodes, pythium and ophids.

Units containing an herbicide can be used to control weeds growing adjacent to the crop plant. Herbicide containing units can be used with crops tolerant to the herbicide, whether naturally tolerant or made tolerant by GM methods. Both crop and weed roots grow into the unit and absorb nutrients and herbicide from the unit, but only the weed will be negatively affected by the herbicide.

Aspects of the present invention that are advantageous and unique over current technologies and practices include but are not limited to:
Universality—embodiments of the present invention are not dependent on temporal and spatial variations of soil, crop and weather. The units of the invention provide predetermined chemical properties optimal for root activity and controlled chemical availability (e.g. diffusion, pH, activity, moisture, mechanical resistance, and temperature).
Simplicity—embodiments of the present invention relate to a single application using conventional equipment. All plant required inputs (e.g. nutrients, plant protection products, and water) can be provided by the units of the invention. The controlled release mechanism controls the release rate over time, enabling a steady release of the relevant active ingredients to control the target pest, e.g. insect, disease, or weeds.
Economy—embodiments of the present invention save labor and the amount of agrochemical input (fertilizers and pesticides, and energy) for the farmer. Units of the invention provide efficacy which is comparable to or better than the standard application methods.
Sustainability—embodiments of the present invention protect the environment (water bodies and atmosphere) from contamination as a result of leaching, runoff and volatilization of agrochemicals. The root development zones eliminate direct leaching of plant protection products, fertilizers, and other agrochemicals below the root zone due to leaching generated by frequent rain or irrigation events.
Safety—embodiments of the present invention protect the farmer by reducing the farmer's handling of and exposure to fertilizers and pesticide.
Regulatory Approval—embodiments of the present invention use a reduced amount of pesticide relative to conventional pesticide application methods, increasing the probability of regulatory approval for fertilizers and pesticides formulated according to the invention.

### REFERENCES

Drew M. C., 1997. Oxygen deficiency and root metabolism: Injury and acclimation under hypoxia and anoxia. ANNUAL REVIEW OF PLANT PHYSIOLOGY AND PLANT MOLECULAR BIOLOGY Volume: 48 Pages: 223-250.
Habarurema and Steiner, 1997. Soil suitability classification by farmers in southern Rwanda. Geoderma Volume 75, Issues 1-2, Pages 75-87
Hopkins H. T., 1950. Growth and nutrient accumulation as controlled by oxygen supply to plant roots. Plant Physiology, 25(2): 193-209.
Nicholson S. E. and Farrar T. J., 1994. The influence of soil type on the relationships between NDVI, rainfall, and soil moisture in semiarid Botswana. I. NDVI response to rainfall. Remote Sensing of Environment Volume 50, Issue 2, Pages 107-120
Shaviv A., Mikkelsen R. L. 1993. Controlled-release fertilizers to increase efficiency of nutrient use and minimize environmental degradation—A review. Fert. Res. 35, 1-12.
Püntener W., 1981. Manual for field trials in plant protection second edition. Agricultural Division, Ciba-Geigy Limited.

What is claimed:

1. A unit for delivery of agrochemicals to the roots of a plant comprising:
i) one or more root development zones;
ii) optionally, one or more agrochemical zones; and
iii) a pesticide;
wherein the agrochemical zones are formulated to release at least one agrochemical into the root development zones in a controlled release manner when the root development zones are swelled; and
wherein the dry weight ratio of the root development zones to the agrochemical zones in a dry unit is 0.05:1 to 20:1, or wherein the total volume of the root development zones in the unit is at least 0.2 mL when the unit is fully swelled.

2. The unit of claim 1, wherein the unit:
a) does not contain an agrochemical zone,
b) does not contain a fertilizer,
c) contains one or more agrichemical zones and wherein the one or more agrochemical zones contains a fertilizer, or
d) contains one or more agrichemical zones and wherein the one or more agrochemical zones contains a fertilizer and the weight ratio of the pesticide to the fertilizer is at least 6×10⁻³:1.

3. (canceled)

4. (canceled)

5. (canceled)

6. The unit of claim 1, comprising:
i) one or more root development zones,
ii) one or more agrochemical zones containing a fertilizer, and
iii) a pesticide,
wherein the agrochemical zones are formulated to release the fertilizer into the root development zones in a controlled release manner when the root development zones are swelled,
wherein the total amount of pesticide in the dry unit is 0.0004% to 0.5% of the total weight of the unit, wherein the weight ratio of pesticide to fertilizer in the unit is 5×10⁻⁶:1 to 6×10⁻³:1, or wherein the total amount of pesticide in the unit is less than 50 mg, and
wherein the dry weight ratio of the root development zones to the agrochemical zones in a dry unit is 0.05:1 to 0.32:1, or wherein the total volume of the root development zones in the unit is at least 0.2 mL when the unit is fully swelled.

7. The unit of claim 1, wherein:
a) the total amount of the pesticide in the dry unit is 0.0004% to 05% of the total weight of the unit,
b) the total amount of the pesticide in the dry unit is 0.01% to 0.05%, 0.0005% to 0.1%, 0.01% to 0.05%, or 0.01% to 0.3% of the total weight of the unit,
c) the total amount of the pesticide in the dry unit is 0.0004% to 20%, 0.01% to 20%, 0.05% to 10%, or 0.1% to 1% of the total weight of the dry unit,
d) the weight ratio of pesticide to fertilizer in the unit is 5×10⁻⁶:1 to 6×10⁻³:1,
e) the weight ratio of pesticide to fertilizer in the unit is 4.6×10⁻⁴:1,
f) the weight ratio of the pesticide to the fertilizer is 6×10⁻³:1 to 1:1, 1×10⁻²:1, or 0.1:1 to 1:1,
g) the unit contains one or more agrichemical zones and wherein the dry weight ratio of the root development zones to the agrochemical zones in a dry unit is 0.05:1 to 10:1, 0.1:1 to 10:1, or 0.5:1 to 5:1,
h) the total amount of the pesticide in the unit is less than 50 mg, or
i) the total weight of the pesticide in the unit is 0.01 mg to 0.1 mg, 0.1 to 1 mg, 1 mg to 5 mg, 5 mg to 10 mg, 10 mg to 15 mg, 15 mg to 20 mg, 20 mg to 25 mg, 25 mg to 30 mg, 30 mg to 35 mg, 35 mg to 40 mg, 40 mg to 45 mg, or 45 mg to less than 50 mg.

8-15. (canceled)

16. The unit of claim 1, wherein:
a) the pesticide is in one or more agrochemical zones,
b) the agrochemical zones containing the pesticide are formulated to release the pesticide into the root development zones in a controlled release manner when the root development zones are swelled,
c) the fertilizer and the pesticide are together in one or more agrochemical zones,
d) the fertilizer and the pesticide are each in different agrochemical zones, or
e) the pesticide is dispersed throughout one or more root development zones and outside of an agrochemical zone.

17-20. (canceled)

21. The unit of claim 1, wherein:
a) the pesticide is an insecticide, a fungicide, a nematicide, or an herbicide,
b) the pesticide is a pesticide for soil pests and pathogens which is fluensulfone, propamocarb, flutolanil, fludioxonil, abamectin, fluopyram, or oxamyl, or
c) the pesticide is imidacloprid or azoxystrobin.

22. (canceled)

23. (canceled)

24. The unit of claim 1, comprising two or more pesticides, wherein:
a) at least two of the two or more pesticides are together in at least one agrochemical zone,
b) at least two of the two or more pesticides are each in different agrochemical zones, or
c) at least one of the two or more pesticides is dispersed throughout one or more root development zones and outside of an agrochemical zone.

25. (canceled)

26. (canceled)

27. (canceled)

28. The unit of claim 1, comprising two or more fertilizers, wherein:
a) at least two of the two or more fertilizers are together in at least one agrochemical zone,
b) at least two of the two or more fertilizers are each in different agrochemical zones, or
c) at least one of the two or more fertilizers is in an agrochemical zone which is formulated to release the fertilizers contained therein over a period of less than one week when the unit is swelled.

29. (canceled)

30. (canceled)

31. (canceled)

32. The unit of claim 1, wherein:
a) the root development zones do not contain a fertilizer or a pesticide before the unit is swelled for the first time, or
b) the root development zones contain a fertilizer, a pesticide, or a fertilizer and a pesticide before the unit is swelled for the first time.

33. (canceled)

34. The unit of claim 1, wherein:
a) the weight ratio of the root development zones to the agrochemical zones in a dry unit is 0.05:1 to 0.32:1, or
b) the unit contains one or more agrochemical zones and wherein the dry weight ratio of the root development zones to the agrochemical zones in a dry unit is 0.05:1 to 10:1, 0.1:1 to 10:1, or 0.5:1 to 5:1.

35. (canceled)

36. A unit for delivery of agrochemicals to the roots of a plant comprising:
i) one or more root development zones, and
ii) one or more agrochemical zones containing at least one agrochemical,
wherein the agrochemical zones are formulated to release the at least one agrochemical into the root development zones in a controlled release manner when the root development zones are swelled, and
wherein the weight ratio of the root development zones to the agrochemical zones in a dry unit is 0.12:1, 0.14:1, or 0.21:1.

37. The unit of claim 1, wherein:
a) the total volume of the root development zones in the unit is at least 0.2 mL or at least 2 mL when the unit is fully swelled,
b) the total volume of the root development zones when the unit is 1%-100% swelled is large enough to contain at least 10 mm of a root having a diameter of 0.5 mm,
c) the unit has a dry weight of 0.1 g to 20 g, or
d) the total weight of the agrochemical zones of the unit is 0.05 to 5 grams.

38-41. (canceled)

42. The unit of claim 1, wherein:
a) the unit is in the shape of a cylinder, a polyhedron, a cube, a disc, or a sphere,
b) the agrochemical zones and the root development zones are adjoined,
b) the agrochemical zones are partially contained within the root development zones such that the surface of the unit is formed by both the root development zones and the agrochemical zones,
c) the unit is a bead comprising an external zone surrounding an internal zone, wherein the root development zones form the external zone and the agrochemical zones form the internal zone,
d) the unit comprises one root development zone and one agrochemical zone, or
e) the unit comprises more than one agrochemical zone.

43-47. (canceled)

48. The unit of any one claim 1, wherein:
a) the root development zones comprise a super absorbent polymer (SAP),
b) the root development zones are capable of absorbing at least about 10, 15, 20, 25, 30, 35, 40, 45, 50, 75, 80, 85, 90, 95, 100, 200, 300, 400, 500, or 1000 times their weight in water,
c) the root development zones are permeable to oxygen such that at least about 6 mg/L of dissolved oxygen is maintained in the root development zones when the root development zones are swelled,
d) the root development zones when fully swelled are at least about 70, 75, 80, 85, 90, 95, or 100% as permeable to oxygen as swelled alginate or swelled semi-synthetic CMC,
e) the root development zones comprise an aerogel, a hydrogel or an organogel, wherein the hydrogel optionally comprises hydroxylethyl acylamide,
f) the root development zones further comprise a polymer, a porous inorganic material, a porous organic material, or any combination thereof,
g) the roots of a plant are capable of growing within the root development zones when the root development zones are swelled, and wherein the plant is optionally a crop plant,
h) when the root development zones are about 1%, 5%, 10%, 15%, 20%, 25%, 30%, 35%, 40%, 45%, 50%, 1-50% or 5-50% swelled, the total weight of the root development zones is at least about 2, 3, 4, 5, 6, 7, 8, 9, 10, 20, 30, 40, 50, 60, 70, 80, 90, 100 or more than 100 times greater than the total weight of the agrochemical zones, or
i) the root development zones comprise a synthetic hydrogel, a natural carbohydrate hydrogel, a pectin or protein hydrogel, a natural super absorbent polymer (SAP), a poly-sugar SAP, a semi-synthetic SAP, a fully-synthetic SAP, or any combination thereof or any combination thereof, and wherein the root development zones optionally comprise at least one oxygen carrier that that increases the amount of oxygen in the root development zones.

49-56. (canceled)

57. The unit of claim 1, wherein:
a) the agrochemical zones comprise an organic polymer, a natural polymer, or an inorganic polymer, or any combination thereof, or
b) the agrochemical zones are partially or fully coated with a coating system, wherein the coating system optionally dissolves into the root development zones when the root development zones are swelled, and wherein the coating system optionally covers all surfaces of the agrochemical zones which would otherwise be on the surface of the unit and which is impermeable to at least one agrochemical in the agrochemical zones.

58. (canceled)

59. The unit of claim 57, wherein the coating system slows the rate at which at least one agrochemical in the agrochemical zones dissolves into the root development zones when the root development zones are swelled.

60. (canceled)

61. A method of reducing environmental damage caused by agrochemicals, comprising delivering the agrochemicals to the root of a plant by adding at least one unit of claim 1 to the medium of the plant.

62. A method of generating an artificial zone with predetermined chemical properties within the root zone of a plant, comprising:
i) adding one or more units to the medium of the root zone of the plant; or
ii) adding one or more units to the anticipated root zone of the medium in which the plant is anticipated to grow,
wherein at least one of the one or more units is a unit of claim 1.

63. A method of (i) fertilizing a plant, (ii) protecting a plant from a pest, or (iii) growing a plant comprising adding at least one unit of claim 1 to the medium in which the plant is grown.

64. (canceled)

65. The method of claim 63, wherein:
a) the amount of the pesticide contained in all of the units added to the medium is substantially less than the amount of the pesticide which would be needed to achieve the same level of pest protection when applying the pesticide by foliar spraying, soil drenching, above ground distribution, or soil spraying,
b) 300,000 to 700,000 units are added per hectare of medium,
c) the units comprise 1.5 g of fertilizer, and wherein 500,000 units are added per hectare of medium,
d) the unit contains a pesticide for soil pests and pathogens, and wherein the number of units added her hectare of medium contains 100 to 3000 g of the pesticide for soil pests and pathogens, or
e) 4-20 units are added to the medium per plant.

66-69. (canceled)
